(19) United States
(12) Patent Application Publication
(10) Pub. No.: US 2018/0262744 A1
(43) Pub. Date: Sep. 13, 2018

(54) SYSTEMS, METHODS AND APPARATUSES FOR STEREO VISION

(71) Applicant: MindMaze Holding SA, Lausanne (CH)

(72) Inventors: Tej TADI, Lausanne (CH); Leandre BOLOMEY, Lausanne (CH); Nicolas FREMAUX, Lausanne (CH); Flavio LEVI CAPITAO CANTANTE, Lausanne (CH); Corentin BARBIER, Lausanne (CH); Ieltxu GOMEZ LORENZO, Lausanne (CH)

(21) Appl. No.: 15/891,235

(22) Filed: Feb. 7, 2018

Related U.S. Application Data
(60) Provisional application No. 62/456,045, filed on Feb. 7, 2017.
(60) Provisional application No. 62/553,953, filed on Sep. 4, 2017.
(60) Provisional application No. 62/598,487, filed on Dec. 14, 2017.

(51) Int. Cl. H04N 13/15; H04N 13/139; H04N 13/167; H04N 9/31; H04N 13/324

(52) U.S. Cl. CPC H04N 13/15; H04N 13/139; H04N 2013/0077; H04N 9/3182; H04N 13/324; H04N 13/167

(57) ABSTRACT

A system, method and apparatus for stereo vision with a plurality of coupled cameras and optional sensors.

### FIELD OF THE DISCLOSURE

The present disclosure is directed to systems, methods and apparatuses for stereo vision, and in particular, to systems, methods and apparatuses for stereo vision which include a plurality of image sensors (e.g., cameras), as well as (in some embodiments) additional sensors.

### BACKGROUND OF THE DISCLOSURE

Stereoscopic cameras provide a stereo view and are well known. For example, International Patent Publication no. WO2014154839 is understood to describe a camera system for capturing stereo data using two RGB cameras combined with a depth sensor for tracking the motion of an object (e.g., a person). The computations of the system are performed by a separate computer, which can lead to lag. Other examples include:
The Persee product of Orbbec 3D (also known as Shenzhen Orbbec Co., Ltd.; https://orbbee3d.com/) combines camera functions with an ARM processor in a single apparatus. The apparatus includes a single RGB camera, a depth sensor, an infrared receiving port and a laser projector to provide stereo camera information;
International Patent Publication no. WO2016192437, describes a system in which infrared sensor data is combined with RGB data to create a 3D image; and
The Zed product of Stereolabs Inc (https://www.stereolabs.com/zed/specs/) provides a 3D camera with tracking capabilities.

### BRIEF SUMMARY OF THE DISCLOSURE

Embodiments of the present disclosure are directed to systems, methods and apparatuses for stereo vision, and in particular, to systems, methods and apparatuses for stereo vision which include a plurality of image sensors (e.g., cameras), as well as (in some embodiments) additional sensors.

According to at least some embodiments there is provided a stereo vision procurement apparatus for obtaining stereo visual data, comprising: a stereo RGB camera; a depth sensor; and an RGB-D fusion module, wherein: each of said stereo RGB camera and said depth sensor are configured to provide pixel data corresponding to a plurality of pixels, said RGB-D fusion module is configured to combine RGB pixel data from said stereo RGB camera and depth information pixel data from said depth sensor to form stereo visual pixel data (SVPD), and said RGB-D fusion module is implemented in an FPGA field-programmable gate array).

Optionally the apparatus further comprises a de-mosaicing module configured to perform a method comprising: averaging the RGB pixel data associated with a plurality of green pixels surrounding red and blue sites for R(B) at B-G(R-G) sites or R(B) at R-G(B-G) sites, and reducing a number of green pixel values from the RGB pixel data to fit a predetermined pixel array (e.g., a 5×5 window) for R(B) at B(R) sites.

Optionally said stereo RGB camera comprises a first camera and a second camera, each of said first and second cameras being associated with a clock on said FPGA, and said FPGA including a double clock sampler for synchronizing said clocks of said first and right cameras.

Optionally the apparatus further comprises a histogram module comprising a luminance calculator for determining a luminance level of at least said RGB pixel data; and a classifier for classifying said RGB pixel data according to said luminance level, wherein said luminance level is transmitted to said stereo RGB camera as feedback.

Optionally the apparatus further comprises a white balance module configured to apply a smoothed GW (gray world) algorithm to said RGB pixel data.

Optionally the apparatus further comprises a processor; and a biological sensor configured to provide biological data, wherein: said biological sensor is selected from the group consisting of: an EEG sensor, a heartrate sensor, an oxygen saturation sensor, an EKG sensor, or EMG sensor, and a combination thereof, the processor is configured to process the biological data to form a plurality of sub-features, said sub-features are combined by the FPGA to form a feature.

Optionally said FPGA is implemented as a field-programmable gate array (FPGA) comprising a system on a chip (SoC), including an operating system as a SOM (system on module).

Optionally the apparatus further comprises a CPU SOM for performing overflow operations from said FPGA.

Optionally the apparatus further comprises a processor; and a plurality of tracking devices to track movement of a subject, wherein: the processor is configured to process data from the tracking devices to form a plurality of sub-features, and said sub-features are combined by said FPGA to form a feature to track movements of the subject.

Optionally the tracking devices comprise a plurality of wearable sensors.

Optionally the apparatus further comprises a processor; and a multi-modal interaction device in communication with a subject, said multi-modal interaction device comprising said plurality of tracking devices and at least one haptic feedback device, wherein: the processor is configured to process data from the tracking devices to form a plurality of tracking sub-features, and said sub-features are combined by said FPGA to form a feature to track movements of the subject and to provide feedback through said at least one haptic feedback device.

Optionally the apparatus further comprises a processor configured to perform a defined set of operations in response to receiving a corresponding instruction selected from an instruction set of codes; and a memory; wherein: said defined set of operations including: a first set of codes for operating said RGB-D fusion module to synchronize RGB pixel data and depth pixel data, and for creating a disparity map; and a second set of codes for creating a point cloud from said disparity map and said depth pixel data.

Optionally said point cloud comprises a colorized point cloud.

Optionally the apparatus further comprises a memory; and a processor configured to perform a defined set of operations for performing any of the functionality recited in any of claims 1-11 in response to receiving a corresponding instruction selected from an instruction set of codes.

Optionally said processor is configured to operate according to a set of codes selected from the instruction set for a de-noising process for a CFA (color filter array) image according to a W-means process.

Optionally said computational device comprises a second set of codes selected from the instruction set for operating a bad pixel removal process.

According to at least some embodiments there is provided a system comprising the apparatus as described herein, further comprising a display for displaying stereo visual data.

Optionally the system further comprises an object attached to a body of a user; and an inertial sensor, wherein said object comprises an active marker, input from said object is processed to form a plurality of sub-features, and said sub-features are combined by the FPGA to form a feature.

Optionally the system further comprises a processor for operating a user application, wherein said RGB-D fusion module is further configured to output a colorized point cloud to said user application.

Optionally said processor is configured to transfer SVPD to said display without being passed to said user application, and said user application is additionally configured to provide additional information for said display that is combined by said FPGA with said SVPD for output to said display.

Optionally said biological sensor is configured to output data via radio-frequency (RF), and wherein: the system further comprises an RF receiver for receiving the data from said biological sensor, and said feature from said FPGA is transmitted to said user application.

Optionally the system further comprises at least one of a haptic or tactile feedback device, the device configured to provide at least one of haptic or tactile feedback, respectively, according to information provided by said user application.

According to at least some embodiments there is provided a stereo vision procurement system comprising: a first multi-modal interaction platform configurable to be in communication with one or more additional second multi-modal interaction platforms; a depth camera; a stereo RGB camera; and an RGB-D fusion chip; wherein: each of said stereo RGB camera and said depth camera are configured to provide pixel data corresponding to a plurality of pixels, the RGB-D fusion chip comprises a processor operative to execute a plurality of instructions to cause the chip to fuse said RGB pixel data and depth pixel data to form stereo visual pixel data.

Optionally the depth camera is configured to provide depth pixel data according to TOF (time of flight).

Optionally the stereo camera is configured to provide SVPD from at least one first and at least one second sensor.

Optionally the RGB-D fusion chip is configured to preprocess at least one of SVPD and depth pixel data so as to form a 3D point cloud with RGB pixel data associated therewith.

Optionally the fusion chip is further configured to form the 3D point cloud for tracking at least a portion of a body by at least the first multi-model interaction platform.

Optionally the system further comprises at least one of a display and a wearable haptic device, wherein at least the first multi-modal interaction platform is configured to output data to at least one of the display and the haptic device.

Optionally the system further comprises one or more interactive objects or tools configured to perform at least one of giving feedback, receiving feedback, and receiving instructions from at least one of the multi-modal interaction platforms.

Optionally the system further comprises one or more sensors configured to communicate with at least one of the multi-modal interaction platforms.

Optionally the one or more sensors include at least one of: a stereo vision AR (augmented reality) component configured to display an AR environment according to at least one of tracking data of a user and data received from the first multi-modal interaction platform, and a second additional multi-modal interaction platform; an object tracking sensor; a facial detection sensor configured to detect a human face, or emotions thereof; and a markerless tracking sensor in which an object is tracked without additional specific markers placed on it.

According to at least some embodiments there is provided a multi-model interaction platform system comprising: a multi-modal interaction platform; a plurality of wearable sensors each comprising an active marker configured to provide an active signal for being detected; an inertial sensor configured to provide an inertial signal comprising position and orientation information; at least one of a heart rate and oxygen saturation sensor, or a combination thereof; an EEG sensor; and at least one wearable haptic devices, including one or more of a tactile feedback device and a force feedback device.

According to at least some embodiments there is provided a method for processing image information comprising: receiving SVPD from a stereo camera; performing RGB preprocessing on the input pixel data to produce preprocessed RGB image pixel data; using the RGB preprocessed image pixel data in the operation of the stereo camera with respect to at least one of an autogain and an autoexposure algorithm; rectifying the SVPD so as to control artifacts caused by the lens of the camera; and calibrating the SVPD so as to prevent distortion of the stereo pixel input data by the lens of the stereo camera.

Optionally the method further comprises colorizing the preprocessed RGB image pixel data, and creating a disparity map based on the colorized, preprocessed RGB image pixel data.

Optionally calibration comprises matching the RGB pixel image data with depth pixel data.

Optionally the disparity map is created by: obtaining depth pixel data from at least one of the stereo pixel input data, the preprocessed RGB image pixel data, and depth pixel data from a depth sensor, and checking differences between stereo images.

Optionally said disparity map, plus depth pixel data from the depth sensor in the form of a calibrated depth map, is combined for the point cloud computation.

According to at least some embodiments there is provided an image depth processing method for depth processing of one or more images comprising: receiving TOF (time-of-flight) image data of an image from a TOF camera; creating at least one of a depth map or a level of illumination for each pixel from the TOF data; feeding the level of illumination into a low confidence pixel removal process comprising: comparing a distance that each pixel is reporting; correlating said distance of said each pixel to the illumination provided by said each pixel, removing any pixel upon the illumination provided by the pixel being outside a predetermined acceptable range such that the distance cannot be accurately determined; processing depth information to remove motion blur of the image, wherein motion blur is removed by removing artifacts at edges of moving objects in depth of the image; and applying at least one of temporal or spatial filters to the image data.

According to at least some embodiments there is provided a stereo image processing method comprising: receiving first data flow of at least one image from a first RGB camera and second data flow of at least one image from a second RGB camera; sending the first and second data flows to a frame synchronizer; and synchronizing, using the frame synchronizer, a first image frame from the first data flow and a second image frame from the second data flow such that time shift between the first image and frame and the second image frame is substantially eliminated.

Optionally sampling, before sending the first and second data flows to the frame synchronizer, the first and second data flows such that each of the first and second data flows are synchronized with a single clock; and detecting which data flow is advanced of the other, and directing the advanced data flow to a First Input First Output (FIFO), such that the data from the advanced flow is retained by the frame synchronizer until the other data flow reaches the frame synchronizer.

Optionally the method further comprises serializing frame data of the first and second data flows as a sequence of bytes.

Optionally the method further comprises detecting non-usable pixels.

Optionally the method further comprises constructing a set of color data from each of the first and second data flows.

Optionally the method further comprises color correcting each of the first and second data flows.

Optionally the method further comprises corresponding the first and second data flows into a CFA (color filter array) color image data; applying a denoising process for the CFA image data, the process comprising: grouping four (4) CFA colors to make a 4-color pixel for each pixel of the image data; comparing each 4-color pixel to neighboring 4-color pixels; attributing a weight to each neighbor pixel depending on its difference with the center 4-color pixel; and for each color, computing a weighted mean to generate the output 4-color pixel.

Optionally said denoising process further comprises performing a distance computation according to a Manhattan distance, computed between each color group neighbor and the center color group.

Optionally the method further comprises applying a bad pixel removal algorithm before said denoising process.

Unless otherwise defined, all technical and scientific terms used herein have the same meaning as commonly understood by one of ordinary skill in the art to which this disclosure belongs. The materials, systems, apparatuses, methods, and examples provided herein are illustrative only and not intended to be limiting.

Implementation of the embodiments of the present disclosure include performing or completing tasks, steps, and functions, manually, automatically, or a combination thereof. Specifically, steps can be implemented by hardware or by software on an operating system, of a firmware, and/or a combination thereof. For example, as hardware, steps of at least some embodiments of the disclosure can be implemented as a chip or circuit (e.g., ASIC). As software, steps of at least some embodiments of the disclosure can be implemented as a number of software instructions being executed by a computer (e.g., a processor) using an operating system. Thus, in any case, selected steps of methods of at least some embodiments of the disclosure can be performed by a processor for executing a plurality of instructions.

Software (e.g., an application, computer instructions, code) which is configured to perform (or cause to be performed) certain functionality of some of the disclosed embodiments may also be referred to as a “module” for performing that functionality, and also may be referred to a “processor” for performing such functionality. Thus, processor, according to some embodiments, may be a hardware component, or, according to some embodiments, a software component.

Further to this end, in some embodiments, a processor may also be referred to as a module, and, in some embodiments, a processor may comprise one more modules. In some embodiments, a module may comprise computer instructions—which can be a set of instructions, an application, software, which are operable on a computational device (e.g., a processor) to cause the computational device to conduct and/or achieve one or more specific functionality. Furthermore, the phrase “abstraction layer” or “abstraction interface”, as used with some embodiments, can refer to computer instructions (which can be a set of instructions, an application, software) which are operable on a computational device (as noted, e.g., a processor) to cause the computational device to conduct and/or achieve one or more specific functionality. The abstraction layer may also be a circuit (e.g., an ASIC see above) to conduct and/or achieve one or more specific functionality. Thus, for some embodiments, and claims which correspond to such embodiments, the noted feature/functionality can be described/claimed in a number of ways (e.g., abstraction layer, computational device, processor, module, software, application, computer instructions, and the like).

Some embodiments are described with regard to a “computer”, a “computer network,” and/or a “computer operational on a computer network,” it is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

Embodiments of the present disclosure are herein described, by way of example only, with reference to the accompanying drawings. With specific reference now to the drawings in detail, it is stressed that the particulars shown are by way of example and for purposes of illustrative discussion of the preferred embodiments of inventions disclosed herein, and are presented in order to provide what is believed to be the most useful and readily understood description of the principles and conceptual aspects of various embodiments of the inventions disclosed herein.

FIG. 1 shows a non-limiting example of a system according to at least some embodiments of the present disclosure;

FIG. 2 shows additional detail of the system of FIG. 1;

FIG. 3 shows a non-limiting example of a method for preprocessing according to at least some embodiments of the present disclosure;

FIGS. 4A and 4B shows a non-limiting example of a method for depth preprocessing according to at least some embodiments of the present disclosure;

FIGS. 5A-5C shows a non-limiting example of a data processing flow for the FPGA (field-programmable gate array) according to at least some embodiments of the present disclosure;

FIGS. 6A-6E shows a non-limiting example of a hardware system for the camera according to at least some embodiments of the present disclosure;

FIG. 7 shows a non-limiting example of a method for stereo processing according to at least some embodiments of the present disclosure;

FIG. 8 shows a non-limiting example of a MCU configuration according to at least some embodiments of the present disclosure;

FIG. 9 shows a non-limiting example of a camera according to at least some embodiments of the present disclosure;

FIG. 10 shows a non-limiting example of a configuration for double clock sampler functions according to at least some embodiments of the present disclosure;

FIGS. 11A and 11B show a non-limiting example of a buffer configuration according to at least some embodiments of the present disclosure;

FIGS. 12A-12C show non-limiting examples of an internal buffer cells arrangement: a) global structure, b) mask for defective pixel detection, c) mask for de-mosaic task;

FIG. 12D shows exemplary state machines;

FIGS. 13A-13H show a non-limiting example of a method for de-mosaic according to at least some embodiments of the present disclosure;

FIG. 14 shows a non-limiting example of a method for white balance correction according to at least some embodiments of the present disclosure;

FIG. 15 shows a non-limiting example of a method for performing the histogram adjustment according to at least some embodiments of the present disclosure;

FIG. 16 shows an illustrative, exemplary, non-limiting process for stereo rectification according to at least some embodiments of the present disclosure;

FIG. 17A shows an illustrative, exemplary, non-limiting system for stereo rectification according to at least some embodiments of the present disclosure;

FIG. 17B shows an illustrative, exemplary, non-limiting mapper module for use with the system of FIG. 17A according to at least some embodiments of the present disclosure;

FIG. 17C shows an illustrative, exemplary, non-limiting memory management for use with the system of FIG. 17A according to at least some embodiments of the present disclosure;

FIG. 17D shows a non-limiting example of an image;

FIG. 17E shows the memory filling scheme for this image;

FIG. 17F shows a non-limiting, exemplary finite state machine for use with the system of FIG. 17A according to at least some embodiments of the present disclosure;

FIG. 18A shows an illustrative, exemplary, non-limiting disparity map method according to at least some embodiments of the present disclosure;

FIG. 18B shows an illustrative, exemplary, non-limiting method for calculating a cost for the disparity map method according to at least some embodiments of the present disclosure;

FIG. 19A shows an example of image representation for “W-means” algorithm;

FIG. 19B shows the effects of parameters on “W-means” weight;

FIG. 19C shows taxicab geometry versus Euclidean distance: In taxicab geometry, the red, yellow, and blue paths vall have the shortest length of |6|+|6|=12. In Euclidean geometry, the green line has length, and is the unique shortest path;

FIG. 19D shows the W-means algorithm, in a non-limiting example;

FIG. 20 shows the results of state of the art and “W-means” algorithms, after application of the debayer. Image size (150×80) (zoom). Algorithm parameters are: NLM(h=6, f=3, r=10), Vinh(p=8), PSWFA(n=5), W_means(h=16, σ=4), W_means_1stOrd(h=32, σ=2), W_means_thr(σ=12), W_means_thr_optdiv(σ=12);

FIG. 21A shows required ports of the filter to be added in the image pipeline, while FIG. 21B shows a pixel stream interface chronogram;

FIG. 22A shows a schematic of the Bailey and Jimmy method, while FIG. 22B shows an exemplary implementation thereof;

FIG. 23 shows an exemplary bad pixel removal method FPGA implementation diagram, in which each yellow unit is a VHDL component;

FIG. 24 shows an exemplary, illustrative non-limiting data flow for bad pixel removal;

FIG. 25 shows an exemplary, illustrative non-limiting diagram for “W-means” unit FPGA implementation;

FIG. 26 shows an exemplary, illustrative non-limiting generate kernel component diagram for “W-means” algorithm, where the red annotations are color groups;

FIG. 27 shows an exemplary, illustrative non-limiting distance computation component diagram for “W-means” algorithm, in which “ccg(i)” is the center color group with color number i, “cg(x)(i)” is the neighbor number x with color number i and “d(x)” is the result distance for the neighbor number x. i ∈ [1, 4], x ∈ [1, 8];

FIG. 28 shows an exemplary, illustrative non-limiting filter core “thr_optdiv’ component diagram for “W-means” algorithm, in which “ccg(i)” is the center color group with color number i, “cg(x)(i)” is the neighbor number x with color number i, and “fcg(i)” is the center color group with color number i. i ∈ [1, 4], x ∈ [1, 8];

FIG. 29A shows an exemplary, illustrative non-limiting format output component diagram for “W-means” algorithm, while FIG. 29B shows an exemplary, illustrative valid output color group for “W-means” algorithm in a CFA (color filter array) image. In this example the CFA colors are “GBRG” (first image row start with green then blue and the second row starts with red then green);

FIG. 30 shows an exemplary, illustrative non-limiting data flow for bad pixel removal and denoising;

FIGS. 31A and 31B show final test results on the camera module for both the bad pixel and “W-means” algorithms. Image size (150×150) (zoom);

FIG. 32 shows a non-limiting exemplary method for color correction according to at least some embodiments; and

FIGS. 33A-33D show a non-limiting exemplary FPGA configuration according to at least some embodiments.

### DETAILED DESCRIPTION OF AT LEAST SOME EMBODIMENTS

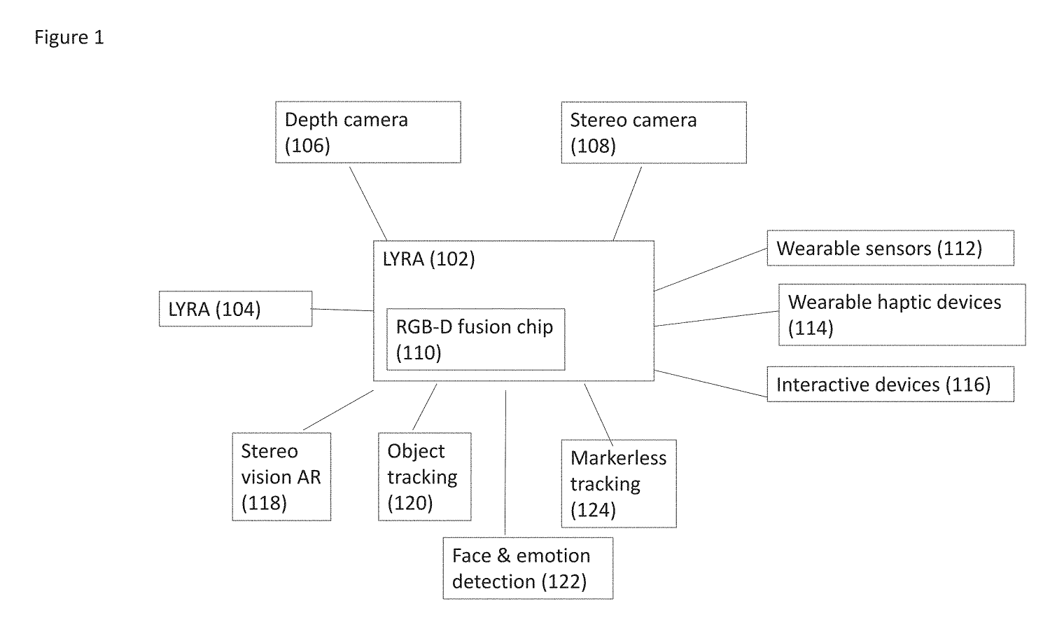

FIG. 1 shows a non-limiting example of a system according to at least some embodiments of the present disclosure. As shown, a system 100 features a multi-modal interaction platform 102, which can be chained to one or more additional multi-modal interaction platforms 104 as shown. Multi-modal interaction platform 102 can in turn be in communication with a depth sensor (e.g., camera) 106, a stereo sensor (e.g., camera) 108, and an RGB-D fusion chip 110. Depth camera 106 is configured to provide depth sensor data, which may be pixel data, for example, according to TOF (time of flight) relative to each pixel. Stereo camera 108 is configured to provide stereo camera data (pixel data) from left (first) and right (second) camera sensors (not shown). Stereo sensor 108 provides stereo RGB (red green blue) data as is known in the art and may be referred to as a “stereo RGB sensor (or camera)”. Such data may be referred to as stereo visual pixel data (SVPD). Optionally, the functions of stereo sensor 108 and depth camera 106 may be combined to a single device (not shown).

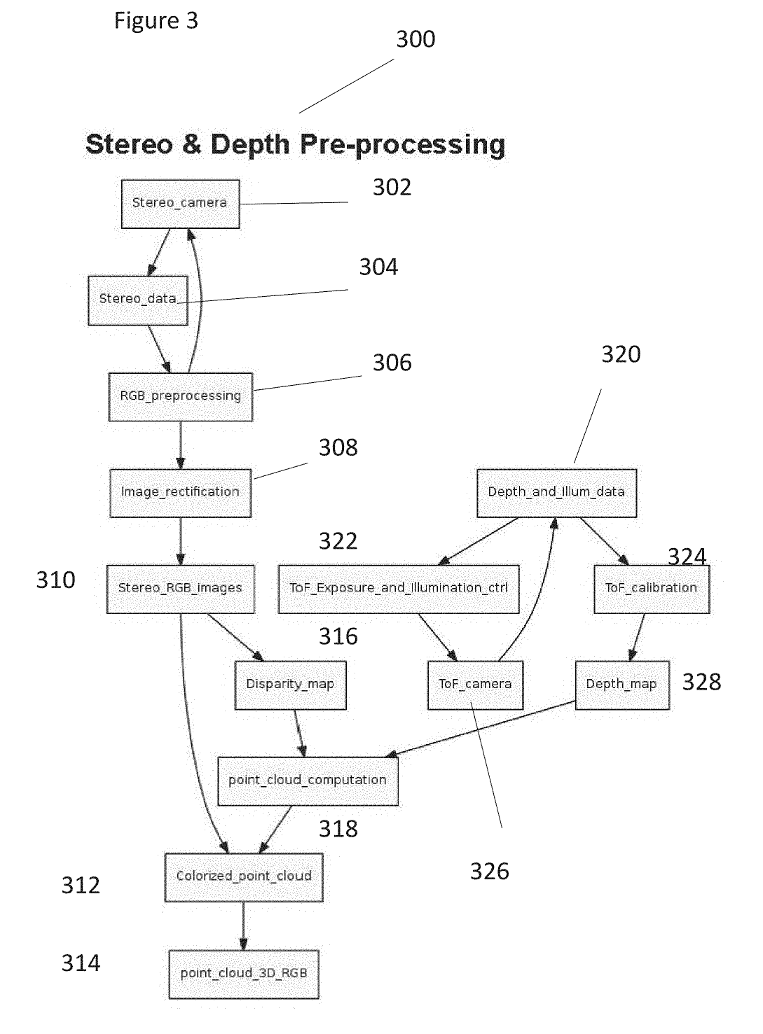

RGB-D fusion chip 110 may optionally be implemented in a variety of ways, for example according to a RGB-D fusion module which may feature software, hardware, firmware or a combination thereof. The functions of RGB-D fusion chip 110 are described in greater detail with regard to FIG. 3, but preferably include preprocessing of stereo camera data and depth data, to form a 3D point cloud with RGB data associated with it. The formation of the point cloud enables its use for tracking a body or a portion thereof, for example (or for other types of processing), by multi-modal interaction platform 102. Multi-modal interaction platform 102 can then output data to a visual display (not shown) or a wearable haptic device 114, for example to provide haptic feedback. One or more interactive objects or tools 116 may be provided to give or receive feedback or instructions from multi-modal interaction platform 102, or both.

A plurality of additional functions may be provided through the components described herein, alone or in combination, with one or more additional sensors, provided through outputs from multi-modal interaction platform 102. For example, a stereo vision AR (augmented reality) component 118 can be provided to display an AR environment according to tracking data of the subject and other information received from multi-modal interaction platform 102. Such object tracking can be enabled by an object tracking output 120. Various tracking devices can support such tracking as described herein. Detection of a human face, optionally with detection of emotion, may be provided through such an output 122. Markerless tracking 124, in which an object is tracked without additional specific markers placed on it, may also be provided. Other applications are also possible.

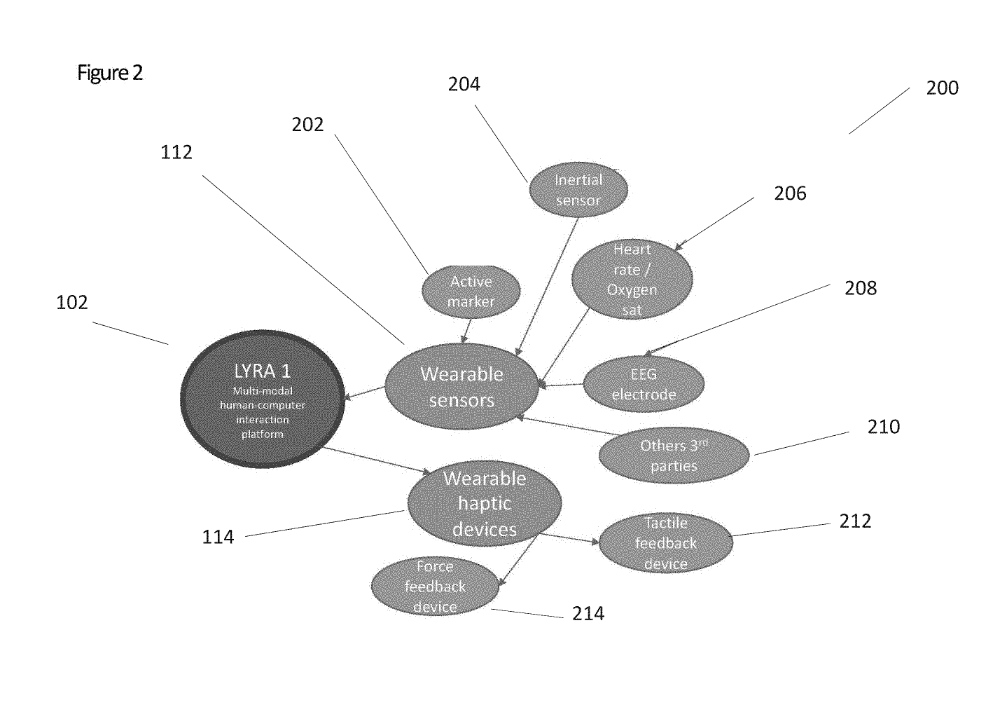

FIG. 2 shows a detail of the system of FIG. 1, shown as a system 200. In this FIG., multi-modal interaction platform 102 is shown as connected to a plurality of different wearable sensors 112, including, but not limited, to an active marker 202 (as a non-limiting example of a tracking device), which can, for example, provide an active signal for being detected, such as an optical signal (for example) which would be detected by the stereo camera; an inertial sensor 204, for providing an inertial signal that includes position and orientation information; biological sensors such as a heart rate/oxygen saturation sensor 206 and EEG electrodes 208; and/or one or more additional sensors 210. Other biological sensors such as an oxygen saturation sensor, an EKG or EMG sensor, or other sensors that capture biological data of a subject can be used. Optionally biological sensors can be used separately or in combination. Operation of some wearable sensors 112 in conjunction with multi-modal interaction platform 102 is described in greater detail below.

Multi-modal interaction platform 102 is also shown as connected to a plurality of different wearable haptic devices 114, including one or more of a tactile feedback device 212 and a force feedback device 214. For example and without limitation, such wearable haptic devices 114 could include a glove with small motors on the tips of the fingers to provide tactile feedback or such a motor connected to an active marker.

FIG. 3 shows a non-limiting example of a method for preprocessing according to at least some embodiments of the present disclosure. As shown, preprocessing starts at 302 with input from the stereo camera, provided as stereo data 304. Stereo data 304 undergoes RGB preprocessing 306, which in turn feeds back to the operation of stereo camera 302, for example, with regard to the autogain and autoexposure algorithm, described in greater below. In 308, image rectification is performed, to control artifacts caused by the lens of the camera. In some embodiments, a calibration process can be performed to prevent distortion of the image data by the lens, whether at the time of manufacture or at the time of use.

Optionally, the camera calibration process is performed as follows. To perform all these steps, intrinsic and extrinsic parameters of the cameras are needed to know how they are positioned one to each other, to know their distortion, their focal length and so on. These parameters are often obtained from a calibration step. This calibration step optionally comprises taking several pictures of a chessboard pattern with the cameras and then computing the parameters by finding the pattern (of known size) inside the images.

From the intrinsic calibration process, the intrinsic parameters of each camera are extracted and may comprise the following:
Focal length: in pixels, (fx, fy);
Principal point: in pixels, (cx, cy);
Skew coefficient: defines the angle between the horizontal and vertical pixels axes, α_{c};
Distortion coefficients: radial (k₁, k₂, k₃, k₄, k₅, k₆) and tangential (p₁, p₂) distortion coefficients.

Then, from the extrinsic calibration process, the position of one camera to the other can be extracted by having a 3×3 rotation matrix r and a 3×1 translation vector t.

In 310, stereo RGB images that have been preprocessed may then be processed for colorization and for creating a disparity map 316, such may then be fed to a colorized point cloud formation process 312. The process in 312 may be performed, for example, as described in the paper “Fusion of Terrestrial LiDAR Point Clouds with Color Imagery”, by Colin Axel, 2013, available from http://www.cis.rit.edu/DocumentLibrary/admin/uploads/CIS000202.PDF. However, optionally, determination of the sensor position and orientation may be dropped, since the stereo camera and depth sensor can both be calibrated, with their position and orientation known before processing begins. In addition, pixels from the RGB camera can be matched with pixels from the depth sensor, providing an additional layer of calibration. The colorized point cloud can then be output as the 3D point cloud with RGB data in 314.

Turning back to 310, the disparity map 316 is created in 312 by obtaining the depth information from the stereo RGB images and then checking the differences between stereo images. The disparity map 316, plus depth information from the depth sensor in the form of a calibrated depth map 328 (as described in greater detail below), is combined for the point cloud computation in 318, for a more robust data set.

Depth information from the depth sensor can be obtained as follows. Depth and illumination data is obtained in 320, from TOF (time of flight) camera 326. The depth and illumination data may then be processed along two paths, a first path for TOF control 322, which in turn feeds back to TOF camera 326 to control illumination and exposure time according to the illumination data. A second path for TOF calibration 324 can then be used to correct the TOF image, by applying the factory calibration, which in turn feeds corrected TOF depth data into the depth map 328. Calibration of the TOF function may be required to be certain that the depth sensor data is correct, relative to the function of the depth sensor itself. Such calibration increases the accuracy of depth map 328. Depth map 328 can then be fed into 318, as described above, to increase the accuracy of creating the colorized point cloud.

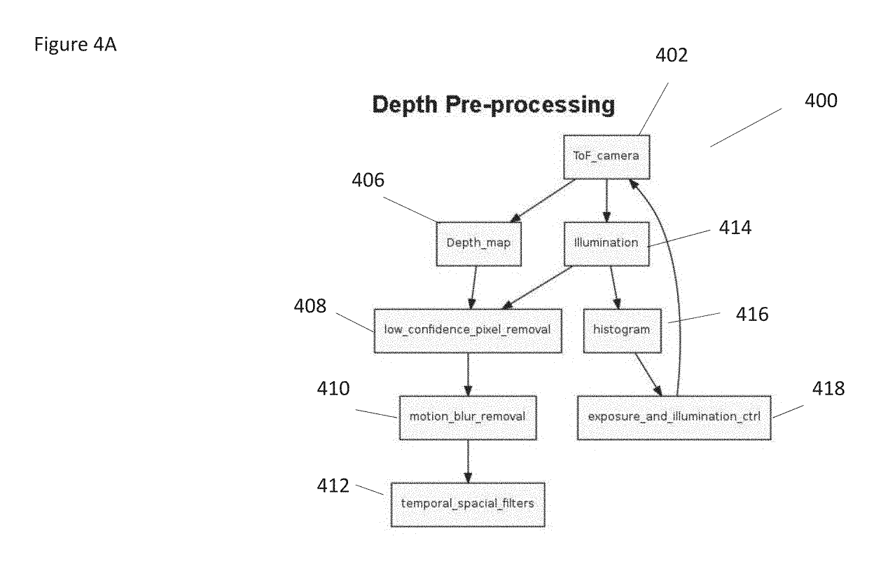

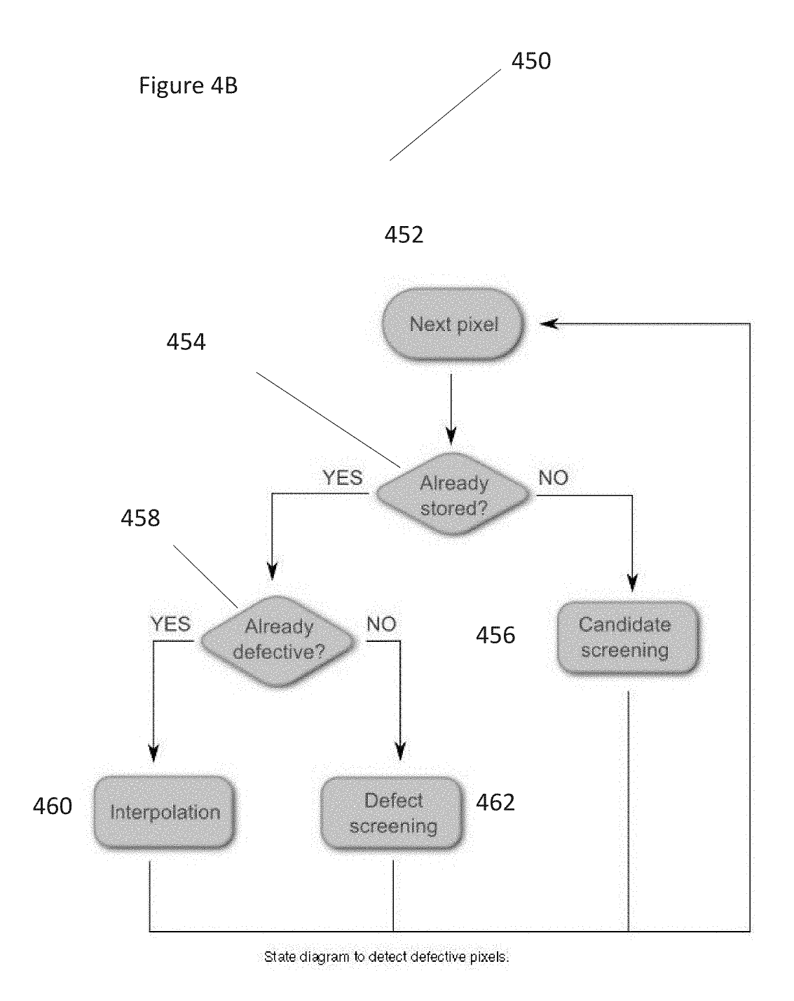

FIGS. 4A and 4B show a non-limiting example of a method for depth preprocessing according to at least some embodiments of the present disclosure, which shows the depth processing method of FIG. 3 in more detail. Accordingly, as shown in FIG. 4A, a depth preprocessing process 400 starts with image (e.g., pixel) data being obtained from a TOF camera in 402, which may be used to create a depth map in 406, but may also may be used to determine a level of illumination in 414 for each pixel. The level of illumination can then be fed into a low confidence pixel removal process 408. This process compares the distance that a pixel in the image is reporting and correlates this reported distance to the illumination provided by that pixel. The settings for process 408 can be decided in advance, according to the acceptable noise level, which may for example be influenced by the application using or consuming the data. The lower the acceptable noise level, the lower the amount of data which is available. If the illumination is outside of a predetermined acceptable range, the distance cannot be accurately determined. Preferably, if this situation occurs, the pixel is removed.

A histogram process 416, which enables autoexposure and autogain adjustments, is described in greater detail below.

After removal of low confidence pixels in 408, the depth processing can continue with motion blur removal in 410, which can remove artifacts at edges of moving objects in depth (i.e., removing the pixels involved). The application of temporal and spatial filters may be performed in 412, which are used to remove noise from the depth (spatial) and average data over time to remove noise (temporal). Spatial filters attenuate noise by reducing the variance among the neighborhood of a pixel, resulting in a smoother surface, but potentially at the cost of reduced contrast. Such a spatial filter may be implemented as a Gaussian filter for example, which uses a Gaussian weighting function, G(p−p′) to average the pixels, p′, within a square neighborhood, w, centered about the pixel, p.

Turning back to histogram process 416, the information obtained therefrom may also be passed to an exposure and illumination control process 418 as previously described, which is used to adjust the function of TOF camera 402. FIG. 4B shows an exemplary illustrative non-limiting method for detecting defective pixels according to at least some embodiments of the present disclosure, which can be used for example with the method of FIG. 4A, for example to remove low confidence pixels as previously described. The process 450 can be divided into three steps: interpolation 460, defect screening 462, candidate screening 456 (for example).

While each incoming pixel (452) reaches the center of the moving window obtained in the buffer of the FPGA (field-programmable gate array), it is checked to determine if it was previously stored (in memory) as being defective (454). If not previously stored, the module proceeds to perform the candidate screening process (456) where the value of the pixel under test is compared toward surrounding neighbors average. If a certain threshold, TH_NEIGH, is exceeded, the inspected pixel is suspected to be defective, hence its data (value, position, neighbor average) are stored for further analysis.

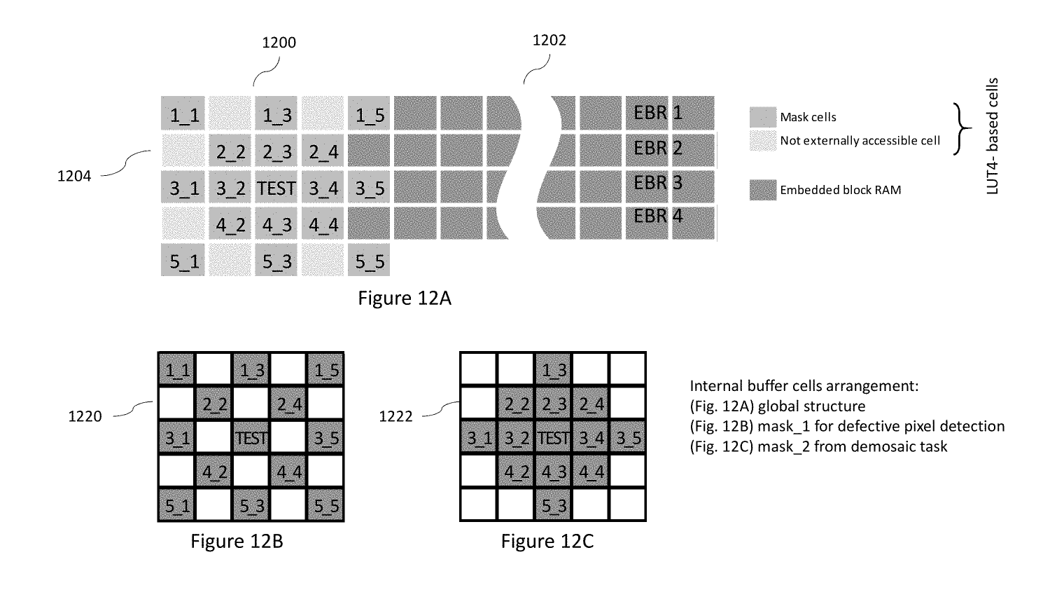

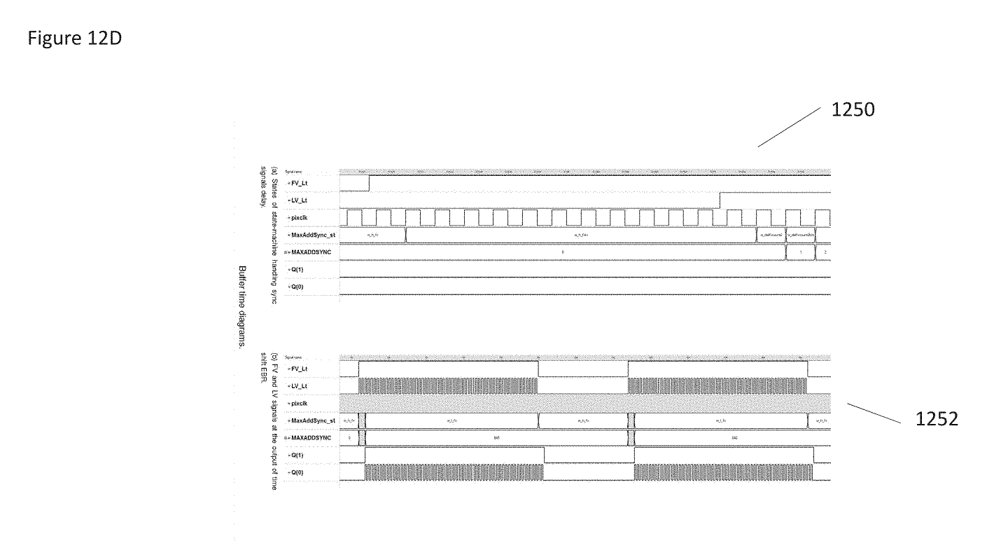

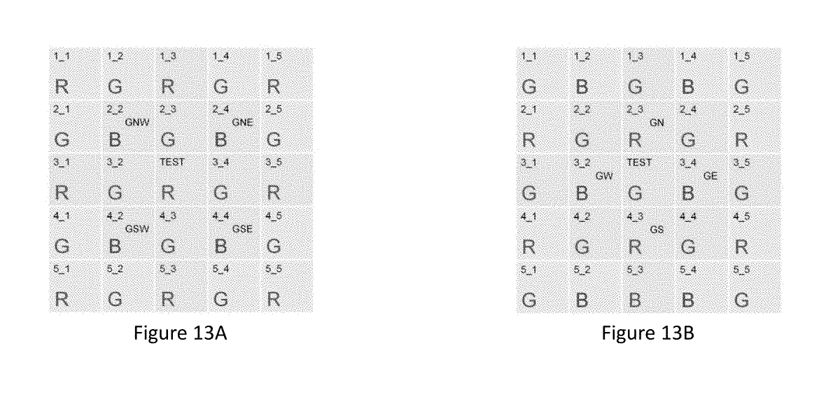

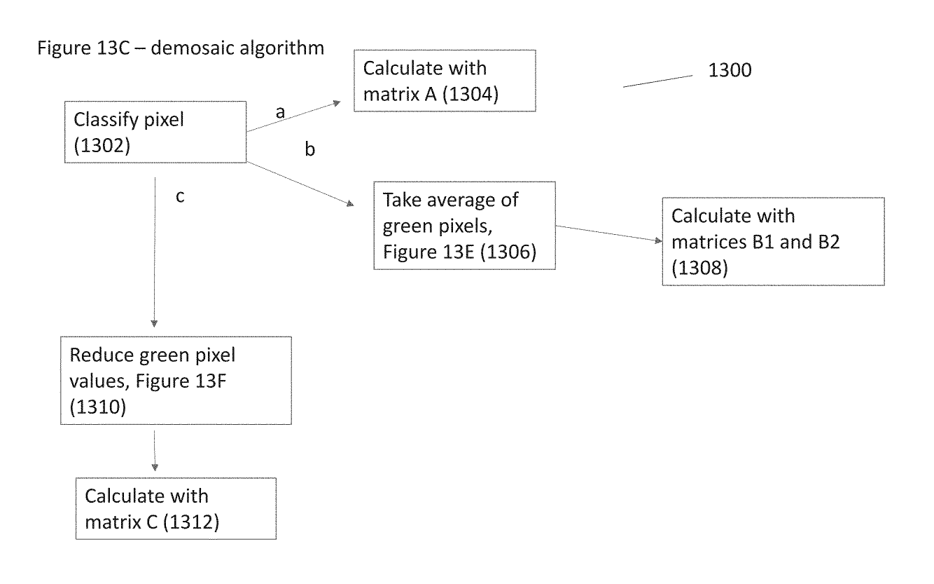

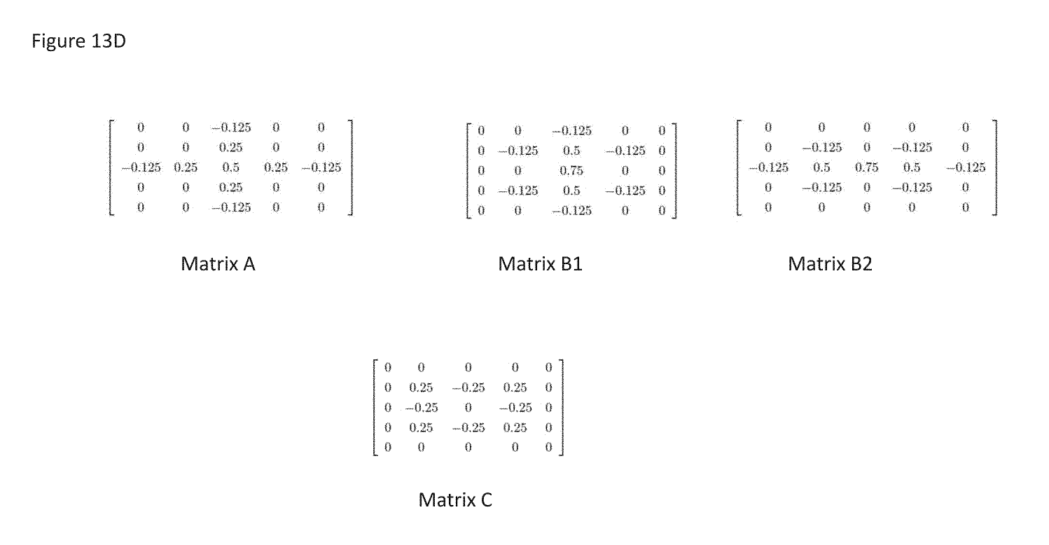

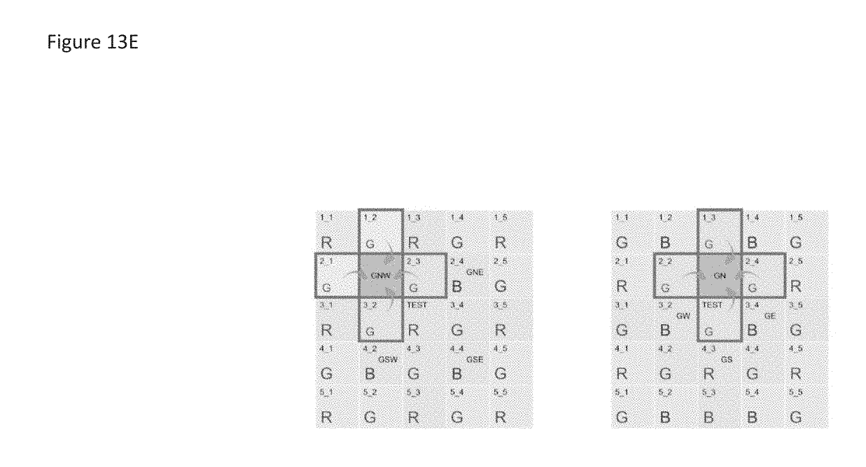

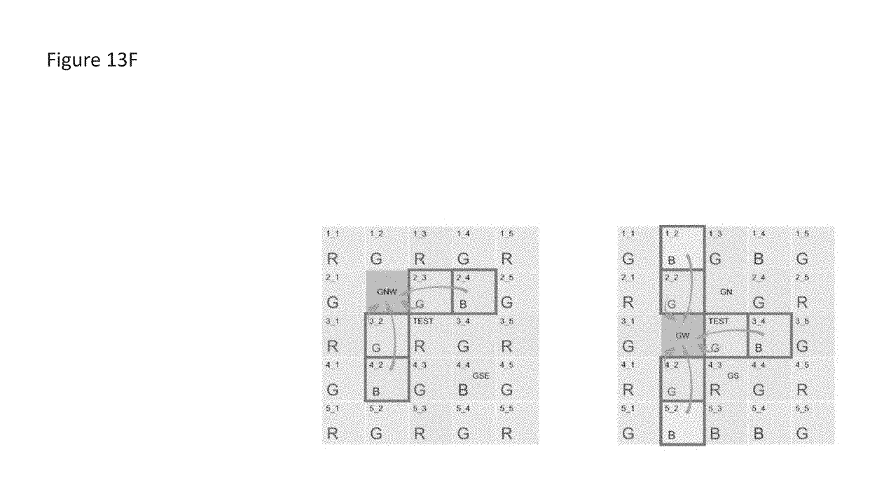

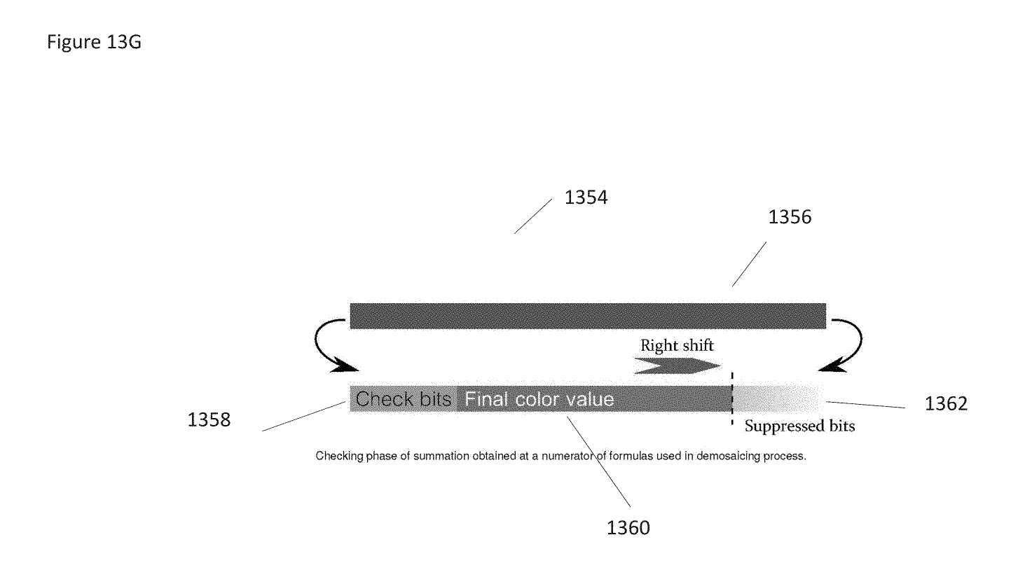

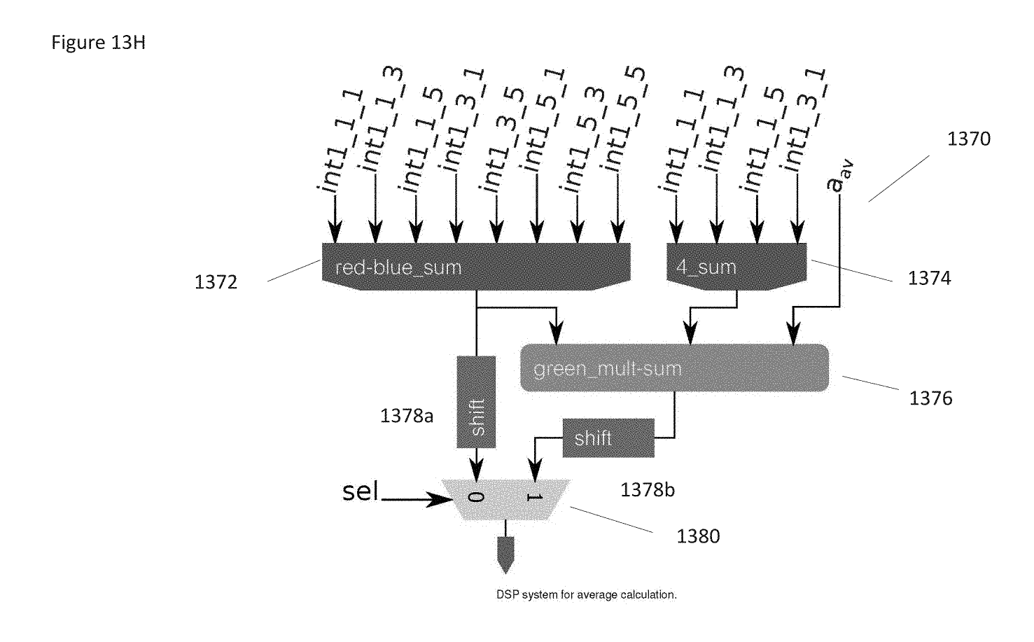

A stored pixel is checked to determine whether it was previously labeled as defective (458), which leads to interpolation (460). If not previously labeled as defective, the pixel undergoes defect screening (462) by comparing its actual and previous values. A higher difference between these values as compared to the threshold TH_DIFF (to cancel effects of noise) corresponds to the pixel changing regularly, such that the pixel is no longer suspected as being defective. A time constant is incremented for each period of time that the pixel remains under suspicion of being defective. Another threshold, TH_FRAME, is defined and used to compare the value of the time constant. Once a pixel value (excluding noise) remains unchanged for a certain number of frames, such that the value of the time constant is equal to the second threshold of TH_FRAME, the pixel is determined to be defective. Now the interpolation step (460) becomes active, so that defective pixel is corrected before it slides toward first mask_2 memory cell. Interpolation may be performed by substituting an investigated pixel value with the average of its surrounding pixel. The average can be calculated among those pixels having the same filter color as the one in the center of the mask, which is discussed in more detail in reference to FIGS. 12A-13B. An example of such a process is demonstrated in following pseudo-code form:

```
for pixel=1 to endFrame do
  if pixel already stored then
    if pixel already defective then
      Interpolate pixel
    else if|pixel-previousPixelValue|≤TH_DIFF
      then if timeConst=TH_FRAME then
        Add pixel to defects list
      else
        Increment timeConst
      end
    else
      Remove pixel from candidate list
    end
  else if memory not full then
    if|pixel-neighborsAverage|≥ TH_NEIGH then
      Add pixel to candidate list
    end
  end
end
```

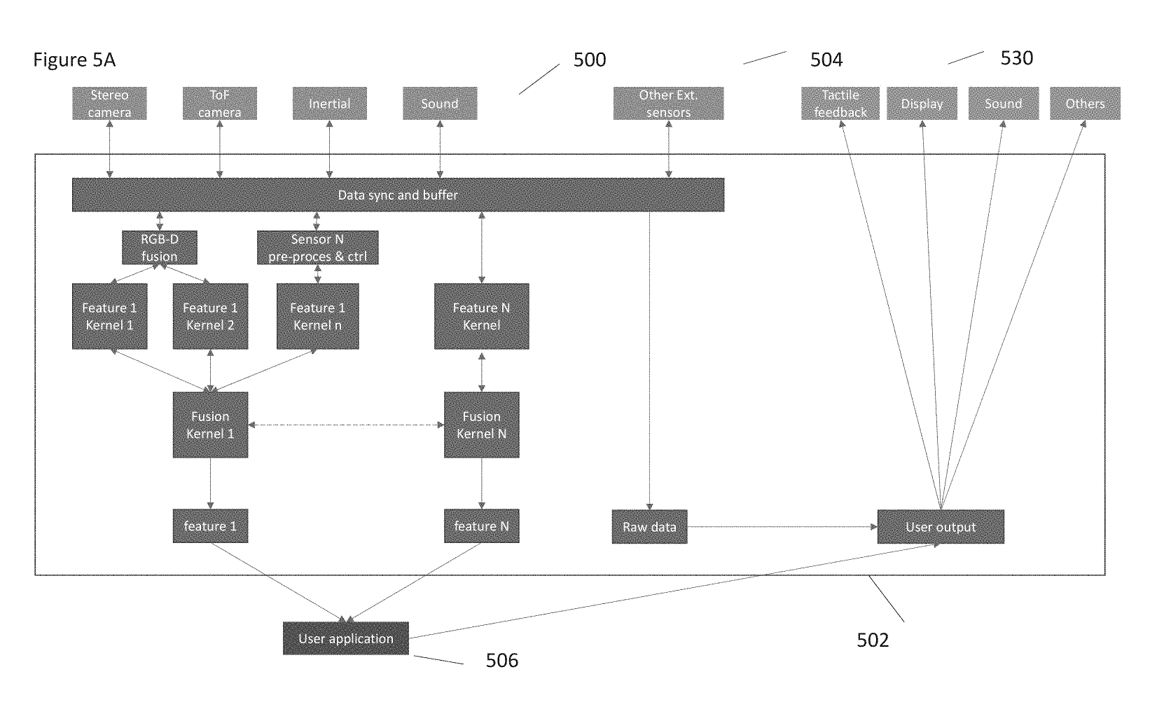

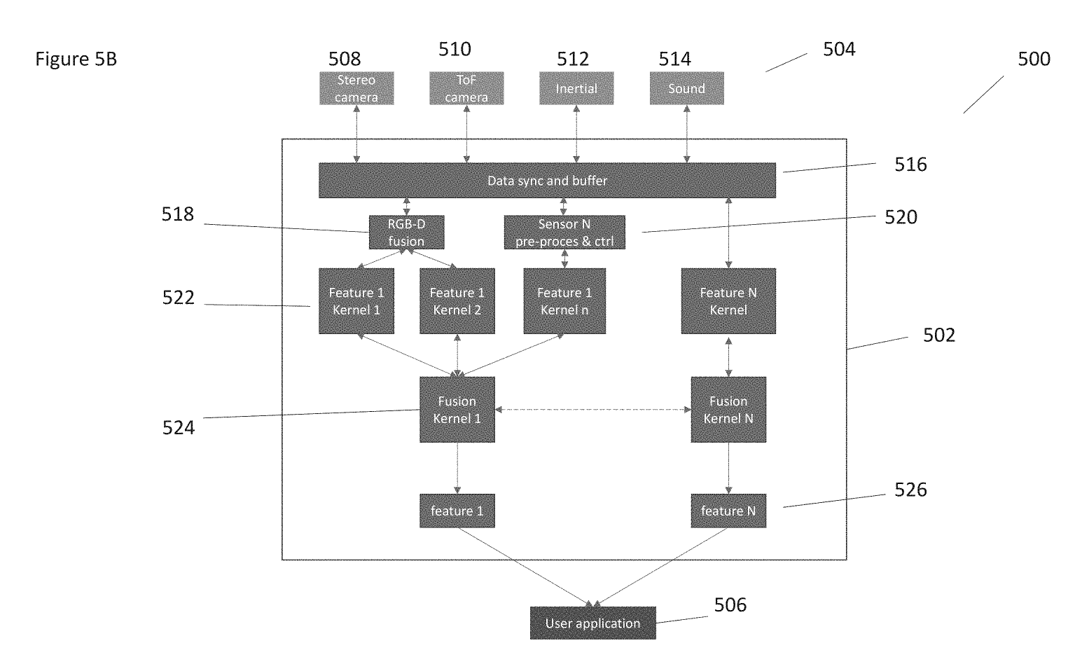

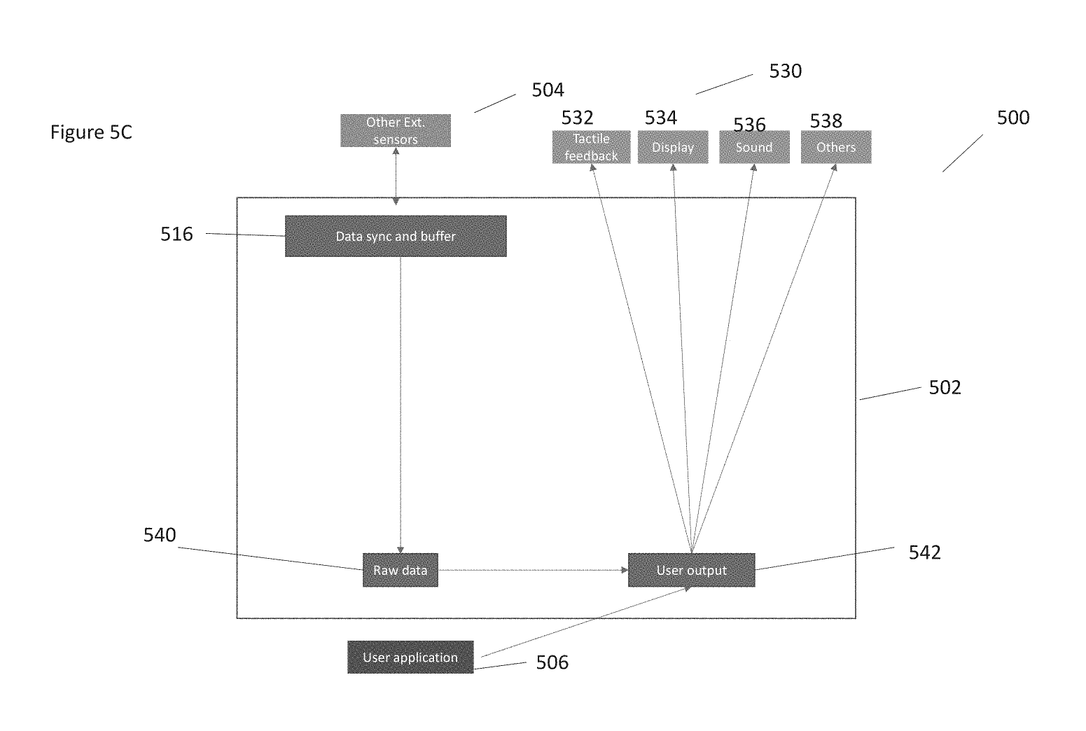

FIGS. 5A-5C show a non-limiting example of a data processing flow for the FPGA according to at least some embodiments of the present disclosure. FIG. 5A shows the overall flow 500, which includes input from one or more sensors 504, which can include a stereo camera, ToF camera, inertial sensor, sound input device, other external sensors, or some combination thereof, and output to one or more output devices 530, which can include a tactile feedback device, display, sound output device, some other output device, or some combination thereof. Input from sensors 504 can be processed through FPGA process 502 and then sent to a user application 506. User application 506 may then return output to output devices 530.

FIG. 5B describes the detailed flow for some exemplary input sensors 504. Thus, and for example, as shown, exemplary input sensors 504 include one or more of a stereo camera 508, a ToF camera 510, an inertial sensor 512 and a sound input device 514. A non-limiting example of sound input device 514 could include a microphone for example. Input from input sensors 504 may be received by a data sync and buffer 516, which operates as described in greater detail below, to synchronize various data streams (including without limitation between inputs of stereo camera 508, and between stereo camera 508 and ToF camera 510) according to a plurality of clocks. Data sync and buffer 516 can also buffer data as described in greater detail below. In terms of buffering functions, the buffer part of data sync and buffer 516 is configured to provide a moving window. This allows data processing to be performed on a portion of a frame when data are serially sent.

Optionally one or more input sensors 504 are asynchronous sensors. As a non-limiting example, an asynchronous sensor implementation for a camera does not send data at a fixed frame rate. Instead, such a sensor would only send data when a change had been detected, thereby only sending the change data.

Data may then pass to an RGB-D fusion chip process 518, the operation of which was described with regard to FIG. 3, and which preprocesses the data for depth and RGB processing. Data can also pass to a sensor specific preprocess and control 520 for sensors other than stereo camera 508 and ToF camera 510, to prepare the sensor data for further use (for example, in regard to calibration of the data).

Next, data may pass to a layer of feature specific kernels 522, which receive data from RGB-D fusion chip process 518, sensor specific preprocess and control 520, and data sync and buffer 516. Feature specific kernels 522 may be operated according to the OPENCL standard, which supports communication between the FPGA and the CPU of the computational device operating user application 506 (not shown). Feature specific kernels 522 may also receive data directly from data sync and buffer 516, for example, to control the sensor acquisition and to provide feedback to data sync and buffer 516, to feed back to sensors 504.

Feature specific kernels 522, according to some embodiments, take data related to particular features of interest to be calculated, such as the previously described point cloud of 3D and RGB data, and calculate sub-features related to the feature. Non-limiting examples of such features may also include portions of processes as described herein, such as the de-mosaic process, color correction, white balance and the like. Each feature specific kernel 522 may have an associated buffer (not shown), which is preferably designed in order to provide a moving window. This allows data processing to be performed on a portion of a frame when data is serially sent.

Next, the sub-features can be passed to a plurality of fusion kernels 524, to fuse the sub-features into the actual features, such as the previously described point cloud of 3D and RGB data. Specific feature specific kernels 522 and fusion kernels 524 processes are described in greater detail below. Fusion kernel 524 can also report that a particular feature specific kernel 522 is missing information to the feature specific kernel that reports any missing information to sensors 504 through data sync and buffer 516. These features 526 may then be passed to user application 506 which may request specific features 526, for example, by enable specific fusion kernels 524, as needed for operation.

Among the advantages of calculation by feature specific kernels 522 and fusion kernels 524 according to some embodiments, is that both are implemented in the FPGA (field programmable array), and hence may be calculated very quickly. Both feature specific kernels 522 and fusion kernels 524 may be calculated by dedicated elements in the FPGA which can be specifically created or adjusted to operate very efficiently for these specific calculations. Even though features 526 may require intensive calculations, shifting such calculations, away from a computational device that operates user application 506 (not shown) and to the FPGA process 502, significantly increases the speed and efficiency of performing such calculations.

Optionally the layer of feature specific kernels 522 and/or the layer of fusion kernels 524 may be augmented or replaced by one or more neural networks. Such neural network(s) could be trained on sensor data and/or on the feature data from the layer of feature specific kernels 522.

Optionally, specific sub-features could be provided for analyzing biological data as described herein, for example from biological sensors as described herein. Analysis of biological data is well known in the art. For example, analysis of EEG data is known to include but not be limited to determining whether the data is of sufficiently high quality (for example having a sufficiently low impedance and/or not having excessive noise), analyzing the data for features as is known in the art, for example as sequences and/or according to the presentation of stimuli. Features could then be created from these sub-features for biological data.

FIG. 5C shows the operation of the process 500 as it relates to additional external sensors 504 and output devices 530. Input from additional external sensors 504 may be transmitted to data sync and buffer 516, and then to a raw data processor 540, for example, for the display or other output device 530, that requires a raw pipe of data, optionally with minor modifications, to avoid sending all of the data to user application 506, which is operated by a slower computational device (thereby avoiding delay). Raw data processor 540 could also optionally receive data from stereo camera 508 (not shown) as a raw feed. From raw data processor 540, the sensor input data can be sent to a user output controller 542 for being output to the user.

Output from user application 506 can also be sent to user output controller 542, and then to output devices 530. Non-limiting examples of output devices 530 include a tactile feedback device 532, a display 534, a sound output device 536 and optionally other output devices 538. Display 534 can display visual information to the user, for example, as part of a head mounted device, for example for VR (virtual reality) and AR (augmented reality) applications. Similarly, other output devices 530 could provide feedback to the user, such as tactile feedback by tactile feedback device 532, as part of VR or AR applications.

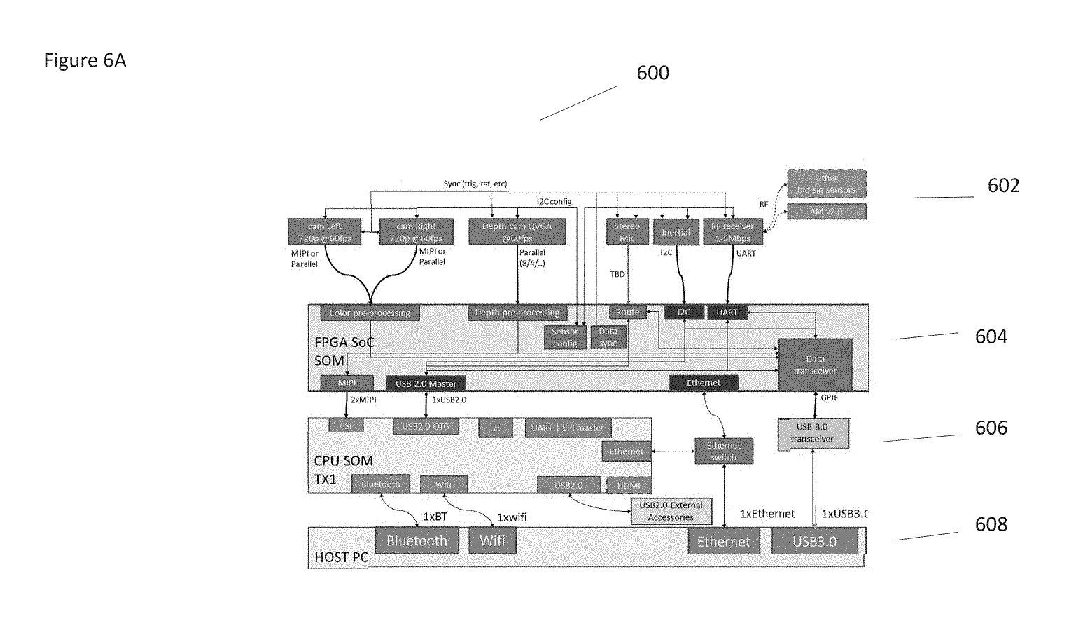

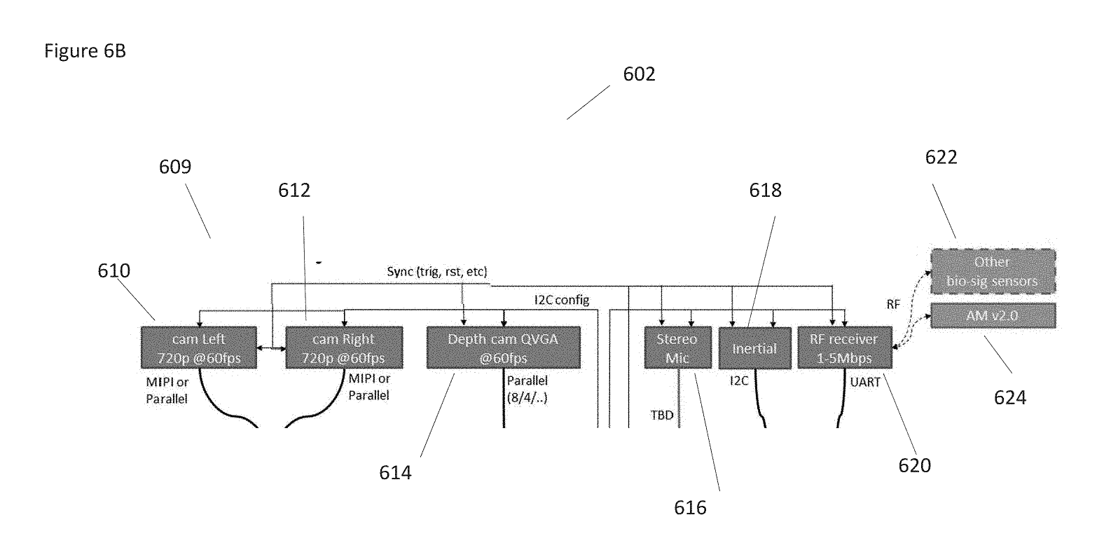

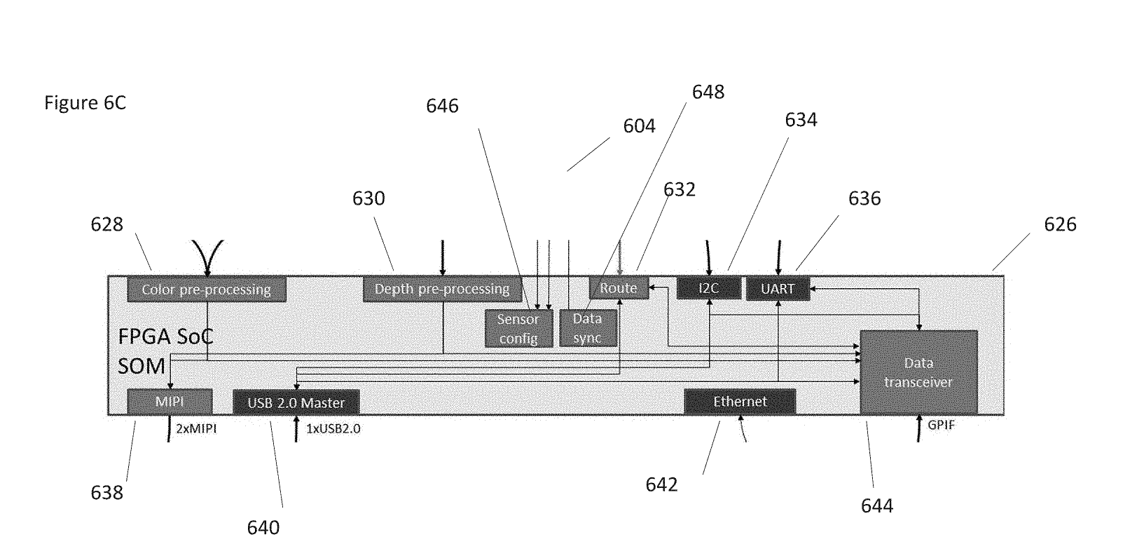

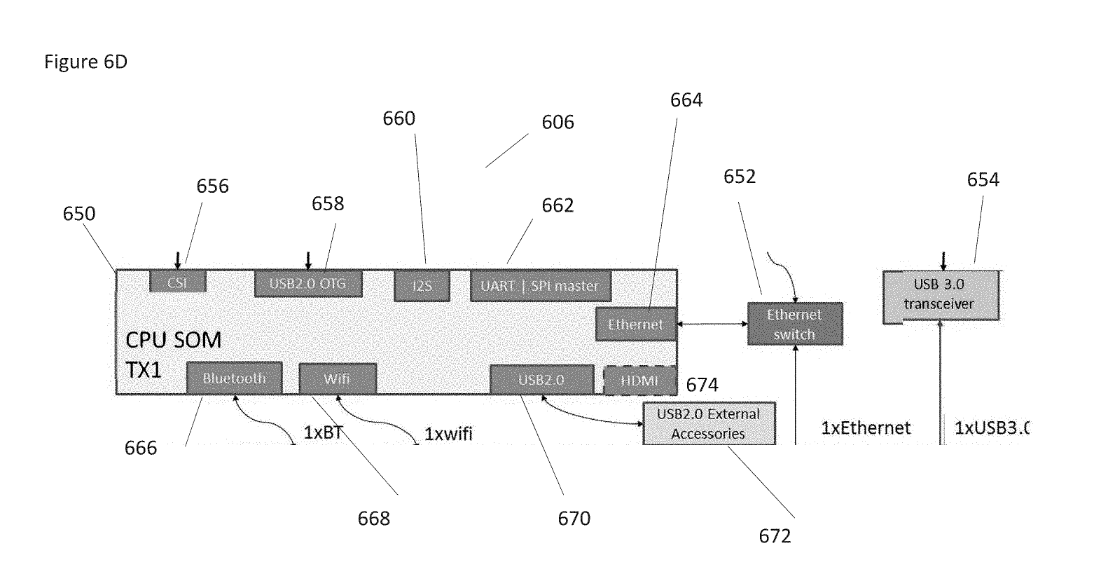

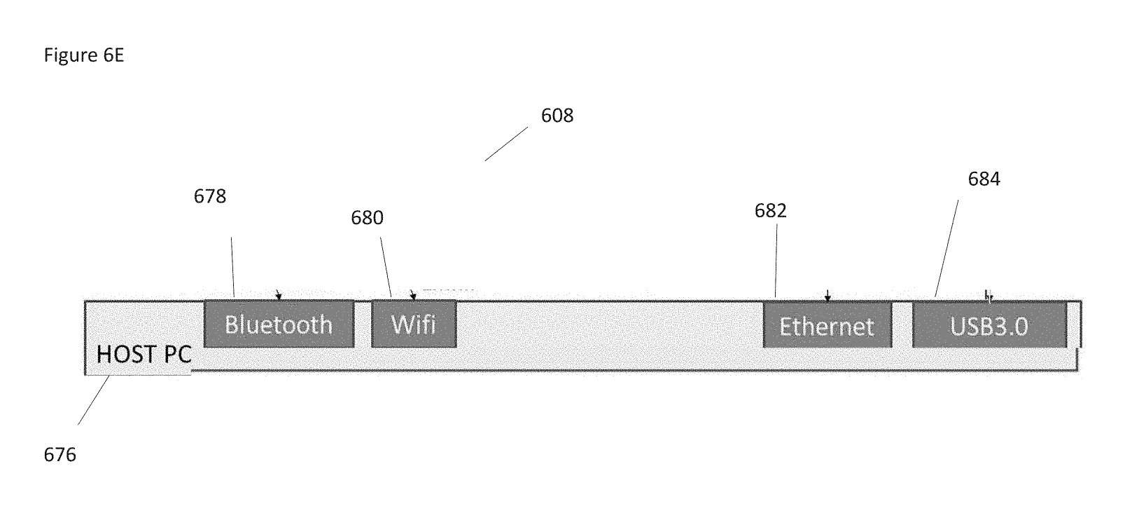

FIGS. 6A-6E show an exemplary, illustrative, non-limiting hardware system for the camera according to at least some embodiments of the present disclosure. FIG. 6A shows the overall hardware system 600, featuring a plurality of layers 602, 604, 606 and 608. Layer 602 features a plurality of inputs. Layer 604 features FPGA hardware, which may optionally function as described with regard to FIG. 5. Layer 606 relates to CPU hardware and associated accessories. Layer 608 relates to a host computer. FIG. 6B shows layer 602 in more detail, including various inputs such as a stereo camera 609, featuring a left camera 610 and a right camera 612, which in this non-limiting example, feature 720 pixels and 60 fps (frames per second). Each of left camera 610 and right camera 612 may communicate with the FPGA (shown in the layer illustrated in FIG. 6C) according to a standard such as MIPI (Mobile Industry Processor Interface) or parallel communication.

A depth sensor 614 is shown as a ToF camera, in this non-limiting example implemented as a QVGA (Quarter Video Graphics Array) camera operating at 60 fps, which communicates with the FPGA according to parallel communication. Audio input may be obtained from a stereo microphone 616 as shown. An inertial sensor 618 may be used to obtain position and orientation data. A radio-frequency (RF) receiver 620 may be used to collect data from other external sensors, which may be worn by the user for example, such as a biological sensor 622 and an AM (active marker) sensor 624, as previously described.

FIG. 6C shows layer 604, which includes a FPGA 626, which may operate as described with regard to FIG. 5. FPGA 626 may be implemented as an FPGA SoC SOM, which is a field-programmable gate array (FPGA) which features an entire system on a chip (SoC), including an operating system (so it is a “computer on a chip” or SOM—system on module). FPGA 626 includes a color preprocessing unit 628 which receives data from stereo camera 609, and which preprocesses the data as previously described, for example with regard to FIG. 3. A depth preprocessing unit 630 receives depth data from depth sensor 614, and preprocesses the data as previously described, for example with regard to FIGS. 3 and 4.

A sensor config 646 optionally receives configuration information from stereo camera 609 and depth sensor 614, for example, to perform the previously described synchronization and calibration of FIG. 3. Similarly, sensor config 646 optionally receives configuration information from the remaining sensors of layer 602, again to perform synchronization and calibration of the data, and also the state and settings of the sensors. Synchronization is controlled by a data sync module 648, which instructs all sensors as to when to capture and transmit data, and which also provides a timestamp for the data that is acquired. A route module 632 can receive input from stereo microphone 616, to convert data for output to USB port 640 or data transceiver 644.

Inertial sensor 618 may communicate with FPGA 626 according to the I2C (Inter Integrated Circuit) protocol, so FPGA 626 includes an I2C port 634. Similarly, RF receiver 620 may communicate with FPGA 626 according to the UART (universal asynchronous receiver/transmitter) protocol, so FPGA 626 features a UART port 636. For outputs, FPGA 626 can include one and/or another of a MIPI port 638, a USB port 640, an Ethernet port 642 and a data transceiver 644.

Turning now to FIG. 6D, the elements of layer 606 are shown, which can include one and/or another of a CPU 650, an Ethernet switch 652, and a USB transceiver 654. CPU 650 may handle calculations otherwise handled by FPGA 626 if the latter is temporarily unable to process further calculations, or to perform other functions, such as functions to assist the more efficient operation of a user application (which would be run by the host computer of layer 608). CPU 650 may be implemented as a SOM. Inputs to CPU 650 optionally include a CSI port 656 (for communicating with MIPI port 638 of FPGA 626); a USB port 658 (for communicating with USB port 640 of FPGA 626); an I2S 660 for transferring sound from the microphone; and UART/SPI master 662 for providing the RF receiver data to the CPU processors.

Also shown in FIG. 6D, a Bluetooth output 666 may be used to communicate with a Bluetooth port 678 of host computer 676 (shown in layer 608, FIG. 6E). Similarly, a WiFi output 668 may be used to communicate with a WiFi port 680 of host computer 676. USB port 670 may be used to communicate with external accessories through their ports 672. HDMI 674 can also be available for display connection. Ethernet switch 652 may be configured to handle communication from any one or more of Ethernet port 642 of FPGA 626, Ethernet port 664 of CPU 650, and also Ethernet port 682, of host computer 676 (shown in layer 608, FIG. 6E). Such communication may be bidirectional in these cases. Similarly, USB transceiver 654 handles communication from data transceiver 644 of FPGA 626, as well as from USB port 684 of host computer 676 (shown in layer 608, FIG. 6E). Such communication may be bidirectional in both cases. FIG. 6E shows layer 608, the functions of which were previously described.

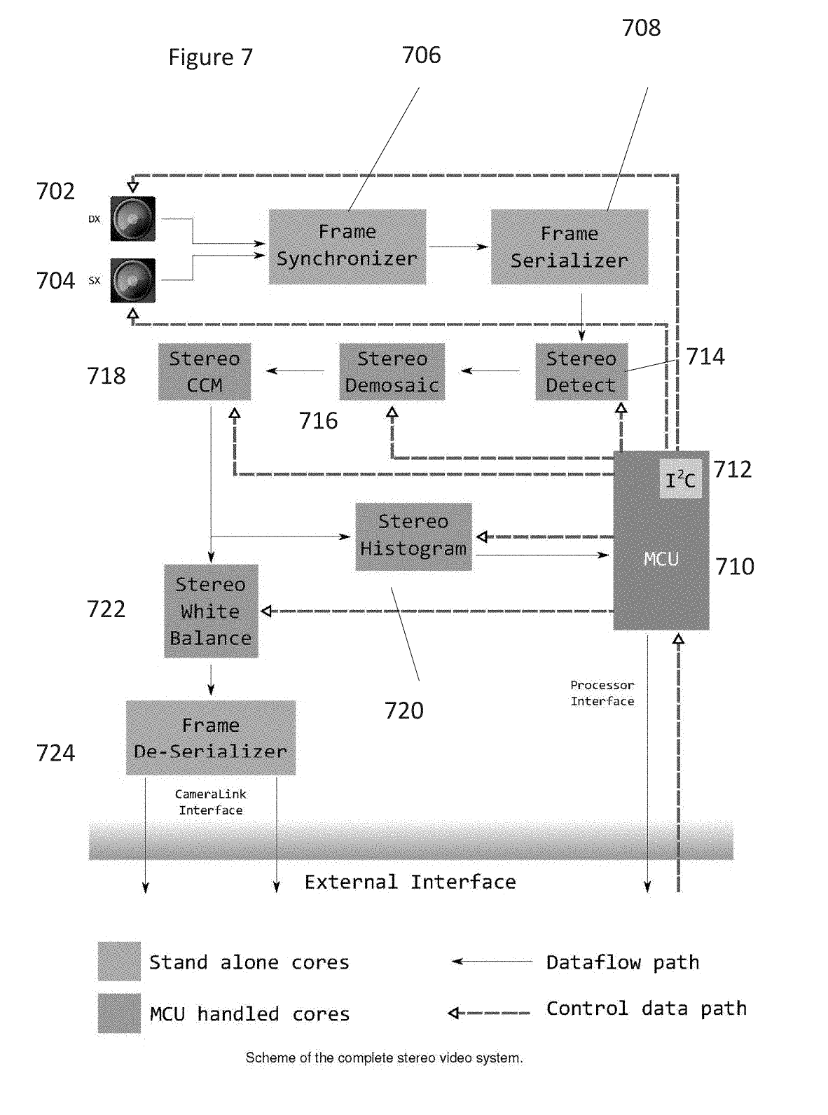

FIG. 7 shows a non-limiting example of a method for stereo processing according to at least some embodiments of the present disclosure, the functionality of which may be contained within the FPGA of FIG. 6. As shown, a process 700 can start with input from left RGB camera 702 and right RGB camera 704, of RGB data as previously described. Such input may be sent to a frame synchronizer 706, which synchronizes frames between the two cameras to eliminate time shift. This task may be performed in two stages. In a first stage, the input flows are sampled in such a way that they are synchronized with the same clock. In a second stage, a state machine detects which flow is in advance with respect to the other one so that it directs this flow toward a First Input First Output (FIFO). In this way, the first flow reaching frame synchronizer 706 is delayed until the other data flow reaches frame synchronizer 706 as well. Additional details are provided below.

A frame serializer 708 serializes the frame data as a sequence of bytes and the serialized data is passed to a stereo detect module 714, which performs the previously described “bad” or non-usable pixel detection. The data then undergoes a de-mosaic process 716, which is described in greater detail below and which involves constructing a complete set of color data from the incomplete color samples obtained previously. Thereafter, the data may then pass to a CCM (color correction matrix) process 718, described in greater detail below, which corrects deficiencies in the color data. Thereafter, the data may be adjusted for white balance in a white balance process 722, also described in greater detail below, and thereafter, can undergo a frame deserialization process 724 to restore the frame structure of the data.

Data from CCM process 718 can then be passed to a histogram process 720, which enables autoexposure and/or autogain adjustments (see below). Histogram data may be sent to an MCU 710, which performs any necessary adjustments to histogram process 720. MCU 710 also sends feedback to left RGB camera 702 and right RGB camera 704, to adjust their function according to the histogram data.

As shown in FIG. 7, I2C 712 can be configured to control the register of the camera. An I2C is a multi-master, multi-slave, packet switched, single-ended, serial computer bus which is well known in the art.

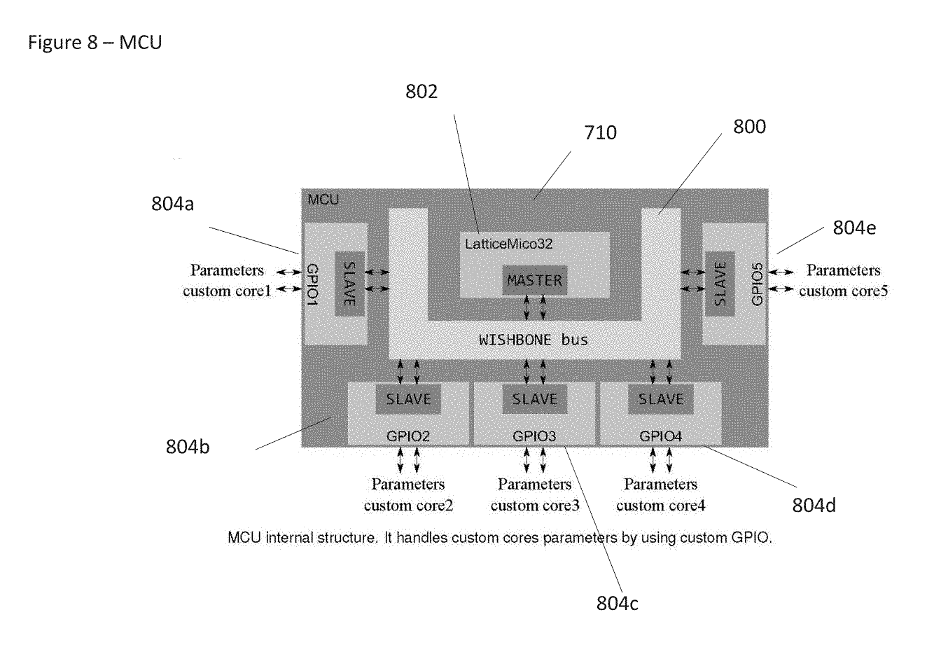

FIG. 8 shows a non-limiting example of a MCU (microcontroller, i.e., a processor) configuration according to at least some embodiments of the present disclosure. Optionally, a similar configuration could be used for a CPU structure (additionally or alternatively). As shown, MCU 710, which may for example be implemented with the process of FIG. 7, features a bus 800, which is connected to a master 802 and a plurality of slave units 804, shown as slave units 804a to 804e, which handle custom parameters to communicate with custom cores. The custom cores can, for example, be used for RGB preprocessing, to configure and control the various components and functions of the RGB preprocessing (as previously described). MCU 710 can also be configured to control each kernel as previously described with regard to FIG. 5.

Master 802 may be implemented by using, for example, the Lattice Semiconductors™ product, in which case the GPIO (General Purpose Input Output) core is implemented for slave units 804. Bus 800 may be implemented according to the Wishbone protocol, which is an open source interconnect architecture maintained by OpenCores organization (https://opencores.org/opencores,wishbone).

Configurable parameters can be sent to custom cores by means of the hardware implemented processor, e.g., LatticeMico32™ as master 802, which is based on a 32-bit Harvard RISC architecture and the open bus WISHBONE. For communication within MCU 710, such communication always occurs between a MASTER interface and a SLAVE interface. In some embodiments, only MASTER unit 802 can begin communications. Master unit 802 performs a handshake with slave 804 through bus 800, after which communication can occur.

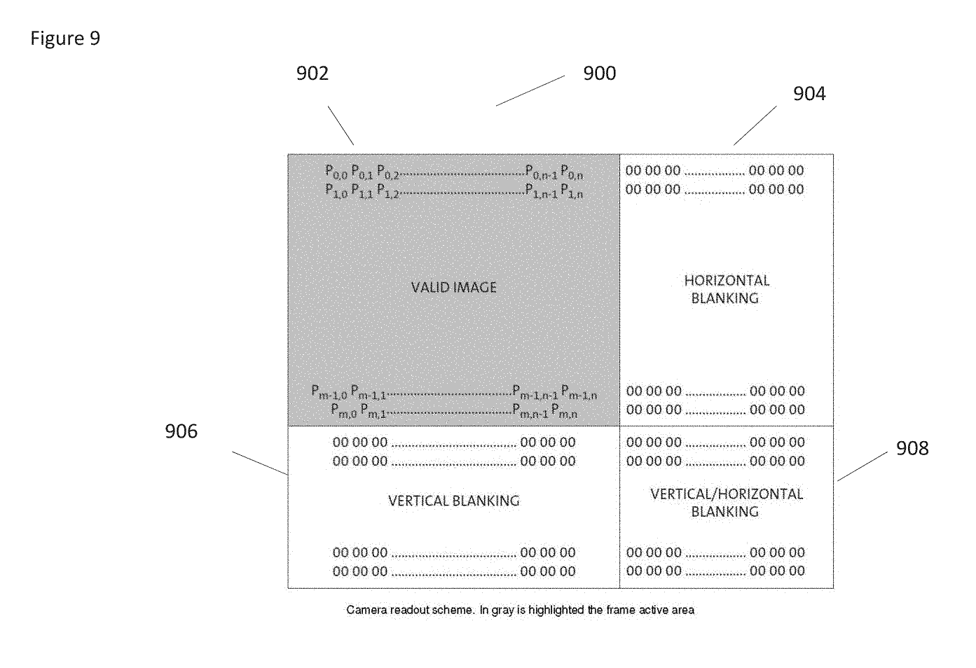

FIG. 9 shows illustrative aspects of an example of a camera according to at least some embodiments of the present disclosure, including a camera readout schematic 900, a frame active area 902, horizontal blanking 904, vertical blanking 906 and horizontal/vertical blanking 908.

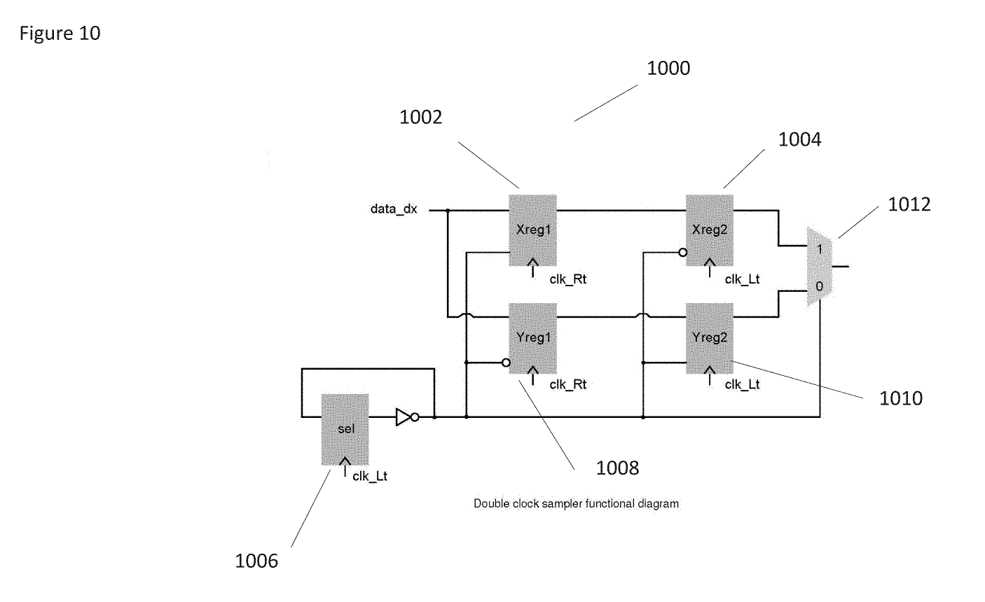

FIG. 10 shows a non-limiting example of a configuration for double clock sampler functions according to at least some embodiments of the present disclosure. Such functions are desirable because of the need to synchronize different clocks, for example between the right and left cameras as described herein. In order to perform clock synchronization, a double clock module 1000 is provided in which a first layer of registers (Xreg1 (1002) and Yreg1 (1008)) sample data from the right camera (not shown) using its own clock signal (clk_Rt), while second layer of registers (Xreg2 (1004) and Yreg2 (1010)) sample data from the left camera (not shown) using left clock instead (clk_Lt). The left clock can be used as the overall module clock for double clock module 1000. Signal sel (1006) alternatively activates a pair of registers Xreg1-Yreg2 or Yreg1-Xreg2. In this way, data has time to reach stable state in first layer before to be sampled by second one. Finally, data can be synchronized to the first left camera clock when outputted from multiplexer, which selector is connected to the sel signal from signal sel 1006.

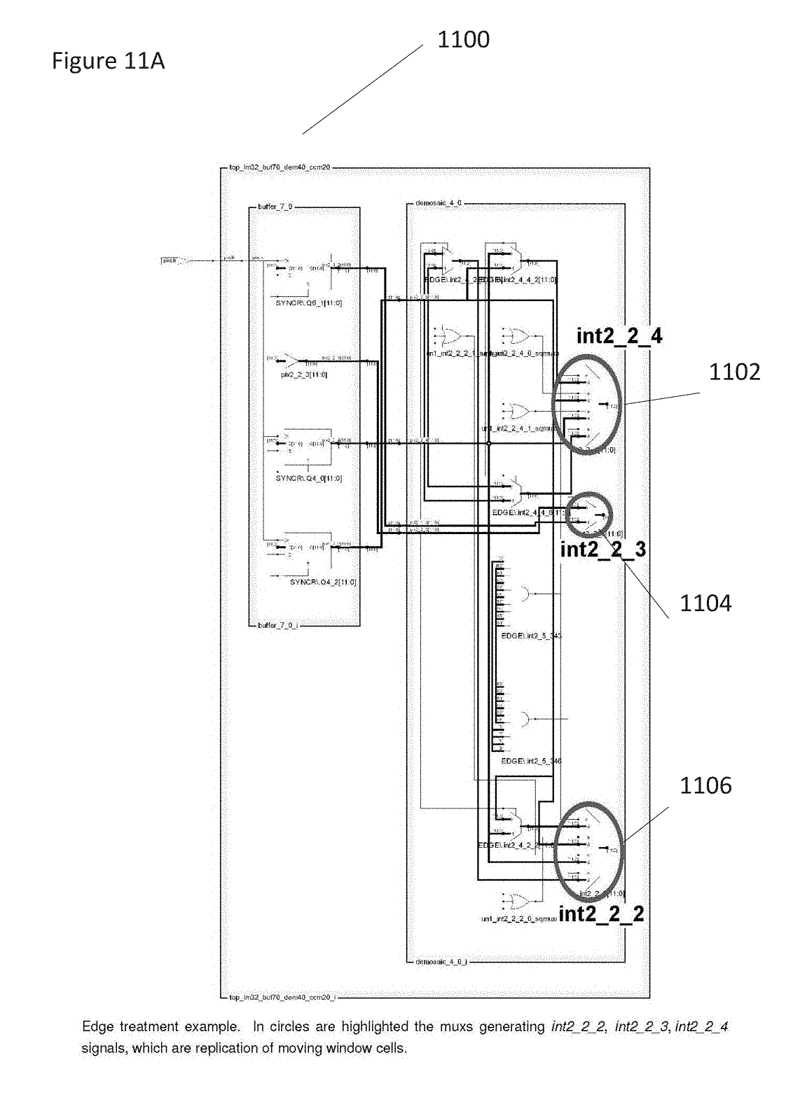

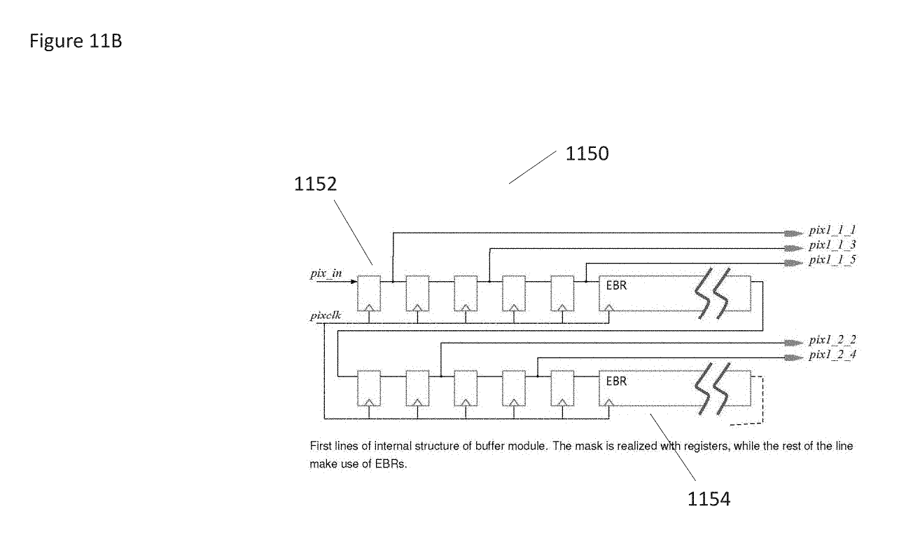

FIGS. 11A and 11B show non-limiting buffer configurations according to at least some embodiments of the present disclosure, which for example may be used to fulfill the buffer requirements of the FPGA and/or optionally of various modules as described herein. FIG. 11A shows an exemplary buffer configuration 1100, featuring multiplexers (muxs), highlighted in circles, generating int2_2_2 (1102), int2_2_3 (1104), and int2_2_4 (1106) signals, which are replications of moving window cells. When a moving window has its center placed on the edge of a frame, outside corner information may be missing from the frame. For this reason, the replication of the last 2 rings can be chosen as the strategy to avoid data loss. Replication includes providing the same information to more than one cell of a moving window a plurality of times, which can be accomplished by using muxs, as shown in FIG. 11A. Such a buffering system is used for example for the de-mosaic and detect modules.

FIG. 11B shows a portion of the internal structure of the buffer module 1150—the first lines of the internal structure of buffer module. The mask is realized with registers 1152, while the rest of the line makes use of EBRs (Embedded Block RAM) 1154.

The moving windows can comprise data registers 1152, which allows moving mask to have all cells accessible at same time. The remaining part of each line may be realized with EBRs 1154, which behave as FIFO registers. Each EBR 1154 preferably comprise 18 Kbit RAM. According to available memory configuration, this buffer is capable of handling a frame having maximum width of 2053 pixels (2 EBRs 1154 per line are adopted in configuration 1024×18). In order to maintain original synchronization, FV and LV signals entering in the buffer have to be properly delayed at output. In some embodiments, the first entering pixel through pix_in input comes out from pix_TEST after about 2 frame lines (see FIG. 12). FV and LV time shift is achieved by using EBRs 1154 and a control state machine. The control state machine could be implemented for example as shown in FIG. 11A; and may be configured to control a counter connected to read/write address input of EBRs 1154.

FIGS. 12A-C show non-limiting examples of an internal buffer cells arrangement. FIG. 12A shows a global structure 1200 in which the previously described EBRs are implemented as embedded block RAM 1202. A general mask 1204 is shown as implemented in LUT4 based cells including mask cells (gray) and cells that are not externally accessible (blue). The specific details of the mask cells vary according to the functions of the mask. For example, FIG. 12B shows a non-limiting mask 1220 for defective pixel detection, which is performed as previously described. FIG. 12C shows a non-limiting mask 1222 for the de-mosaic task, which is performed as previously described and also as described below.

FIG. 12D shows exemplary state machines of the output synchronization signals, according to some embodiments. Diagrams of state machines 1250 and 1252 show the waveforms of sync signals and logic state of the controller. State machine 1250 relates to states of state-machine handling sync signals delay, while state machine 1252 relates to FV and LV signals at the output of time shift EBR. Each state machine starts in W_H_FV, waiting for FV being asserted. Once this occurs, the state changes to W_H_FVLV, to wait for both FV and LV being asserted. When FV and LV are in high state, a counter is started keeping track of how many clocks are needed to delay signals of 2 frame lines. This can be achieved by alternatively jumping between W_DelFVCount2 and W_DelFVCount2bis (which increments the counter). The counter stops when two entire rows (horizontal blanking included) are output. The number of clocks can be stored in register MAXADDSYNC. In order to take into account possible resolution changes when a new frame starts, the state machine always resets the counter to update MAXADDSYNC.

FIGS. 13A-13H show non-limiting examples related to a method for performing the de-mosaic task according to at least some embodiments of the present disclosure, involving constructing a complete set of color data from the incomplete color samples obtained previously. This module uses moving windows to perform its task and is equipped with a buffer module to coordinate signals used to identify the formula to apply on the pixel under test. In particular, the cases incurred are:
R pixels: G and B values will be calculated;
G pixels at rows containing R pixels: R and B values will be calculated;
G pixels at rows containing B pixels: R and B values will be calculated;
B pixels: G and R values will be calculated.

The operation of the de-mosaic module (described below), but briefly a set of formulas are given below. FIGS. 13A and B show masks on which the algorithm is performed, including in FIG. 13A G values at R(B) place or B(R) values at R(B) place; and in FIG. 13B, R(B) at G places. B(R) values in R(B) sites, FIG. 13A:

$${B}_{d} / {R}_{d} = {G}_{d} + \frac{1}{4} ( 2 \_ 2 + 2 \_ 4 + 4 \_ 2 + 4 \_ 4 ) - \frac{1}{4} ( 2 \_ 3 + 4 \_ 3 ) - \frac{1}{4} ( 3 \_ 2 + 3 \_ 4 )$$

G values in R(B) sites, FIG. 13A:

$${G}_{d} = \frac{1}{2} TEST + \frac{1}{4} ( 2 \_ 3 + 4 \_ 3 ) + \frac{1}{4} ( 3 \_ 2 + 3 \_ 4 ) - \frac{1}{8} ( 1 \_ 3 + 5 \_ 3 ) - \frac{1}{8} ( 3 \_ 1 + 3 \_ 5 )$$

R(B) in RG(BG) rows at G sites, FIG. 13B:

$${R}_{d\_rg} / {B}_{d\_bg} = \frac{1}{2} TEST + \frac{1}{2} ( 3 \_ 2 + 3 \_ 4 ) - \frac{1}{8} ( 2 \_ 2 + 2 \_ 4 + 4 \_ 2 + 4 \_ 4 ) + - \frac{1}{8} ( 3 \_ 1 + 3 \_ 5 ) + \frac{1}{4} TEST$$

FIG. 13C shows the de-mosaic algorithm in an exemplary implementation, in more detail, to determine the missing green values. This implementation simplifies multiplications and division by reducing them to only shift operations. A de-mosaic process 1300 starts with classifying a pixel 1302. For the value of G (green) at R (red) and B (blue) sites (classification a), matrix A is used in 1304. All matrices are shown in FIG. 13D. The convolution matrices shown as matrices B1 and B2 are used for classification b, for R(B) at B-G(R-G) sites (matrix B1) and for R(B) at R-G(B-G) sites (matrix B2), to take the average of the green pixels surrounding the red and blue sites in 1306 and to apply the convolution matrices B1 and B2 in 1308. The method as performed on the pixels is shown in FIG. 13E.

The remaining classification is classification c, in which the number of green pixel values is reduced to fit in a 5×5 window in 1310, and matrix C is applied as the convolution matrix in 1312. This classification is applied for R(B) at B(R) sites, which are the remaining cases. The method as performed on the pixels is shown in FIG. 13F.

FIG. 13G shows the checking phase of summation obtained at a numerator of formulas used in a de-mosaicing process, for handling truncation, according to some embodiments. When maximum pixel width is adopted (12 bits) pixel, values for the summation can range from 0 up to 4095. In order to avoid premature truncation during partial calculations steps, each term can be carefully sized as to contain signed summations. Nevertheless, under certain conditions, overflow or underflow may occur in the final result, hence a truncation mechanism can be required.

Process 1354 features a truncation mechanism, in the last calculation phase: a vector 1356 containing the summation resulting from operation performed on numerator of one of the above equations for de-mosaicing, which is right shifted. The control may be performed on the most left bits 1358 just before final color value begins. First, it is determined whether the bits are all equal to zero, so as to ensure that the result is on the correct range. 2's complement convention is used for negative number representation and, therefore, if first bit is 1 the final value will be set to 0 (as a negative color value does not make sense). On the other hand, if the first bit is null, but the other bits preceding the final result interval are not all zero, then the result will be an overflow. In this case, the result of check bits 1358 will be truncated to 4095 (if 12 bits format is used). The final color value is shown in 1360, while suppressed bits are shown in 1362.

FIG. 13H shows a non-limiting example of a DSP configuration for RGB processing as described above according to at least some embodiments of the present disclosure. Accordingly, a configuration 1370 features DSP modules red-blue_sum 1372 and 4_sum 1374 which are optimized adders accepting 8 and 4 terms respectively. A trivial shift by 8 (1378a) allows to obtain the average at R and B pixel sites. On the other hand, an average of G sites is obtained through green_mult-sum 1376 which sums the results of the two adders and multiplies their result by aav; a shift (1378b) finalizes the calculation. Depending on the color of the investigated pixel, sel signal 1380 assumes a high or low logic state to select the right average to compare it with. The average in G sites requires more process stage cycles than for R/B ones. Hence, in order to obtain both results at same time, the latter average is delayed using register sequence, controlled by sel signal 1380.

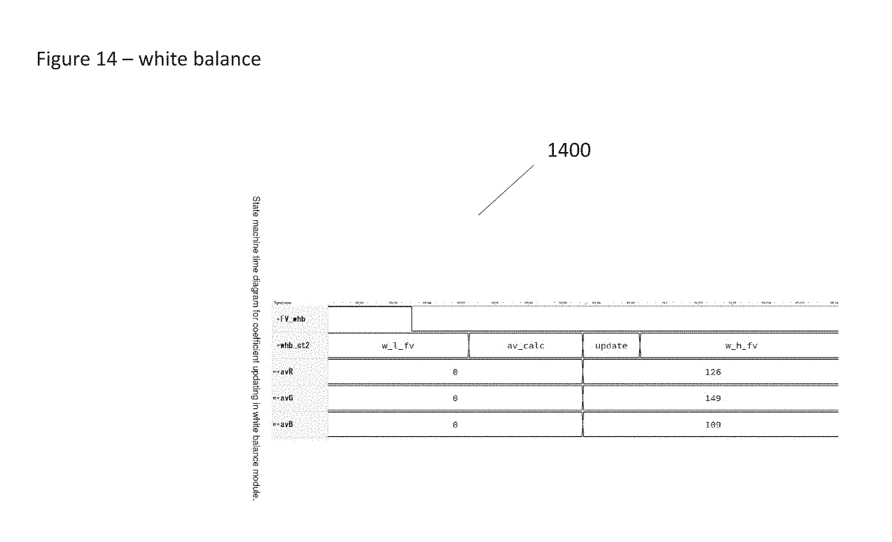

FIG. 14 shows a non-limiting example of a method for white balance correction according to at least some embodiments of the present disclosure, showing a state machine time diagram for coefficient updating in the white balance module. To this end, a white balance algorithm, e.g., the GW (gray world) algorithm, assumes that in a normal well-color-balanced photo, the average of all the colors is a neutral gray. Therefore, the illuminant color cast can be estimated by looking at the average color and comparing it to gray (see https://web.stanford.edu/˜sujason/ColorBalancing/grayworld.html for a detailed explanation and exemplary implementation). However, while the computational simplicity associated therewith is attractive, the present inventors found that the GW algorithm did not provide sufficiently robust results, in particular, proving to be unstable under certain circumstances. Instead, a smoothed GW algorithm was chosen to implement the white balance module.

The smoothed GW algorithm was implemented according to the following equations:

$$\{ \begin{matrix}{corr}_{R , i} = {corr}_{R , i - 1} \\ {corr}_{B , i} = {corr}_{B , i - 1}\end{matrix} if \vert {d}_{RG} \vert = \vert {d}_{BG} \vert = 0 \\ \{ \begin{matrix}{corr}_{R , i} = {corr}_{R , i - 1} \\ {corr}_{B , i} = {corr}_{B , i - 1} + μ \times sign ( - {d}_{BG} )\end{matrix} if \vert {d}_{RG} \vert \geq \vert {d}_{RG} \vert \\ \{ \begin{matrix}{corr}_{R , i} = {corr}_{R , i - 1} + μ \times sign ( - {d}_{RG} ) \\ {corr}_{B , i} = {corr}_{B , i - 1}\end{matrix} if \vert {d}_{BG} \vert < \vert {d}_{RG} \vert \\ Where {d}_{RG} = \overline{R} - \overline{G} and {d}_{BG} = \overline{B} - \overline{G} .$$

Per channel frame average can be obtained by using a DSP adder in self-accumulation configuration (as shown), which can be activated only when both synchronization signals (FV_whb and LV_whb) are in high logic state, so that only valid pixel values are added. Obtained summation can then be divided by total number of pixels composing a frame. Co-efficients nav and aav are chosen by running a function in Scilab called nAvMinErr( ), or a similar computation, which need the number of bits to represent a pixel and the resolution of used camera. Averages are calculated on corrected channels, in order to have a feedback on the effect of last values assumed by coefficients. Each coefficient is initialized to 1 in order to directly estimate real image situation. A state machine can be implemented as to adjust multiplying coefficients during vertical blanking time intervals (FV_whb at logic ‘0’), its associated time diagram being depicted in FIG. 14.

The adjustment of coefficients, according to which the R and B channels are multiplied, requires few clock cycles, and it is performed at the end of a frame, right after FV_whb goes to logic ‘0’. Here two states follow one another: AV_CALC causes finalization of the calculation of averages, UPDATE allows the update of both coefficients. Comparison of averages B and R toward G can be done in parallel. During remaining time, state machine stays in W_L_FV or W_H_FV states in order to catch the end and the beginning of a frame.

Multiplication of R and B channels can be performed converting to fixed point convention (multiplication by 2nres, with nres number of fractional digits) followed by integer part selection, by taking off fractional digits (right shift). The minimum possible step increment may be 0.001, preferably up to and including 0.01). The closest resolution obtainable is 0.000977 using nres=10. To ensure a good range, the integer part is fixed to two bits (3 is the maximum integer part can be represented). Moreover, as the adjustment can be both an increment or a decrease, an additional bit for 2's complement representation is needed. Hence ampl_step input is 10 bits wide.

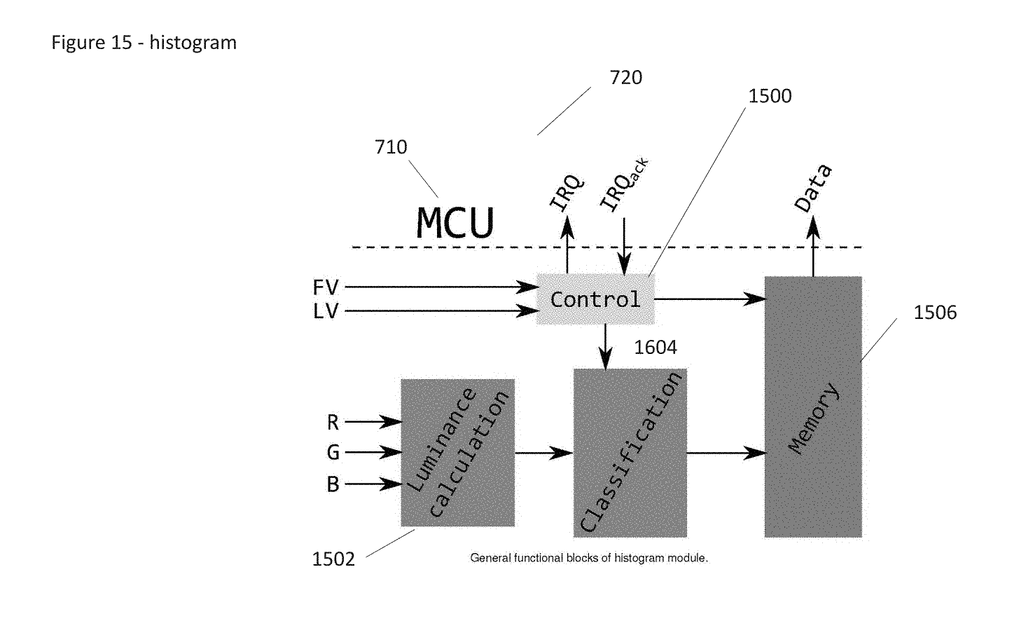

FIG. 15 shows a non-limiting example of a method for performing the histogram adjustment according to at least some embodiments of the present disclosure. The functions are shown as being performed on MCU 710, while the histogram functionality may, for example, be provided for histogram 720. As shown, the process can be controlled by a control 1500. Luminance can be calculated by a luminance calculation module 1502 as previously described.

A classification module 1504 classifies each pixel according to a different range of luminances, as the histogram is configured to show a set of ranges of such luminances. The histogram application therefore involves the classification of each pixel according to its relevant luminance range. The classified pixel may then be stored in a memory 1506, from which the data may be retrieved for use in other procedures. To permit both the FPGA (not shown) and MCU 710 to access the luminance data, a pseudo dual port RAM may be used to updates the luminance data (not shown).

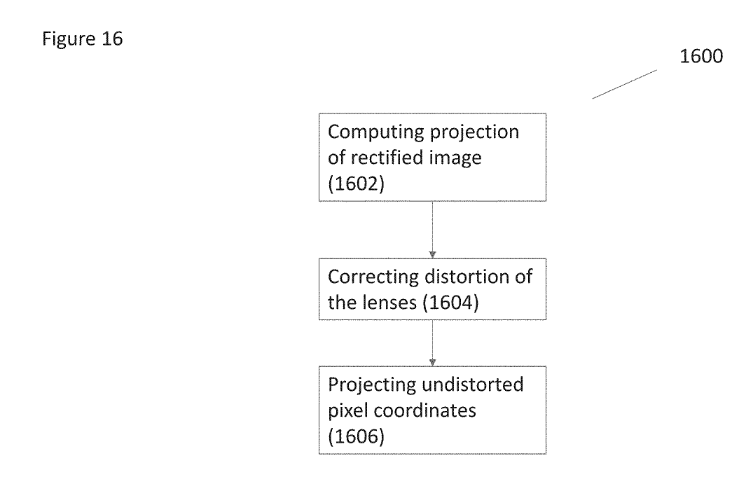

FIG. 16 shows an illustrative, exemplary, non-limiting process for stereo rectification according to at least some embodiments of the present disclosure. The method is optionally implemented as an inverse mapping algorithm that computes for each pixel coordinates in the rectified image the corresponding pixels coordinates in the raw, unrectified and distorted image. Let r and c be the pixel coordinates in the rectified image.

As shown, a method 1600 begins in stage 1602 with computing the projection of the rectified image on the aligned camera reference frame through the new camera matrix computed with the intrinsic parameters (focal length and principal point) and the extrinsic parameters (rotation matrix and translation vector).

Let Pose be a matrix resulting from the computation of a matrix composed of the intrinsic camera parameters and of a matrix composed from the rotation and the translation matrixes between the 2 cameras. Thus, the projection is:

$$( \begin{matrix}ray 1 \\ ray 2 \\ ray 3\end{matrix} ) = Pose \cdot ( \begin{matrix}c \\ r \\ 1\end{matrix} )$$

From this point, the pixel coordinates of the projection of the r and c pixel coordinates on the new coordinates system become:

$${r}_{new} = \frac{ray 2}{ray 3}$$

$${c}_{new} = \frac{ray 1}{ray 3}$$

Stage 1604 includes correcting the distortion of the lenses of the cameras with their distortion parameters.

With q2=rnew2+cnew2, the radial distortion is taken in account in this way:

$$( \begin{matrix}{r}_{r} \\ {c}_{r}\end{matrix} ) = \frac{( 1 + {k}_{1} \cdot {q}^{2} + {k}_{2} \cdot {q}^{4} + {k}_{3} \cdot {q}^{6} )}{( 1 + {k}_{4} \cdot {q}^{2} + {k}_{5} \cdot {q}^{4} + {k}_{6} \cdot {q}^{6} )} \cdot ( \begin{matrix}{r}_{new} \\ {c}_{new}\end{matrix} )$$

The tangential distortion is taken in account in this way:

$$( \begin{matrix}{r}_{t} \\ {c}_{t}\end{matrix} ) = ( \begin{matrix}{p}_{2} \cdot ( {q}^{2} + 2 \cdot {r}_{new}^{2} ) + 2 \cdot {p}_{1} \cdot {c}_{new} \cdot {r}_{new} \\ 2 \cdot {p}_{2} \cdot {c}_{new} \cdot {r}_{new} + {p}_{1} \cdot ( {q}^{2} + 2 \cdot {c}_{new}^{2} )\end{matrix} )$$

Finally, the undistorted pixel coordinates are the sum of the radial and the tangential distortion computations:

$$( \begin{matrix}{r}_{undist} \\ {c}_{undist}\end{matrix} ) = ( \begin{matrix}{r}_{r} + {r}_{t} \\ {c}_{r} + {c}_{t}\end{matrix} )$$

Stage 1606 includes projecting the undistorted pixel coordinates on the real camera reference frame using the KK camera matrix. This matrix is defined as follows:

$$KK = ( \begin{matrix}{f}_{x} & 0 & {c}_{x} \\ 0 & {f}_{y} & {c}_{y} \\ 0 & 0 & 1\end{matrix} )$$

Thus, the final pixel coordinates are:

$$( \begin{matrix}{r}_{p} \\ {c}_{p}\end{matrix} ) = KK \cdot ( \begin{matrix}{r}_{undist} \\ {c}_{undist}\end{matrix} )$$

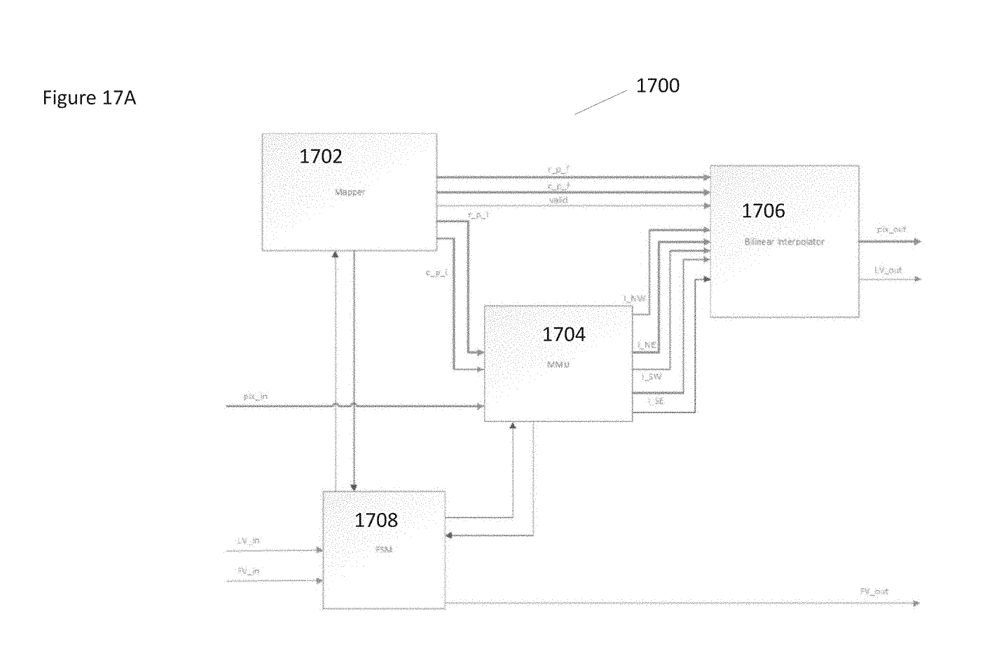

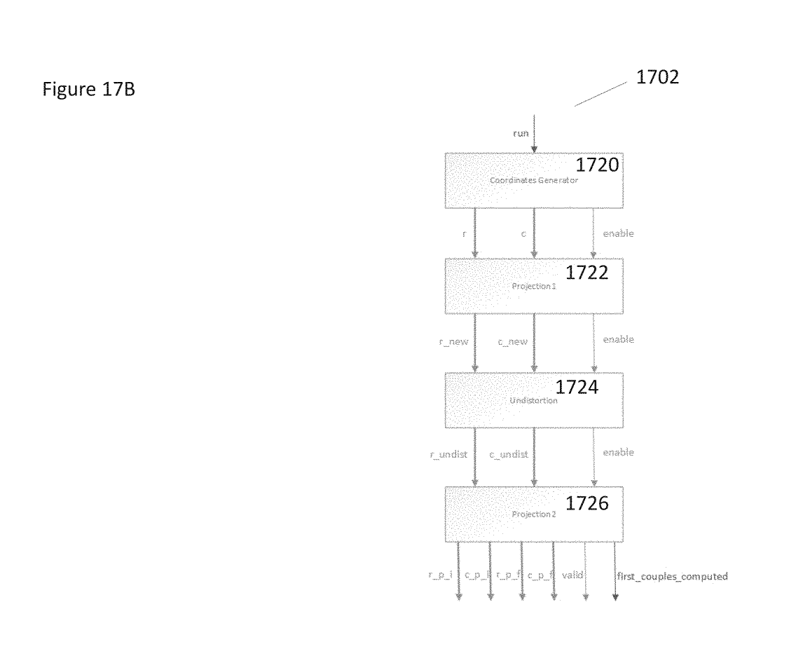

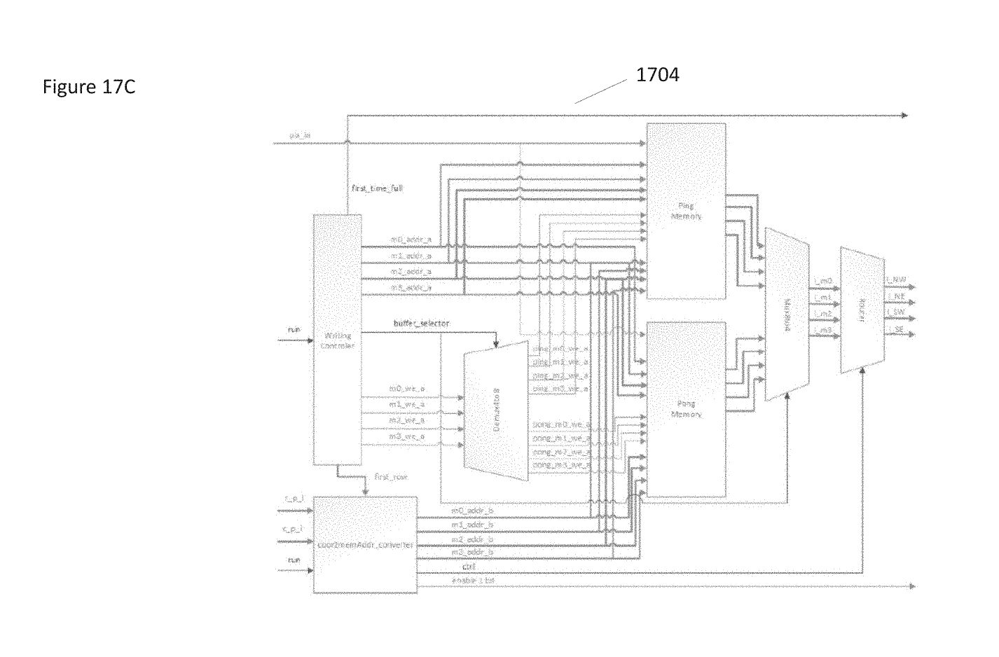

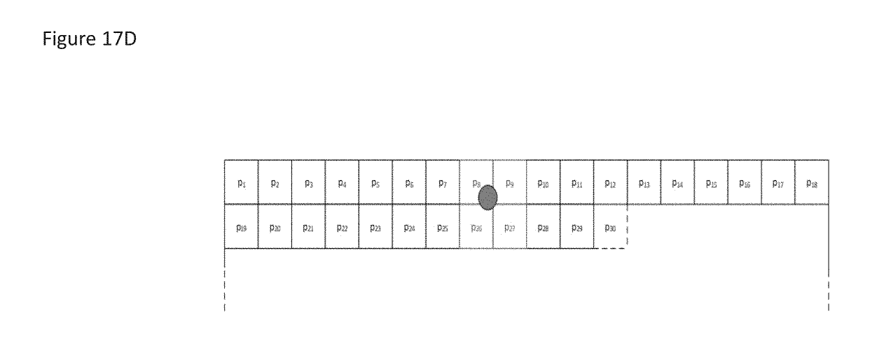

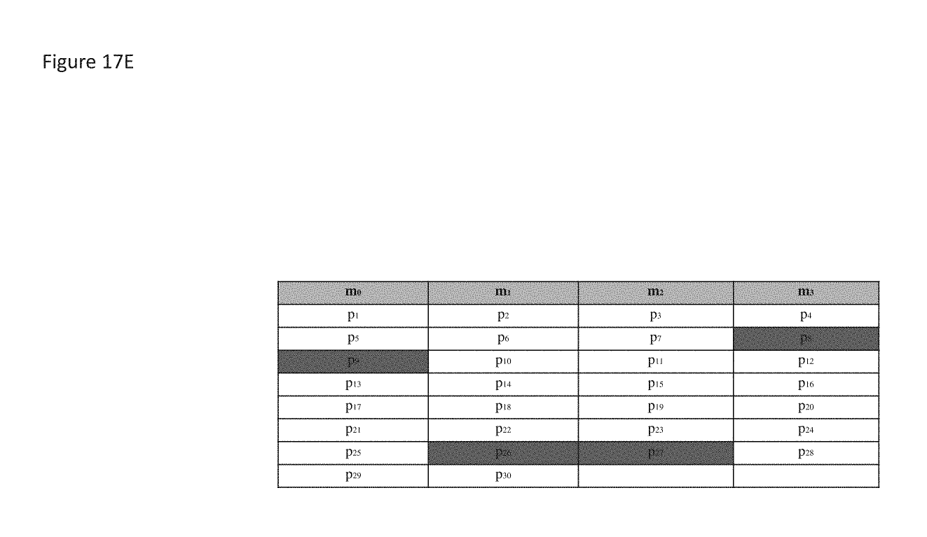

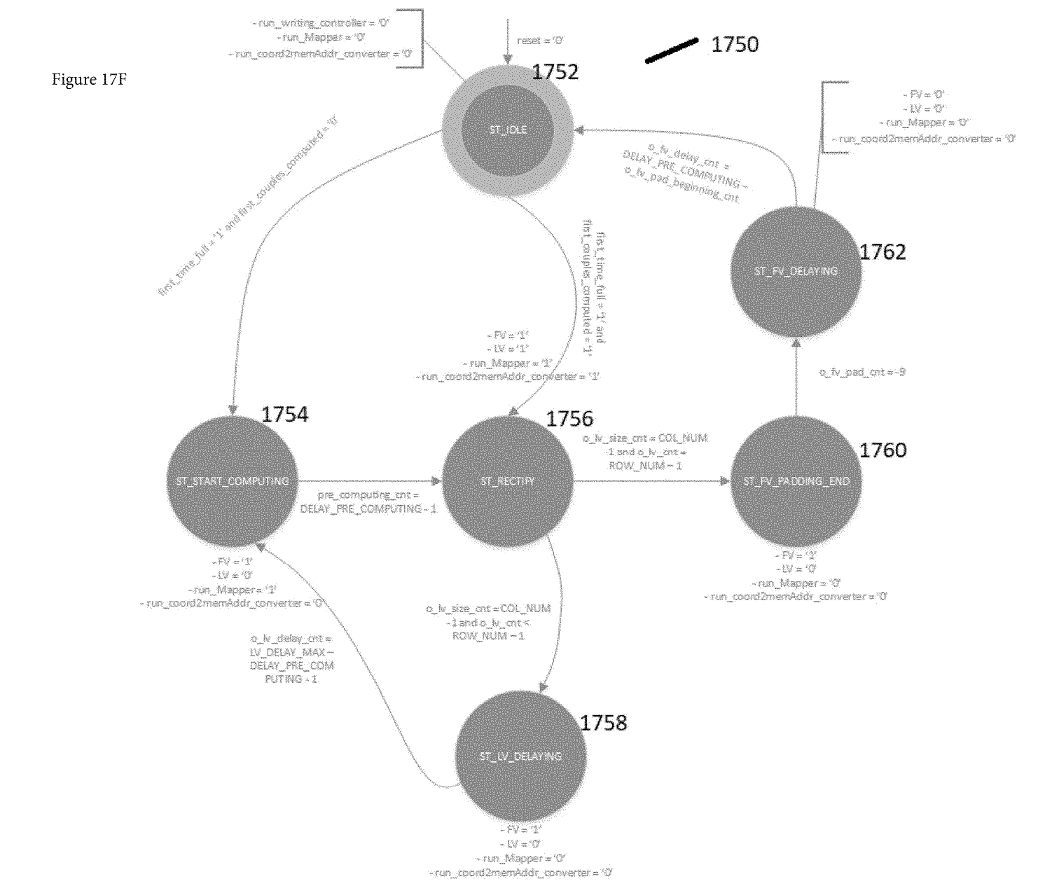

FIG. 17A shows an illustrative, exemplary, non-limiting system for stereo rectification according to at least some embodiments of the present disclosure. A system 1700 features a mapper 1702, a memory management unit 1704, a bilinear interpolator 1706 and a finite-state machine 1708.

Mapper 1702 is in charge of executing the rectification algorithm and generating the rectified pixel coordinates. The operation of mapper 1702 is described in more detail in FIG. 17B.

The purpose of the Memory Management Unit 1704, in some embodiments, is to first store the incoming raw pixels, and second, to output the pixels corresponding to the rectified pixels coordinates given by the Mapper 1702. The operation of Memory Management Unit 1704 is described in more detail in FIG. 17C.

The Bilinear Interpolator 1706 may be used to compute the bilinear interpolation of four pixels. The rectified pixel coordinates aim at four pixels as they are non-integer. A strategy to retrieve a value for the rectified pixel could be to choose one pixel among these four but to be as accurate as possible, a better strategy is to compute the bilinear interpolation of these four pixel values according the relative position of the rectified pixel among these four pixels. The following equation describes this operation:

$$I\_pix \_out = ( 1 - c\_p \_f ) \cdot ( \begin{matrix}{I}_{NW} & {I}_{NE} \\ {I}_{SW} & {I}_{SE}\end{matrix} ) \cdot ( \begin{matrix}1 - r\_p \_f \\ c\_p \_f\end{matrix} )$$

Hence, this block takes as inputs the four pixel values pointing by the rectified coordinates as well as the fractional parts of these rectified coordinates and outputs the pixel value out the rectified pixel as their bilinear interpolation.

A finite-state machine 1708 may be used to control the block(s) according to, for example, an imposed 1280*720p@60 fps protocol (the Line Valid and Frame Valid signals define this protocol). FIG. 17F shows a non-limiting, exemplary finite state machine for use with the system of FIG. 17A according to at least some embodiments of the present invention.

At the beginning of a sequence, the state machine (shown as reference number 1750 in FIG. 17F) goes into the ST_IDLE state 1752 and waits for the first buffer to be filled with raw incoming pixels by the Writing Controller. Once this is done, the rectification can start. The state machine 1750 enters the ST_START_COMPUTING state 1754 and in this state the Mapper is enabled. When the Mapper has computed the first rectified pixels coordinates, the state machine 1750 enters the ST_RECTIFY state 1756 and the reading process starts with the Coord2memAddr_converter being enabled. There are 3 other states, ST_LV_DELAYING 1758, ST_FV_PADDING_END 1760 and ST_FV_DELAYING 1762 that are provided to ensure that the output frame follows the same protocol as the input frame.

FIG. 17B shows an illustrative, exemplary, non-limiting mapper module for use with the system of FIG. 17A according to at least some embodiments of the present disclosure, and FIG. 17F shows a non-limiting, exemplary finite state machine for use with the system of FIG. 17A according to at least some embodiments of the present disclosure.

With respect to FIG. 17B, mapper 1702 may feature four blocks: a coordinates generator 1720, a projection 1 (shown as 1722), an undistortion module 1724 and a projection 2 (shown as 1726). The first block, the Coordinates Generator 1720, corresponds to the generation of all possible pixels coordinates in row order from (1,1) (top-left of the image) to (720,1280) (bottom-right of the image) at the pixel clock rate (i.e., it can be considered a counter). Then, these coordinates will be the inputs of the 3 remaining blocks that correspond to the 3 steps of the rectification algorithm of FIG. 16. This block therefore may be used to output rectified pixels coordinates, and according to all the calculus the rectification algorithm requires, the rectified pixels coordinates are non-integer. Hence, and in order to facilitate both the work of the Bilinear Interpolator and the work of the Coord2memAddr_converter, the Mapper separates the integer (r_p_i and c_p_i) and the fractional (r_p_f and c_p_f) parts of the rectified pixels coordinates.

FIG. 17C shows an illustrative, exemplary, non-limiting memory management for use with the system of FIG. 17A according to at least some embodiments of the present disclosure. As shown, memory management unit 1704 can perform two processes (and at least one), including storing the incoming pixels of the image at the pixel clock rate and being able to make these stored pixels available at any time for the bilinear interpolator. Hence, these 2 processes can be seen as a writing process and a reading process.

In order to avoid data corruption, the buffering process can use a “ping-pong” scheme so that while data is being written in one buffer, and data can be read into the other buffer. A change of buffer can occur every time the writing process reaches the end of a buffer. With this scheme, the architecture starts filling one buffer as soon as it receives the first pixels of an image (indicated by the FV and LV signals) and waits for this buffer to be full before starting to rectify the first pixel's coordinates and allow the reading process to read in this buffer. A small delay may be therefore added at the launching of the architecture, but then the latter may be able to output pixels at the requested frame rate.

As the rectified pixel's coordinates are non-integer, and as four pixels from the unrectified image are needed at the same time to interpolate the intensity of one rectified pixel, four dual-port memories can be used in each buffer so that four pixels at the same clock cycle may be output when requested. To insure that the 4 adjacent pixels targeted by the non-integer pixel coordinates are situated in different dual-port memories, pixels may be simply cyclically stored in the 4 memories following the row order.

An illustrative example of how this operates is shown in FIGS. 17D and 17E. FIG. 17D shows a non-limiting example of an image. FIG. 17E shows the memory filling scheme for this image.

If the pixel coordinates couple requested by the Mapper is the green point on the image (shown in FIGS. 17D and 17E as a non-limiting example), then the four pixels that need to be interpolated are the pixels p8, p9, p26 and p27. This can be done at the same clock cycle since they are all in different memory: p8 is in m3, p9 is in m0, p26 is in m1 and p27 is in m2. This process of filling the memories, in some embodiments, works upon the width of the image being a multiple of 6 and not multiple of 4. Since 1280 is multiple of 4, a padding process may be used to “fake” an image width of 1290. This way, the adjacent pixels may always be located in different memories and the process remains simple for the reading process.

The writing process may be managed by the Writing Controller which can generate the writing addresses of the four memories and cyclically activates their write enable signals while skipping the addresses that need to be to fit with the padding process. A demultiplexer may then be used to redirect the write enable signals to the right buffer (the one that is currently in the writing process).

The reading process is managed by the Coord2memAddr_converter, which may be used to turn pixel coordinates couples coming from the Mapper into reading memory addresses for the Bilinear Interpolator (BI)—the four pixel's values required to compute the rectified pixel value. The BI is facilitated by cyclically storing the pixels because, from a pixel coordinates couple, the BI need merely compute the linear address, and then divide it by 4 (for example). This calculus is described below:

$${NW}_{addr} = ⌊ \frac{( r\_p \_i - 1 ) * ImageWidth + ( c\_p \_i - 1 )}{4} ⌋$$

$${NE}_{addr} = ⌊ \frac{( r\_p \_i - 1 ) * ImageWidth + ( c\_p \_i - 1 ) + 1}{4} ⌋$$

$${SW}_{addr} = ⌊ \frac{( r\_p \_i - 1 ) * ImageWidth + ( c\_p \_i - 1 ) + ImageWidth}{4} ⌋$$

$${SE}_{addr} = ⌊ \frac{( r\_p \_i - 1 ) * ImageWidth + ( c\_p \_i - 1 ) + ImageWidth + 1}{4} ⌋$$

Based upon FIGS. 17D and 17E, the calculation would be performed as follows:

$${NW}_{addr} = ⌊ \frac{0 * 18 + 7}{4} ⌋ = 1$$

$${NE}_{addr} = ⌊ \frac{0 * 18 + 7 + 1}{4} ⌋ = 2$$

$${SW}_{addr} = ⌊ \frac{1 * 18 + 7}{4} ⌋ = 6$$

$${SE}_{addr} = ⌊ \frac{1 * 18 + 7 + 1}{4} ⌋ = 6$$

As shown, p8 that is in m3 is at the linear address 1, p9 in m0 is at linear address 2, and p26 and p27 both are at linear address 6 in m1 and m2 respectively. In this architecture, using the padding process, Image Width is replaced by the width of the padded image, 1290 in the present case, so that the memory addresses skipped by the Writing Controller during the writing process may the never be achieved.

Also, in order to know which memory corresponds to which linear address, a modulo 4 operation may be computed on the column number (c_p_i). This information may also benefit the Router block that matches the incoming pixels value from m0, m1, m2 and m3, with their position in the image (which may be important for the bilinear interpolation).

The linear addresses computed with the above equations may comprise absolute addresses (according to some embodiments). Indeed, in some embodiments, the processes work for buffer size being the same as an entire image. However, since the buffer size may comprise several lines, the Coord2memAddr_converter requires the identification of the line which is currently stored at the beginning of the buffer, so that the linear absolute addresses may be processed into relative addresses. Such information may be provided by the Writing Controller through a first_row signal. Thus, the process, in some embodiments, should take this into account by, for example, subtracting the numerator by this signal.

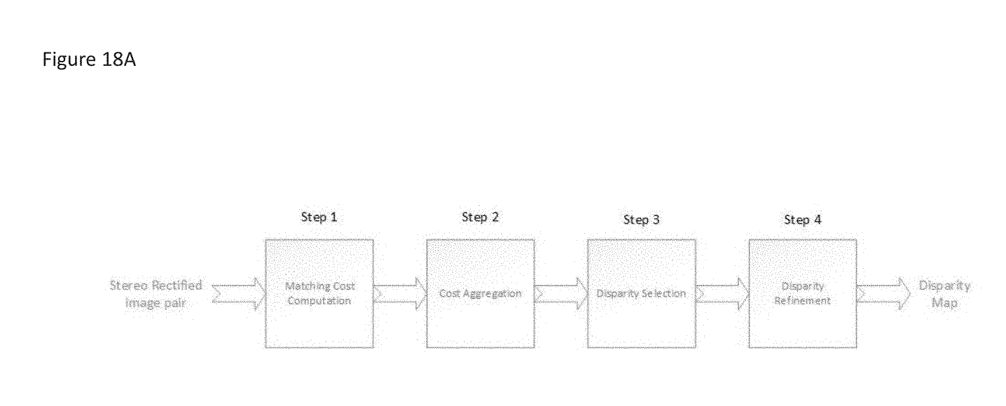

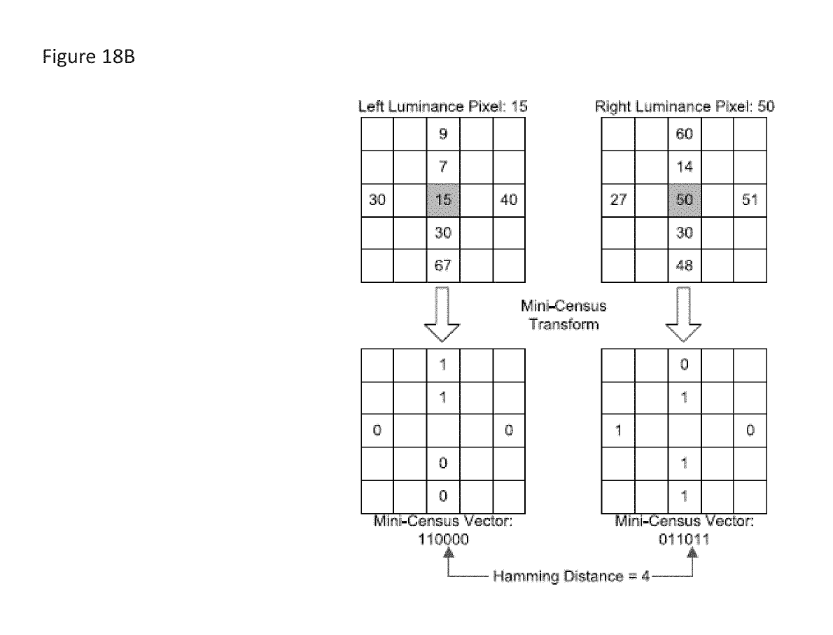

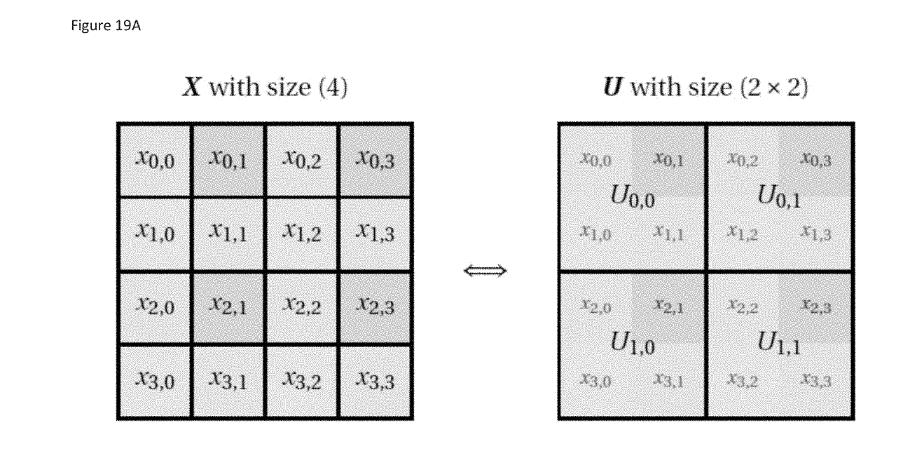

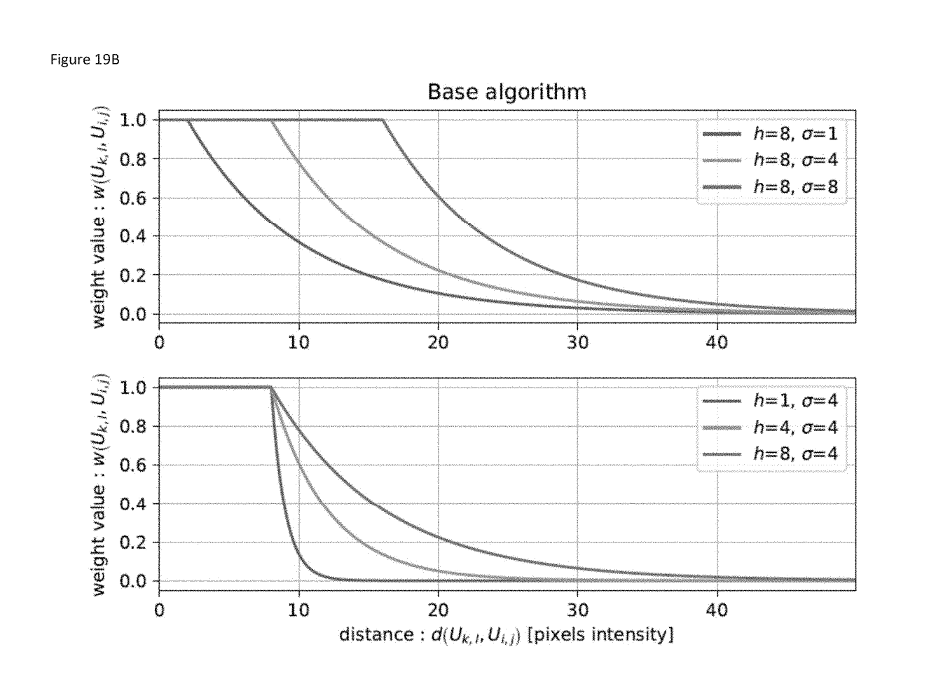

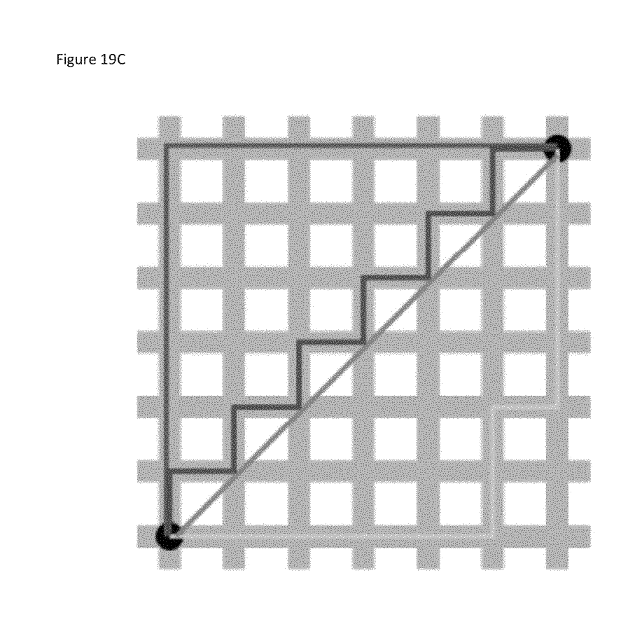

FIG. 18A shows an illustrative, exemplary, non-limiting disparity map method according to at least some embodiments of the present disclosure. Once the stereo images are rectified, matching becomes a one-dimensional issue and the disparity map can be computed. Accordingly, the following is a non-limiting exemplary process for producing a disparity map (the steps given below are referenced in the drawing as “step 1”, “step 2” etc).

Step 1: Matching Cost Computation. In this step, the similarity of pixels in left and right image are measured by producing a cost. Various non-limiting, exemplary algorithms are described below.

Absolute Differences (AD)

AD(x, y, d)=|L(x, y)−R(x−d, y)|

This algorithm can be used to compute the absolute difference of a pixel in the left image and a pixel in the right image on the same row, and with an offset in the column index (corresponding to the disparity). It has a low complexity due to its simplicity but does not produce smooth disparity map for highly textured images.

Squared Differences (SD)

SD(x, y, d)=(L(x, y)−R(x−d, y))2

This algorithm is very similar to the Absolute Differences by its definition and by its results in term of speed and accuracy. It also can be used to compute the difference of the intensity of a pixel in the left image and a pixel in the right image and then elevates it to the power of 2. AD and SD produce almost the same disparity maps.

Sum of Absolute Differences (SAD)

$$SAD ( x , y , d ) = {\sum }_{( i , j ) ∈ ω} \vert L ( i , j ) - R ( i - d , j ) \vert$$

This algorithm gathers data as in step 1 and step 2 of the taxonomy (above), in one step. Indeed, this algorithm is the same as the AD, it operates on a square window around the pixel of interest. Therefore, it has a bigger computational time than the AD, but it smooths the disparity map produced due to the window-based method which acts like a filter and it decreases the error rate of the disparity map produced by better finding some occluded disparities.

Sum of Squared Differences (SSD)

$$SSD ( x , y , d ) = {\sum }_{( i , j ) ∈ ω} {( L ( i , j ) - R ( i - d , j ) )}^{2}$$

The SSD is to the SD, as the SAD is to the AD. Again, the SAD and the SSD are very similar and produce almost the same disparity maps.

Normalized Cross Correlation (NCC)

$$NCC ( x , y , d ) = \frac{{\sum }_{( i , j ) ∈ ω} L ( i , j ) \cdot R ( i - d , j )}{\sqrt{{\sum }_{( i , j ) ∈ ω} {L ( i , j )}^{2} \cdot {R ( i - d , j )}^{2}}}$$

If an algorithm that computes the disparity based on the intensity of the pixels in the images is used with images that come from cameras that do not have the same gain and/or bias, the produced disparity map can be incorrect. Thus, to compensate for differences in gain and/or bias, the normalized cross correlation algorithm can be applied. It normalizes the intensity of the pixels from the left and the right images so that a difference in gain and/or bias does not come into account anymore. Accordingly, this algorithm may be required if the cameras do not have the same gain/bias, but it can blur regions of discontinuity and also requires considerable computational resources to obtain a high-accuracy disparity map.

CensusTransform (CT)

CT(x, y, d)=Hamming(Census_{L}(x, y), Census_{R}(x−d, y))

With:

Census(x, y)=bitstring_{U,flow}(l(i, j)≥l(x, y))

This algorithm is based on the Census transform and it computes a bitstring based on a square window centered on the pixel of interest and where each bit of this bitstring is the result of the comparison between the intensity of a pixel inside the window and the intensity of the pixel of interest. The Hamming distance between the Census transform computed in the left image and the Census transform computed in the right image is performed and considered, but may be at a cost. This algorithm is robust to disparity discontinuities and it can show very high matching quality at object borders. However, in some embodiments, it may produce incorrect matching in regions with repetitive structures.

Mini-Census Transform (miniCT)

This algorithm is similar to the Census transform, although it operates on a different window. In the mini-Census transform, the bitstring is not computed on a square window, but rather, on a cross-centered window on the pixel of interest. The resulting bitstring is 6 bits long (2 bits up and 2 bits down the pixel of interest and 1 pixel left with an offset of 1 and 1 pixel right with an offset of 1). This cross with an example of the application of the algorithm is shown in FIG. 18B, which shows an illustrative, exemplary, non-limiting method for calculating a cost for the disparity map method according to at least some embodiments of the present disclosure.

Step 2: Cost Aggregation

From step 1, a 3-D costs map is produced. Indeed, for each pixel in the image, a cost is computed for each disparity (shift between the 2 images). But these costs can be considered as raw (except for some algorithms) since they are computed with local information. In order to minimize the matching uncertainties, the step 2 aggregates the raw costs according to several possible schemes.

Furthermore, only local methods will be described here as global methods often skip this step. Local methods are window-based methods and the disparity of each pixel depends only on the intensity values of the surroundings pixels within the predefined window. Hence, as this method takes in account only local information, it has a low computational complexity and a short run time so that architectures implementing it can be real-time (sometimes using additional hardware). Finally, local methods use all 4 steps of the process.

Global methods are, in contrast, methods that generate a disparity map that optimizes a global energy function. This global energy function contains mainly 2 terms. One penalizes disparity variations and the other measures the pixel similarity. Global methods have a high computational complexity and a longer run time than local methods. By the way, software-based global methods are almost impossible to be implemented in a real-time architecture so additional hardware would be needed to address this constraint. Another difference with local methods is that global methods usually skip step 2 of the 4-step process.

Turning back to cost aggregation, these methods aggregate the matching cost by summing them over a support region which is usually a square window centered on the current pixel of interest. The simplest aggregation method is to apply a low-pass filter in the square support window. This window can be fixed-size (FW) but the error rate increases when the size of this window becomes too big and the parameters must fit the particular input dataset. Or this window can also be adaptive (AW), in terms of size, or in terms of weight: adaptive support weight (ASW), or there can be multiple windows (MW). The MW technique shows weaknesses at objects' boundaries but the AW technique reduces the errors caused by boundary problems. AW can achieve high quality results near depth discontinuities and in homogenous regions. The ASW technique first computes for each pixel an adaptive cross based on its intensity similarity to its consecutive neighbours in the four directions. Then the adaptive support weight window on which the raw costs will be summed over is created by merging the horizontal arms of the cross of its vertical neighbours.

This technique is said to produce quality results of the generated disparity map but may be more time consuming than the fixed-size (FW) technique for instance.

Step 3: Disparity Selection

Now that the costs are aggregated and that the matching uncertainties have been addressed, it is time to go from this 3-D aggregated costs map to a 2-D disparity map. In other words, it is time to find for each pixel the correct disparity among all the disparities that were used to build this 3-D costs map.

As local and global methods exist for this step, both will be described briefly.

For the local methods, the most used disparity selection method is a Winner Takes All (WTA) strategy so that the disparity d(x,y) for each pixel corresponds to the minimum aggregated cost in the range of the aggregated cost obtained after step 2 (or step 1 if step 2 skipped) over all allowed disparities (D):

$$d ( x , y ) = d \vert C = {min}_{d ∈ D} Cost ( x , y , d )$$

Where D=[min_disp, max_disp] is the range of shift used in step 1 and 2.

This method works for the algorithms described in step 1, except for the normalized cross correlation (NCC) where the Winner Takes All method consists of choosing the disparity that corresponds to the maximum aggregated cost.

For global methods, a global energy function may be used:

E(d)=E_{data}(d)+β, E_{xwxws}(d)
Where E_{data}(d(x,y)) is the matching cost of pixel (x,y), β is a weighting factor and E_{xwxwxs}(d(x,y)) penalizes the disparity variation.

Some algorithms that perform this disparity selection as global methods are:

belief propagation (BP)

graph cut (GC)

dynamic programming (DP)

As previously noted, the local method can be retained for this step also.

Step 4: Disparity Refinement

In this step, the goal is to reduce noise generated through the previous steps and to refine the final disparity map. Among known techniques to do so include:

Gaussian convolution: reduces noise in the disparity map and can also reduce the amount of fine detail. Disparity is estimated using one of the neighboring pixels in compliance with weights of a Gaussian distribution

Median filter: removes small and isolated mismatches in disparity. Low computational complexity

Anisotropic diffusion: Applies smoothing without crossing any edges, unlike Gaussian convolution

These techniques are quite similar in their concept. Another way of improving the quality of the produced disparity map, according to some embodiments, is by doing a consistency check. In some embodiments, 2 disparity maps can be computed from the same stereo image pair. One by looking for matching pixels of the left image in the right image, and another by looking for the matching pixels of the right image in the left image. Due to at least occlusions, these 2 disparity maps of a same stereo image pair will not be the same. But with these 2 disparity maps, a left to right consistency check (LRC) can be performed in order to detect outliers and then several strategies exist to try to refine them.

This left to right consistency check consists of checking all the pixels in the left disparity map if the disparities correspond to the disparities in the right disparity map. For instance, let k be the disparity in the left disparity map at pixel (x,y): DL(x,y)=k. This means that pixel (x,y) in left original image best corresponds to pixel (x-k,y) in right original image when the disparity map is computed for the left image. On the other hand, it can be expected that pixel (x-k,y) in right original image best corresponds to pixel (x,y) in left original image when the disparity map is computed for the right image. Which can be expressed as: DR(x-k,y)=k. Thus, if DL(x,y)=k and DR(x-k,y)=k then disparity at pixel (x,y) in left disparity map can be considered as correct. Otherwise disparity at pixel (x,y) in left disparity map is considered as an outlier.

This LRC permits to detect occlusion problems or simple mismatches and several strategies to address the problems/mismatches are highlighted. For example, the non-trusted disparity may be interpolated with the neighbor disparities if such is considered as correct and if the neighboring pixels have a similar intensity to the pixel corresponding to this non-trusted disparity in the original image. Outliers can also be dealt with by using the information of another technique to determine the depth of a scene like using the data coming from a Time-of-Flight sensor for instance.

Various of these algorithms and methods have been tested. In certain instances, it has been found that for step 3, the Winner-Take-All method provided the best results, including with regard to simplicity. For step 1, the two best algorithms were found to be the AD algorithm and the SAD algorithm. In some embodiments, the AD algorithm was enhanced. In step 1, the matching cost computation, instead of computing the absolute differences of only one pixel in the left image and one pixel in the right image, in this improved version, the absolute differences of two consecutive pixels are computed. Then, knowing that the disparity that produces the smallest cost will be selected as the good one in step 3, a check is carried out on the value of the two costs resulting from the two absolute differences computation, and if both of them are smaller than a certain threshold, then the retained cost, which is the sum of these two, is reduced. Otherwise, if one of them or both of them are bigger than this threshold, the final cost is increased.

This change improves the function of step 3 and improves the quality of the produced disparity map while keeping a low computational cost compared to the SAD algorithm.

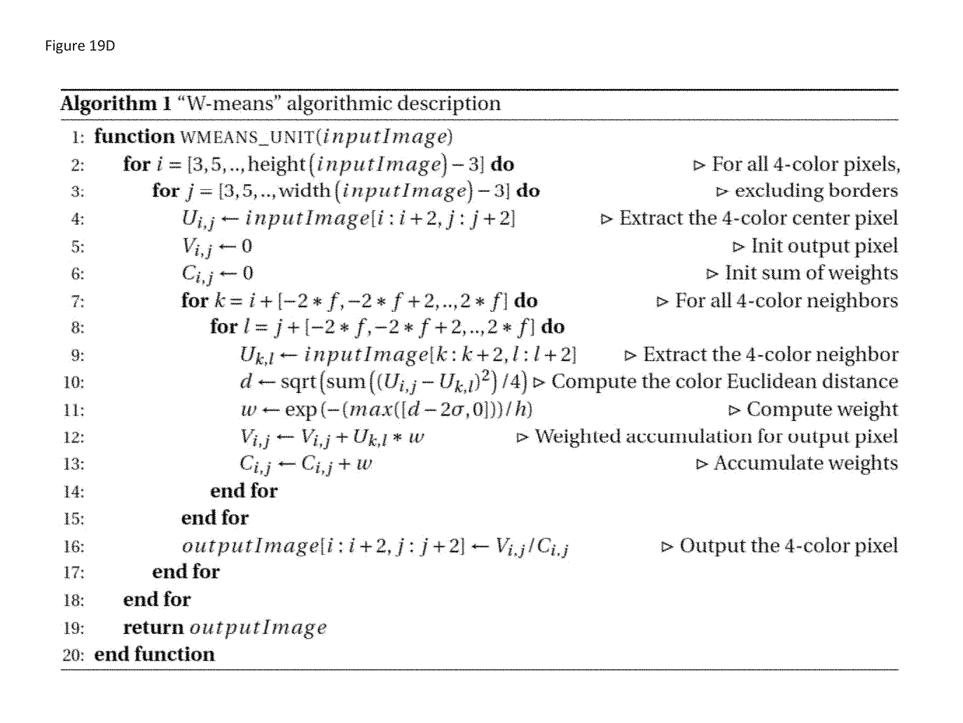

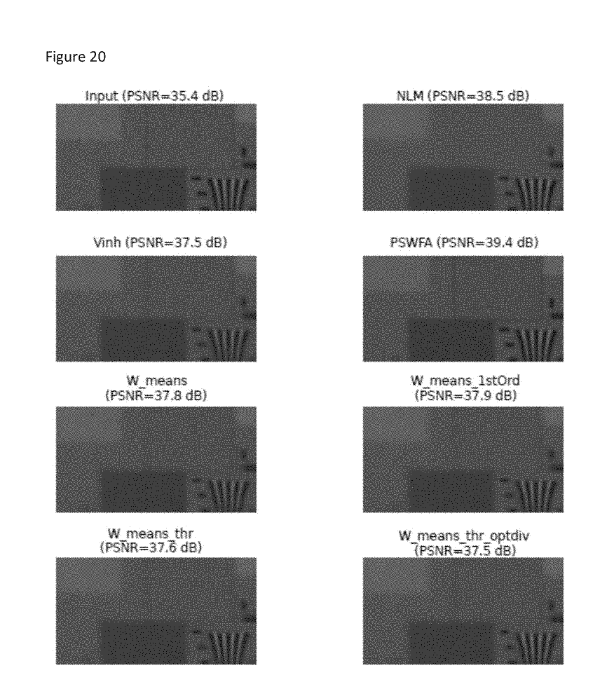

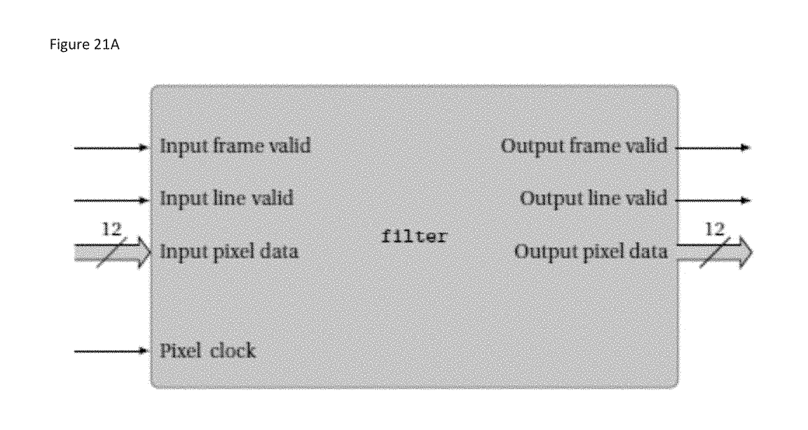

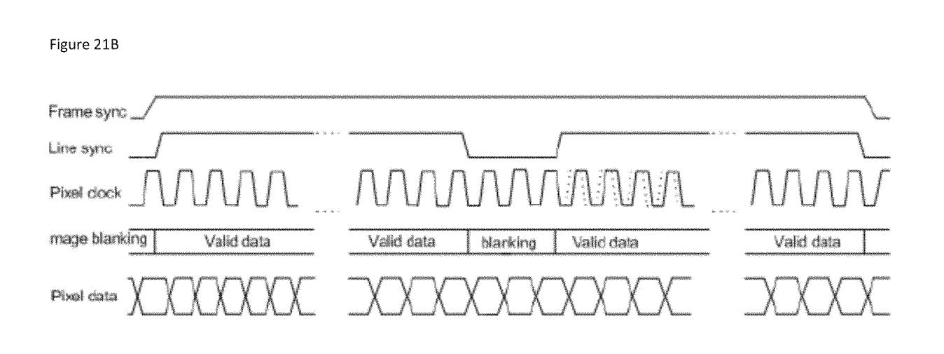

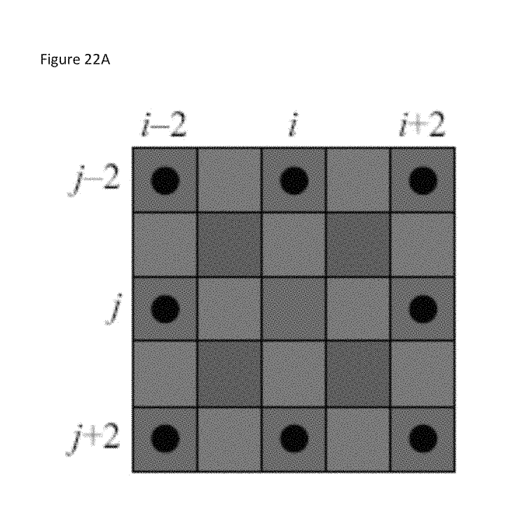

FIGS. 19A-20 relate to a de-noising algorithm for a CFA (color filter array) image, termed herein a “W-means” for “Weighted means”. FIG. 19D shows a non-limiting example of such an algorithm. The algorithm groups the 4 CFA colors to make a so-called “4-color pixel”. Each one of these 4-color pixels in the input image is compared to its neighbors. A weight is attributed to each neighbor depending on its difference with the center pixel. Then, for each color separately, the weighted mean is computed to generate the output 4-color pixel.

First, consider the following CFA image X with size (w×h) and a (2×2) color pattern size (the colors shows an example for the Bayer pattern “Green 1-Blue-Red-Green2 (GBRG)”):

$$X = [ \begin{matrix}{x}_{0 , 0} & {x}_{0 , 1} & {x}_{0 , 2} & … & {x}_{0 , w - 1} \\ {x}_{1 , 0} & {x}_{1 , 1} & {x}_{1 , 2} & … & {x}_{1 , w - 1} \\ {x}_{2 , 0} & {x}_{2 , 1} & {x}_{2 , 2} & … & {x}_{2 , w - 1} \\ ⋮ & ⋮ & ⋮ & ⋱ & ⋮ \\ {x}_{h - 1 , 0} & {x}_{h - 1 , 1} & {x}_{h - 1 , 2} & … & {x}_{h - 1 , w - 1}\end{matrix} ] ,$$

where xi,j are pixel intensity values.

The same image can be represented as a four-color image U with size

$$( m \times n ) = ( \frac{w}{2} \times \frac{h}{2} )$$

$$U = [ \begin{matrix}{U}_{0 , 0} & {U}_{0 , 1} & … & {U}_{0 , m - 1} \\ {U}_{1 , 0} & {U}_{1 , 1} & … & {U}_{1 , m - 1} \\ ⋮ & ⋮ & ⋱ & ⋮ \\ {U}_{n - 1 , 0} & {U}_{n - 1 , 1} & … & {U}_{n - 1 , m - 1}\end{matrix} ]$$

Where Ui,j=[x_{2l,2f}, x_{2i+1.2j}, x_{2l,2j+1}, x_{2i+1.2j+1}].

FIG. 19A shows a simple example of this alternative representation.

The filtered image V with size m×n (same format as U), is given by the equations below.

$${V}_{i , j} = \frac{1}{{C}_{i , j}} {\sum }_{{U}_{k , l} ∈ B ( i , j , f )} {U}_{k , l} \cdot w ( {U}_{k , l} , {U}_{i , j} ) , \\ {C}_{i , j} = {\sum }_{{U}_{k , l} ∈ B ( i , j , f )} w ( {U}_{k , l} , {U}_{i , j} ) , \\ w ( {U}_{k , l} , {U}_{i , j} ) = {e}^{- \frac{ma x ( d ( {U}_{k , l} , {U}_{i , j} ) - 2 α , 0 )}{k}} , \\ d ( {U}_{k , l} , {U}_{i , j} ) = \sqrt{\frac{1}{4} {\sum }_{q ∈ {U}_{k , l} , x ∈ {U}_{i , j}} {( q - x )}^{2}} ,$$

where B (i, j , f) is the square neighborhood centered at Ui,j with size (2f+1)×(2f+1) from U image, σ and h are constant parameters. The weight w ∈ [0,1] depends on the color distance d (there are 4 colors so this is a 4-dimensional distance). This allows application of a bigger weight on similar pixels.

The σ parameter can work as a threshold to ignore noise effect on distances, when its value equals the standard deviation of the noise. Distances smaller than 2σ have their weights set to 1, while larger distances decrease at on exponential rate. The h parameter controls the strength of this exponential function, thus the weights of non-similar pixels. The effect of parameters on the weights relative to the distance can be seen in FIG. 19B.

The main difference with the NLM (Non-Local Means) algorithm (see Antoni Buades, Bartomeu Coll, and Jean-Michel Morel. “Non-Local Means Denoising,” Image Processing On Line, vol. 1 (2011), pp. 208-212. DOI: 10.5201/ipol.2011.bcm_nlm), which makes “W-means” algorithm a lot less iterative, is the computing of the distance d (last equation above). Instead of computing the distance with all Uk,l and Ui,j neighbors, this algorithm only cares about Uk,l and Ui,j colors. The advantage of having 4 colors is to be more accurate than with only 3 colors.

Various adjustments can then be performed to decrease the computational resources necessary to perform the W-means algorithm for noise reduction. The Euclidean distance in the third of three equations above, where the square factor requires a multiplier for each recursive step (for each color of each neighbor) and a square root for each neighbor, the following optimization was performed. The Euclidean distance can be replaced by the Manhattan (Taxicab) distance. Compared to the Euclidean distance, it is computed by removing the square root and computing an absolute value instead of the square, which improves the resource consumption. A simple 2D visualization of these distances can be seen in FIG. 19C.

The Euclidean distance gives the best estimation for the difference between 2 pixels. But, being compared to other differences, this algorithm only requires having comparable difference values. The Manhattan distance also quantifies the difference between 2 pixels, thus it can also be used for this application.

With this optimization, the last of the above three equations becomes the below equation:

$$d ( {U}_{k , l} , {U}_{i , j} ) = \frac{1}{4} {\sum }_{q ∈ {U}_{k , l} , x ∈ {U}_{i , j}} \vert q - x \vert$$

The division by the parameter h in the second of the three above equations may optionally be handled by restricting h values to powers of 2. This way, only multiplexers and/or shifters are required. However, it is preferred to divide by a constant, from 1 to 8, even if that requires more logic elements. The exponential in the second of the three above equations may optionally be handled with threshold based binary weights. Binary weights may optionally be used generally to optimize the above equations.

FIG. 20 demonstrates the effectiveness of the W-means method, which also consumes fewer resources than the art-known methods. For further optimization, optionally a parameter is set so that the denoising increases as the analog amplifier increases its activity. The analog amplifier increases its amplification as the amount of light decreases. In low light conditions, noise can increase significantly. Therefore, increasing denoising as amplification increases can offset this problem, without adding blur in the image.

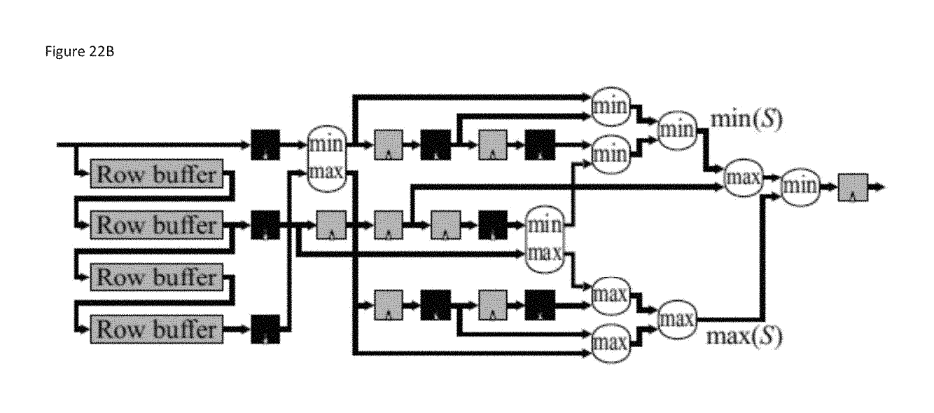

FIGS. 21-31 relate to an exemplary, optional implementation system, and flow, according to some embodiments, that is interoperative with the previously described systems. This system and flow can allow correction according to the W-means method described above, as well as bad pixel correction, described below.

The corrections will be implemented on raw CFA images, just before the debayer process. The input pixel stream consists in the following standard signals:

Pixel clock 1-bit: clock for following signals.

Pixel Data 12-bit: pixel intensity value.

Frame valid 1-bit: used to synchronize the start and the end of the frame.

Line valid 1-bit: means that the pixel data is valid, otherwise it is blanking data. This signal takes the value ‘1’ continuously for the entire row with.

The process units can have, at least, the interfaces shown in FIG. 21A. The chronogram in FIG. 21B shows an example of data transfer.

The method used for defective pixel detection and correction is an adaptation of the algorithm proposed by Bailey and Jimmy (Single shell version; D. Bailey and J. S. Jimmy. “FPGA based multi-shell filter for hot pixel removal within colour filter array demosaicing,” 2016 International Conference on Image and Vision Computing New Zealand (IVCNZ), November 2016, pp. 1-6. DOI: 10.1109/IVCNZ.2016.7804450) is low resource consuming and produced good results during the tests. It is a spatial filter especially made for CFA images. A schematic of the method is shown in FIG. 22A.

Algorithms could be described by the below equation which is applied for all pixels in the image. The proposed implementation diagram is shown in FIG. 22B. In the equation:

y_{i,j}=med(min(S_{CFA}), x_{i,j}, max(S_{CFA})),

where yi,j is the output pixel that depends on the input pixel xi,j and neighbors of same color SCFA represented by black dots in FIG. 22A.

The filter can remove defective pixels that do not belong in a defective pixel cluster (two or more defective neighbors). The sensor data sheet specifies that there are no clusters of defective pixels. Pixels in borders that cannot be processed (two rows on top and two on the bottom, and two columns on each side) are copied from the input to the output.

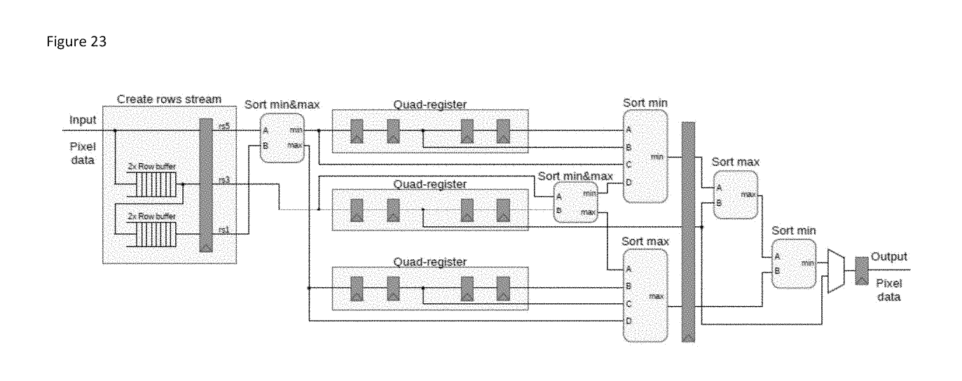

The diagram of the exemplary, illustrative FPGA implementation is shown in FIG. 23, features various adaptations of the published method. Compared to proposed implementation diagram by the authors, the second to last register was added to solve timings issues. A multiplexer has been added to copy the input pixel right to the output when the pixel belongs to the image border.

The Create rows stream component allows to turn the single row stream into a three color-neighbors rows streams called rs1, rs3, and rs5. Due to the CFA image, the filter must process one in two rows. To do this the “2× rows buffer” stores 2 lines instead of one. Then, the Quad-register component can be used to extract the kernel, as in FIG. 22A. Other components include Sort min/max combinatorial units, to perform the process shown in above equation.

Control signals: the pixel data is delayed by approximately two rows, so control signals (frame valid and line valid) must also have this delay. To do that, two more components were created: frame valid delay, that simply runs a counter on each frame valid input transition (when the counter reaches the required delay value, the output is inverted), and a line valid generator that is also based on a counter. When the counter starts, the valid signal is set. Then, when it reaches the image width, the valid signal is cleared.

Based on row and column counters, the line valid generator can be enabled on the second row of the input image and disabled two rows after the end. The copy signal is enabled when the output pixel corresponds to a border in the output image. Pixels residing in the image border are: 1st and 2nd row; 1st and 2nd column; 2nd last and last column; and 2nd last and last row.

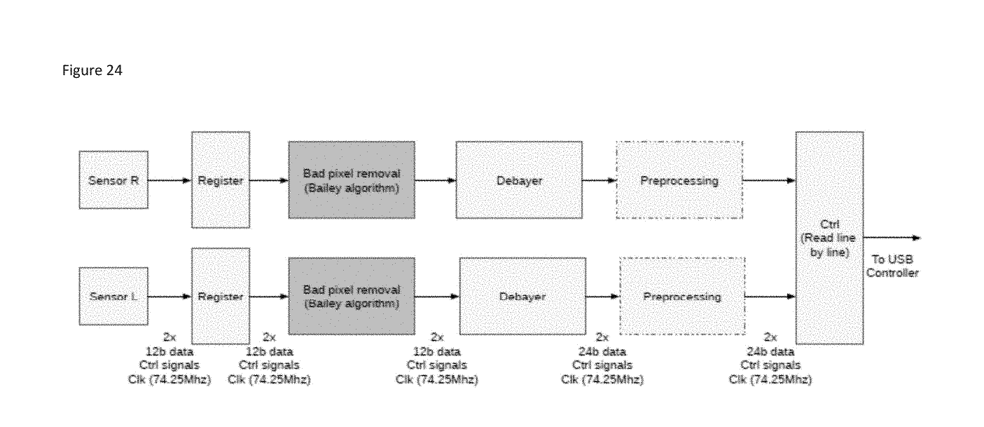

The exemplary implementation of the bad pixel removal method in a camera system as described herein is shown in FIG. 24. Because of the stereo camera pipeline, the method can be instantiated twice, one for each pixel stream. However, the memory is preferably allocated in such a way to avoid employing double the amount of memory.

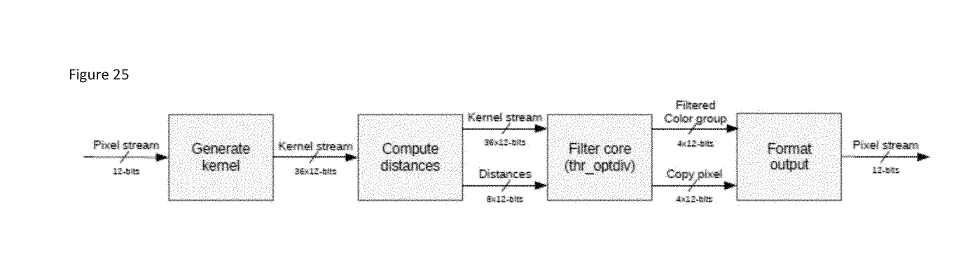

Turning now to the architecture of the W-means method, shown in FIG. 25, the design was made to be reusable. Indeed, if in the future the resource optimization level does not produce sufficient denoising accuracy, some parts of the algorithm can easily be changed to a more resource intensive version. The control signals are generated as the previous implementation. They are based on row and column counters.

The four components shown in FIG. 25 include a generate kernel module, a compute distances module, a filter core module and a format output module.

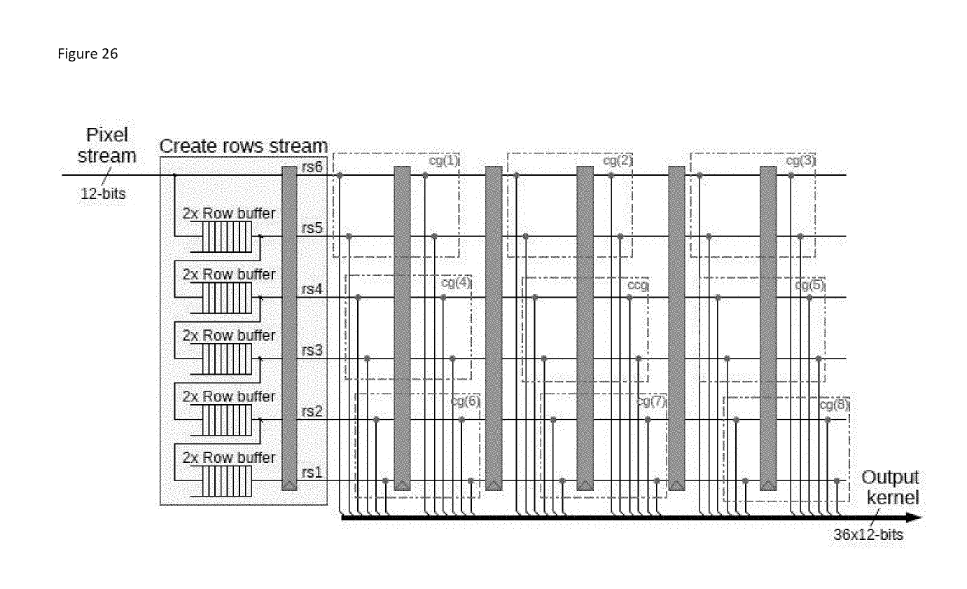

Generate kernel—this component permits to extract the image kernel to be processed. FIG. 26 shows an exemplary diagram. The “Create row stream” component follows the same principle as the previous implementation of the bad pixel method. The kernel contains a 3×3 color group zone, which corresponds to a 6×6 pixel zone.

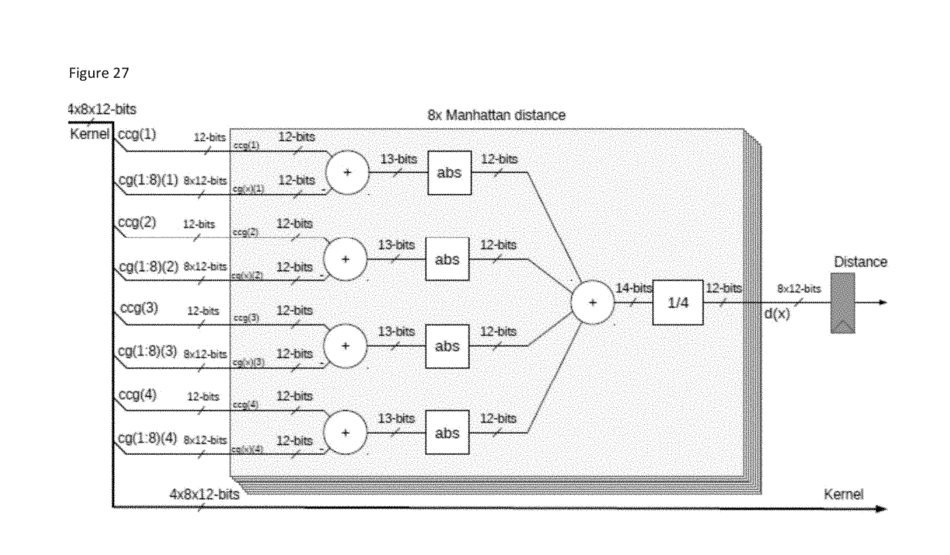

Distance computation—the distance is computed following the Manhattan distance described in the previous equation. FIG. 27 shows an exemplary hardware implementation. The Manhattan distance is computed between each color group neighbor and the center color group.

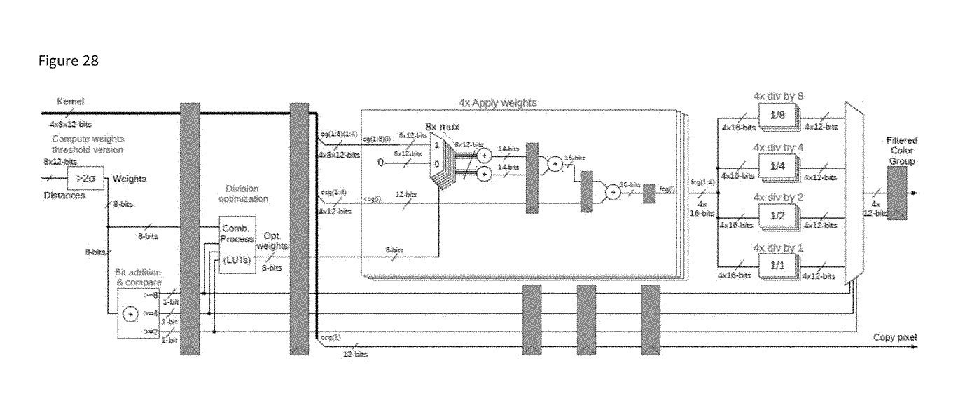

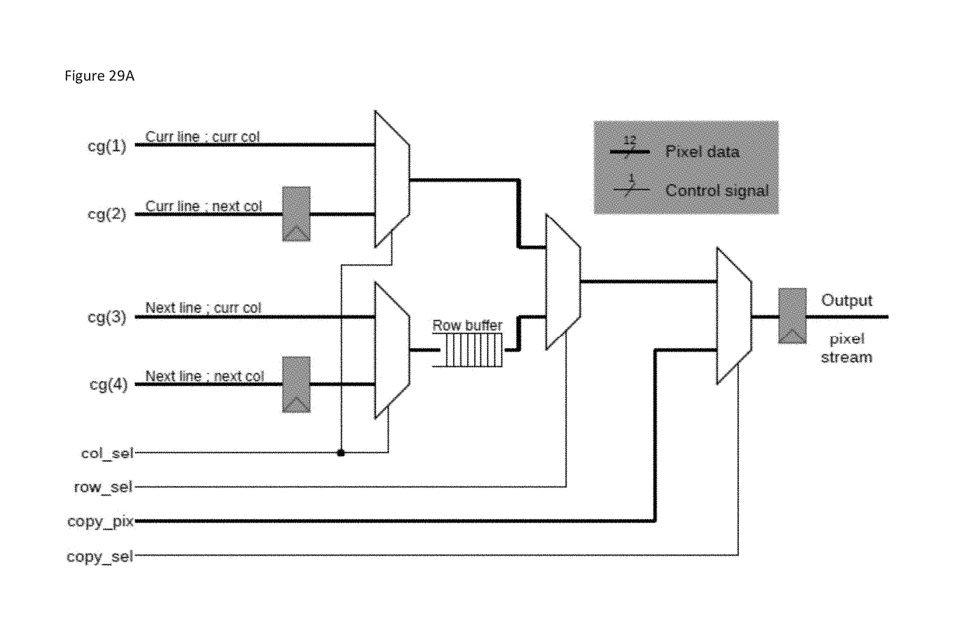

Filter core “thr_optdiv”—a non-limiting, exemplary diagram of the main component of the filter is shown in FIG. 28. The implementation features a number of components. Compute weights (threshold version), where the binary weights are computed. Bit addition and compare, which permits the addition of weights and prepares control signals for the division optimization. It sums bits in the weights vector and compares the sum with all possible power of 2 values (except 1).

Division optimization: This process applies a division optimization, if the sum of weights is equal to a power of 2, the weight does not change. Else, all weights that overflow after the power of 2 are forced to 0.

Apply weights: Applying weights is simply done by a multiplexer. If the weight equal to 1 the associated pixel value is outputted, else it is 0. Then all multiplexers outputs are summed. Division—here the power of 2 divisions are made, where each divisor unit is only wiring.

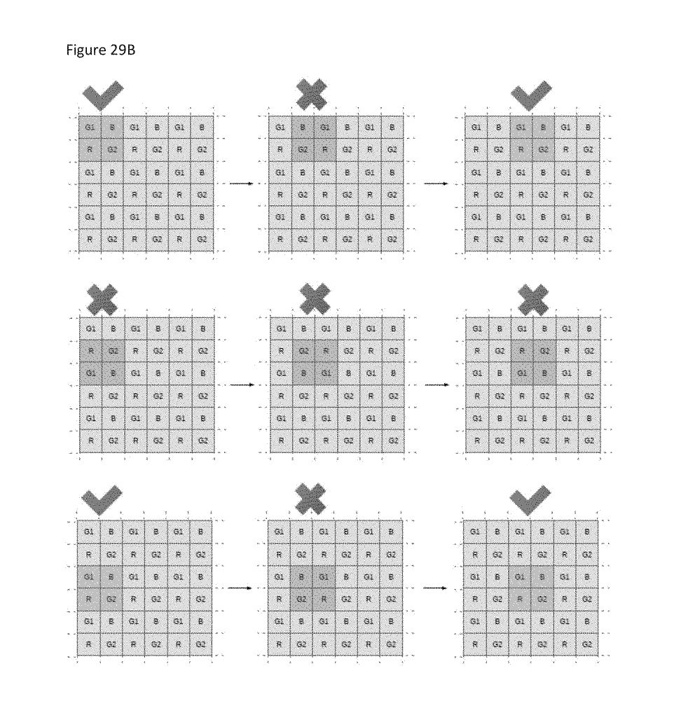

Format output—the denoised color group stream needs to be formatted to a pixel stream. This component permits the algorithm to choose the valid color group to be outputted as a pixel stream. FIG. 29B shows an example of valid and not valid color groups. A color group is valid when its top left color is the same as the first color of the image (1st row, 1st column).

FIG. 29A shows an exemplary, illustrative, non-limiting diagram for this process. Control signals are generated from column and rows counters. Row and column selection are simply least significant bits (LSBs) of these counters. As a color group belongs to two rows, it is required to use a row buffer to delay the second row of the color group. The copy_pix signal is the copied pixel value from the input image. It is used to copy image borders.

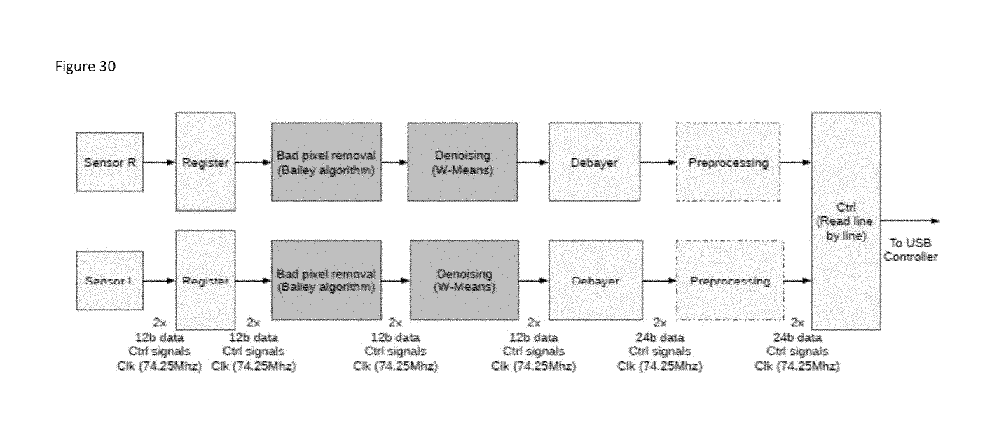

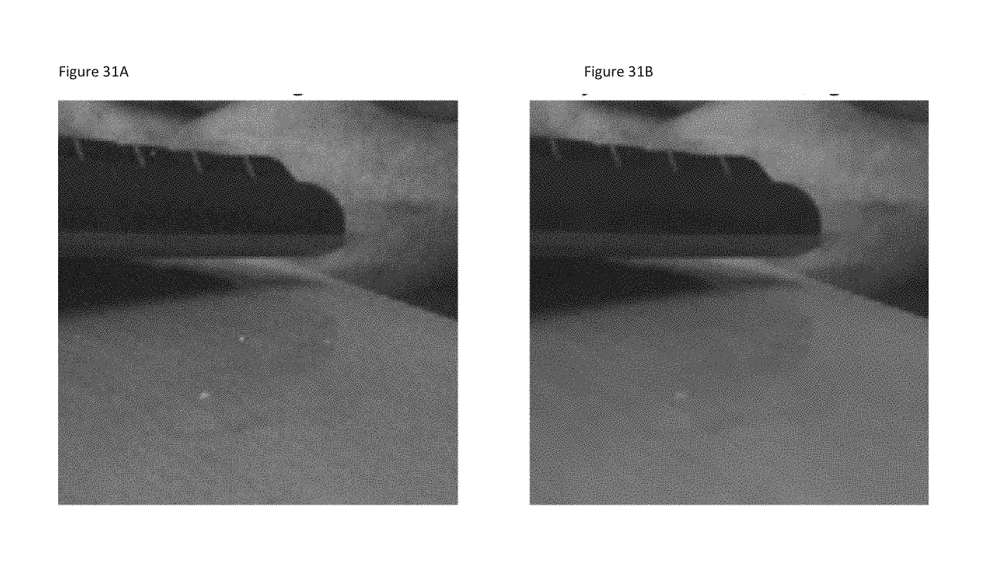

An exemplary implementation of the “W-means” algorithm in the stereoscopic pixel stream can be added while keeping the bad pixel removal algorithm in a camera system as described herein is shown in FIG. 30. The visual result, similar to previous tests, is shown in FIGS. 31A (pre) and 31B (post).

As tested on a Cyclone V FPGA, the system consumes only 5% of combinatorial logic and 7% of the memory. The FPGA tested was the Altera Cyclone V SOC (5CSTFD6D5F31I7N) FPGA). Optionally, the debayer method and the “W-means” algorithm could be combined or interwoven, to decrease resource usage. For every 4 clock cycles the “W-means” implementation only needs 1 to output 4 denoised pixels (only when color groups are valid). This means that during 3 clock cycles the algorithm does not need to filter the image. To improve resource consumption, instead of using a separate unit per pixel stream, both streams can be used in the same computing pipeline.

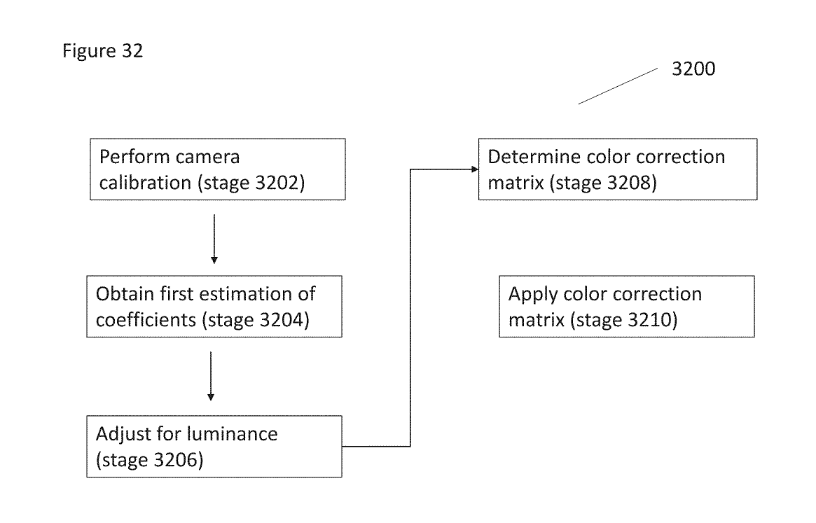

FIG. 32 shows a non-limiting exemplary method for color correction according to at least some embodiments. Selectivity of filters, by which CFA (color filter array) can be applied as described above, is not narrow; moreover, tails of each RGB spectra response usually overlap each other. These problems can lead to the wrong colors in output frame. A matrix of coefficients multiplied by each color channel tends to mitigate such effect. Each coefficient is obtained by a calibration camera process, which can be performed once, and the resulting matrix is called Color Correction Matrix (CCM).

CMOS image sensors are sometimes characterized by quantum efficiency response. Hence, such sensors are monochromic by nature. In order to obtain a color image, a CFA is applied to the sensor output. Depending on the quantum efficiency of the filter, each pixel stores a single color information point. The particular selection of materials, used to realize the CFA, are usually not faithful to natural colors. The problem is typically due to an imperfect frequency range selectivity as well as cross color effect. In particular, each curve does not have a tight Gaussian shape (low selectivity), moreover the tails of each curve overlap each other (cross color effect). In order to correct the color appearance, each channel of the de-mosaiced image has to be multiplied by certain coefficients:

$$[ \begin{matrix}{R}_{corr} \\ {G}_{corr} \\ {B}_{corr}\end{matrix} ] = [ \begin{matrix}r 1 & g 1 & b 1 \\ r 2 & g 2 & b 2 \\ r 3 & g 3 & b 3\end{matrix} ] \times [ \begin{matrix}{R}_{cam} \\ {G}_{cam} \\ {B}_{cam}\end{matrix} ]$$

Where Xcam are R, G, B data coming from camera and Xcorr are R, G, B channel corrected values. The terms rj, gj, bj (with j assuming values 1, 2, 3) compose the color correction matrix.

Turning now to FIG. 32, a method 3200 is performed for color correction (according to some embodiments). In stage 3202, the camera calibration to retrieve color correction matrix coefficients is performed by processing a frame portraying a color checker board. The regions of the frame belonging to the color checker may be manually selected. For each region, the median is performed to evaluate the R, G, B camera channels' response. An example of the reference colors information characterizing color checker board may be found for example in ColorChecker classic for image reproduction|x-rite.

A first estimation of the coefficients is obtained in stage 3204, for example by computing the minimum norm least square solution method in Tsung-Huang Chen and Shao-Yi Chien, “Cost effective color filter array de-mosaicking with chrominance variance weighted interpolation,” IEEE International Symposium on Circuits and Systems, 2007. ISCAS 2007, pages 1277-1280); where Xref terms are R, G, and B reference colors values in checker board, while Xcam terms are R, G, and B camera colors values sent by camera. Applying these coefficients to the image causes the response of each channel to better adhere to the ideal characteristics of the image. Nevertheless test output images featured large saturated regions (data not shown).

$$[ \begin{matrix}{R}_{ref} \\ {G}_{ref} \\ {B}_{ref}\end{matrix} ] = [ \begin{matrix}r 1 & g 1 & b 1 \\ r 2 & g 2 & b 3 \\ r 3 & g 2 & b 3\end{matrix} ] \times [ \begin{matrix}{R}_{cam} \\ {G}_{cam} \\ {B}_{cam}\end{matrix} ]$$

This is due a lack of compensation of the luminance component, defined, according to ITU-R recommendation BT.709, as:

$${Y}^{′} = [ \begin{matrix}0.2126 & 0.7152 & 0.0722\end{matrix} ] \times [ \begin{matrix}R \\ G \\ B\end{matrix} ]$$

When a direct correction is performed, the resulting luminance is higher than in the original frame. In order to maintain an unaltered luminance component, the following calculation is performed in stage 3206:

Consider x as pixels from original frame, y as pixels from directly corrected frame and y* as pixels from luminance corrected frame. These pixels are related one to the other by the two below equations, where A and C are 3×3 matrices.

y=Ax

y*=Cx

These matrices are linked by the relation:

A=αC

then

y=αy*

$$α = \frac{lum ( Ax )}{lum ( {y}^{*} )}$$

Where lum( ) is a function defined to calculate luminance component of input pixels. Because we are looking for a such that the luminance components of the original and final frames are equal, lum(y*)=lum(x), then a is:

$$α = \frac{lum ( Ax )}{lum ( x )}$$

The color correction matrix is then established in stage 3208. Multiplying the frame by the obtained C color correction matrix, a natural color frame image is obtained in stage 3210. Moreover, the image sensor response is more similar to an ideal one adjusted with original luminance.

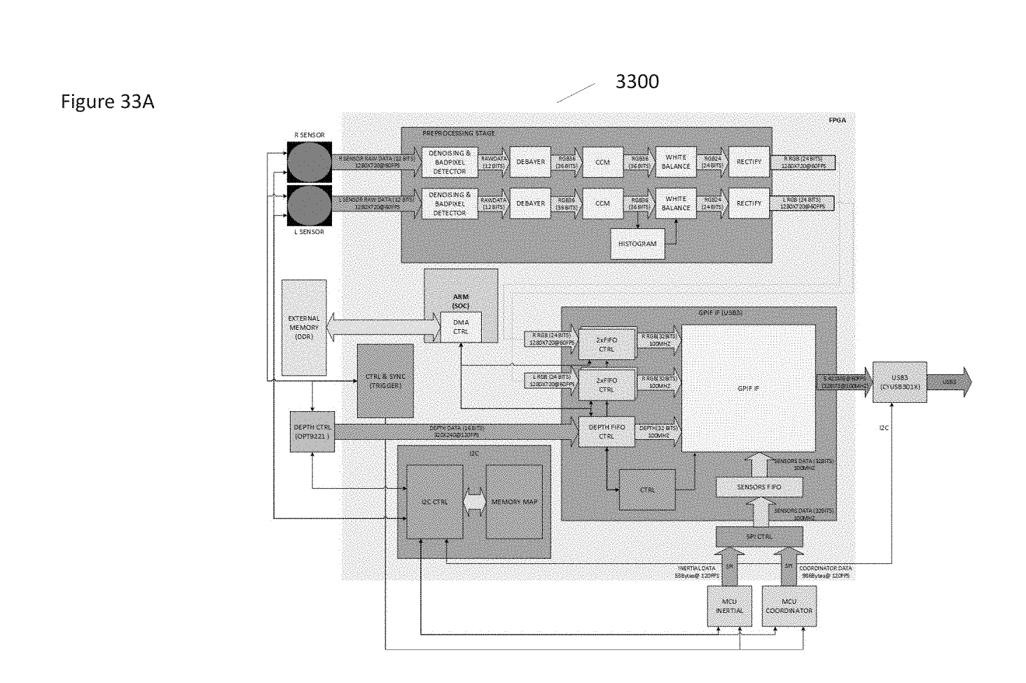

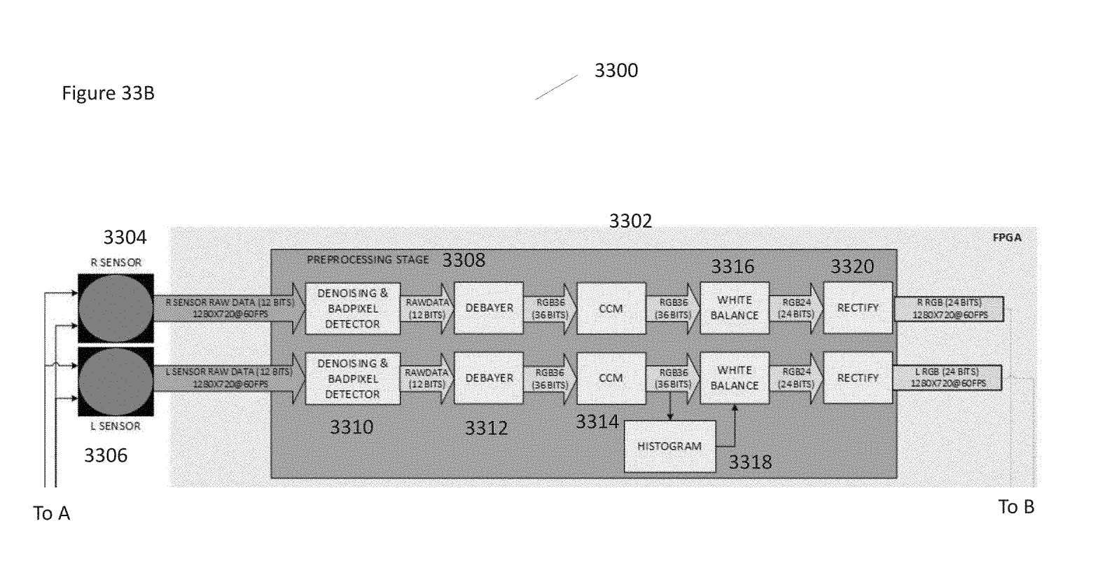

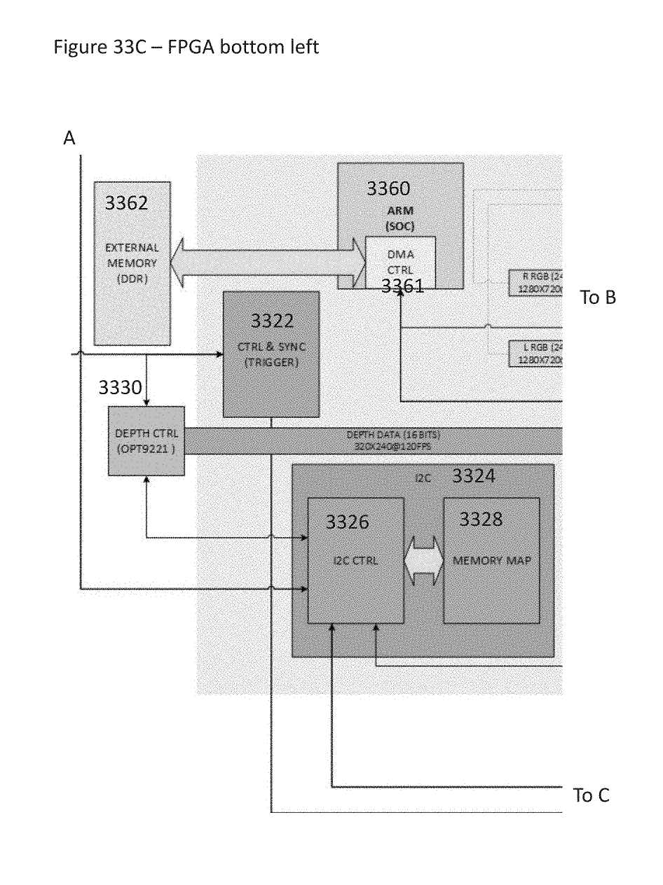

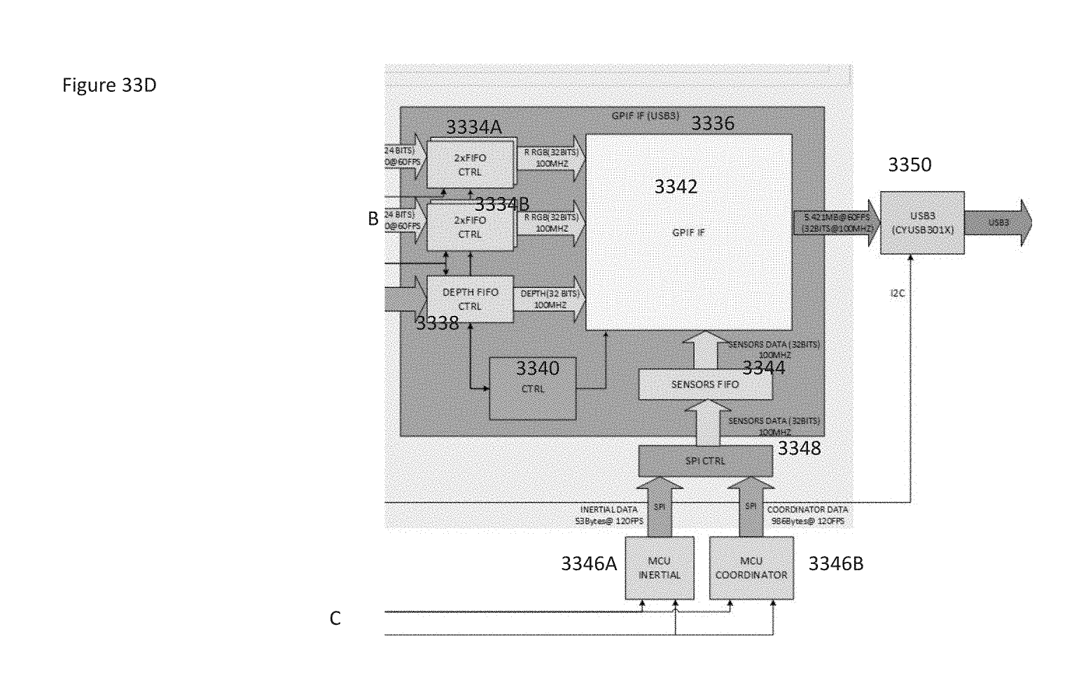

FIGS. 33A-33D show a non-limiting exemplary FPGA configuration according to at least some embodiments. FIG. 33A shows an FPGA 3300 system, while FIG. 33B shows the top of FPGA system 3300 in more detail, and FIGS. 33C and 33D show the left and right sides, respectively, of the bottom of FPGA system 3300 in more detail. Reference is made to all of FIGS. 33A-33D in the below discussion.

FPGA system 3300 features an FPGA 3302, receiving input from a right sensor 3304 and a left sensor 3306. Data from each sensor 3304 and 3306 is fed to a preprocessing stage 3308, which runs preprocessing for data from each sensor separately as shown. For each sensor, preprocessing stage 3308 begins with denoising and bad pixel detection 3310, performed as previously described. Next the previously described debayer process 3312 is performed.

The results of the debayer process 3312 are then fed to the previously described color correction matrix (CCM) process 3314. The data from CCM process 3314 is used to determine the histogram 3318. The histogram then feeds to the previously described white balance correction process 3316. After that a rectify process 3320 is performed for stereo rectification as previously described.

FPGA system 3300 is shown with three branches, in FIGS. 33B-33D. There are two links shown between the top and bottom branches, labeled as “to A” and “to B”. There are two links shown between the left and right bottom branches, labeled as “to B” and “to C”.

Turning to the first branch, “to A” (in FIG. 33B) and “A” (in FIG. 33C), sensors 3304 and 3306 have a bi-directional flow with a trigger 3322 for controlling and syncing between the inputs from both sensors 3304 and 3306, so that timing is synchronized between the frames. In addition, sensors 3304 and 3306 have a bi-directional flow with an I2C (Inter Integrated Circuit) 3324. I2C 3324 includes an I2C controller 3326 and a memory map 3328. I2C controller 3326 in this example is a master microcontroller (slave microcontrollers and other slave components may also be featured; not shown). Memory map 3328 is a map of the memory registers in the various slave components which allow the one or more controllers to write to the registers of the slave devices. Memory map 3328 is a register for controlling the values for the variables for FPGA system 3300.

I2C controller 3326 is also in communication with a depth controller 3330 for synchronizing the timing of the depth sensor data. Optionally all sensor data passes through I2C controller 3326, including but not limited to sensors 3304 and 3306, and sensors 3346.

In the second branch, “to B” (in FIGS. 33B or 33C) or “B” (in FIG. 33D), preprocessing stage 3308 transmits preprocessed RGB sensor data to two FIFO buffers 3334A and 3334B on a GPIF (General Programmable Interface) IF (interface) module 3336. GPIF IF module 3336 implements a 32-bit bus interface, which is used to communicate with the USB3 chip 3350. FIFO buffers 3334A and 3334B operate as previously described. Depth data from depth controller 3330 is fed to a depth FIFO buffer 3338. GPIF IF module 3336 also has a controller 3340 and a GPIF IF 3342. GPIF IF 3342 is the interface for the bus.

GPIF IF 3342 also receives additional sensor data from an additional sensors FIFO buffer 3344, which in turn optionally receives sensor data from multiple sensors 3346, of which two examples are shown for the purpose of illustration and without any intention of being limiting. Non-limiting examples that are shown include a MCU inertial sensor 3346A and a MCU coordinator 3346B. This data is optionally fed through a controller 3348, which may be an SPI (serial peripheral bus) controller for example.

Processed information is then output from GPIF IF 3342 to the USB chip 3350 for example.

The actions of GPIF IF 3342 may be assisted by computations performed by SOC (system on chip) 3360, optionally with an external memory 3362. SOC 3360, using external memory 3362, is able to increase the speed of performance of GPIF IF 3342 by performing computations more quickly. SOC 3360 acts as embedded processor with a DMA (direct memory access) module 3361. For example, SOC 3360 can perform calculations related to stereo data (including depth and RGB data) through sensor FIFOs 3334A, 3334B and 3338.

Turning now to the third branch, labeled “to C” in FIG. 33C and “C” in FIG. 33D, trigger 3322 may control the action(s) of sensors 3346 as shown, to trigger their activation for data collection for example. Trigger 3322 may, alternatively or additionally, synchronize the various sensors 3346 with a timestamp. I2C 3324 receives data from the various sensors, including sensors 3346, and sensors 3304 and 3306, as previously described.

While various inventive embodiments have been described and illustrated herein, those of ordinary skill in the art will readily envision a variety of other means, structures, steps, and/or functionality for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, structure, functionality, steps, processes, and configurations described herein are meant to be exemplary and that the actual parameters, dimensions, materials, structure, functionality, steps, processes, and configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the embodiments disclosed herein are presented by way of example only and that, such embodiments (and any embodiments supported by the present disclosure either expressly, implicitly or inherently) may be practiced otherwise than as specifically described and claimed. Some embodiments of the present disclosure are directed to each individual feature, system, function, article, material, instructions, step, kit, and/or method described herein, and any combination of two or more such features, systems, functions, articles, materials, kits, steps, and/or methods, if such features, systems, functions, articles, materials, kits, steps and/or methods are not mutually inconsistent, is included within the inventive scope of the present disclosure. Additionally, some embodiments of the present disclosure are inventive over the prior art by specifically lacking one and/or another feature/functionality disclosed in such prior art (i.e., claims to such embodiments can include negative limitations to distinguish over such prior art).

Also, various inventive concepts may be embodied as one or more steps/methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any and all references to publications or other documents, including but not limited to, patents, patent applications, articles, webpages, books, etc., presented in the present application, are herein incorporated by reference in their entirety.

All definitions, as defined and used herein, should be understood to control over dictionary definitions, definitions in documents incorporated by reference, and/or ordinary meanings of the defined terms.

1. A stereo vision procurement apparatus for obtaining stereo visual data, comprising:
a stereo RGB camera;
a depth sensor;
an RGB-D fusion module,
a processor;
a memory; and
a plurality of tracking devices to track movement of a subject;
wherein:
each of said stereo RGB camera and said depth sensor are configured to provide pixel data corresponding to a plurality of pixels,
said RGB-D fusion module is configured to combine RGB pixel data from said stereo RGB camera and depth information pixel data from said depth sensor to form stereo visual pixel data (SVPD),
said RGB-D fusion module is implemented in an FPGA field-programmable gate array):
the processor is configured to process data from the tracking devices to form a plurality of sub-features and to perform a defined set of operations in response to receiving a corresponding instruction selected from an instruction set of codes, the instruction of set of codes including a first set of codes for operating said RGB-D fusion module to synchronize RGB pixel, data and depth pixel data, and for creating a disparity map and a second set of codes for creating a point cloud from said disparity map and said depth pixel data; and
the FPGA is configured to combine the sub-features to form a feature to track movements of the subject.

2. The apparatus of claim 1, further comprising a de-mosaicing module configured to perform a method comprising:
averaging the RGB pixel data associated with a plurality of green pixels surrounding red and blue sites for R(B) at B-G(R-G) sites or R(B) at R-G(B-G) sites, and
reducing a number of green pixel values from the RGB pixel data to fit a predetermined pixel array for R(B) at B(R) sites.

3. The apparatus of claim 1, wherein:
said stereo RGB camera comprises a first camera and a second camera,
each of said first and second cameras being associated with a clock on said FPGA, and
said FPGA including a double clock sampler for synchronizing said clocks of said first and right cameras.

4. The apparatus of claim 3, further comprising:
a histogram module comprising a luminance calculator for determining a luminance level of at least said RGB pixel data; and
a classifier for classifying said RGB pixel data according to said luminance level, wherein said luminance level is transmitted to said stereo RGB camera as feedback.

5. The apparatus of claim 4, further comprising a white balance module configured to apply a smoothed GW (gray world) algorithm to said RGB pixel data.

6. The apparatus of claim 1, further comprising:
one or more biological sensor configured to provide biological data,
wherein:
said one or more biological sensor are selected from the group consisting of: an EEG sensor, a heartrate sensor, an oxygen saturation sensor, an EKG sensor, and EMG sensor,
the processor is configured to process the biological data to form a plurality of sub-features,
said sub-features are combined by the FPGA to form a feature.

7. The apparatus of claim 1, wherein said FPGA is implemented as a field-programmable gate array (FPGA) comprising a system on a chip (SoC), including an operating system as a SOM (system on module).

8. The apparatus of claim 7, further comprising a CPU SOM for performing overflow operations from said FPGA.

9. (canceled)

10. The apparatus of claim 1, wherein said tracking devices comprise a plurality of wearable sensors.

11. The apparatus of claim 10, further comprising:
a multi-modal interaction device in communication with a subject, said multi-modal interaction device comprising said plurality of tracking devices and at least one haptic feedback device.

12. (canceled)

13. The apparatus of claim 1, wherein said point cloud comprises a colorized point cloud.

14. (canceled)

15. The apparatus of claim 1, wherein
the instruction set of codes further includes a third set of codes for a de-noising process for a CFA (color filter array) image according to a W-means process.

16. The apparatus of claim 15, wherein
the instruction set of codes further includes a fourth set of codes selected from the instruction set for operating a bad pixel removal process.

17. A system comprising the apparatus of claim 1, further comprising a display for displaying stereo visual data, an object attached to a body of a user; and an inertial sensor, wherein said object comprises an active marker, input from said object is processed to form a plurality of sub-features, and said sub-features are combined by the FPGA to form a feature.

18. (canceled)

19. (canceled)

20. The system of claim 17, wherein:
said processor is configured to transfer SVPD to said display without being passed to said user application, and
said user application is additionally configured to provide additional information for said display that is combined by said FPGA with said SVPD for output to said display.

21. The system of claim 20, wherein said biological sensor is configured to output data via radio-frequency (RF), and wherein:
the system further comprises an RF receiver for receiving the data from said biological sensor, and
said feature from said FPGA is transmitted to said user application.

22. The system of claim 17, further comprising at least one of a haptic or tactile feedback device, the device configured to provide at least one of haptic or tactile feedback, respectively, according to information provided by said user application.

23. A stereo vision procurement system comprising:
a first multi-modal interaction platform configurable to be in communication with one or more additional second multi-modal interaction platforms;
a depth camera;
a stereo RGB camera comprising a plurality of sensors; and
an RGB-D fusion chip;
wherein:
each of said stereo RGB camera and said depth camera are configured to provide pixel data corresponding to a plurality of pixels,
the RGB-D fusion chip comprises a processor operative to execute a plurality of instructions to cause the chip to fuse said RGB pixel data and depth pixel data to form stereo visual pixel data:
the stereo camera is configured to provide SVPD from at least one first and at least one second sensor; and
wherein the RGB-D fusion chip is configured to preprocess at least one of SVPD and depth pixel data so as to form a 3D point cloud with RGB pixel data associated therewith.

24. The system of claim 23, wherein the depth camera is configured to provide depth pixel data according to TOF (time of flight).

25. (canceled)

26. (canceled)

27. The system of claim 23, wherein the fusion chip is further configured to form the 3D point cloud for tracking at least a portion of a body by at least the first multi-model interaction platform.

28. The system of claim 27, further comprising at least one of a display and a wearable haptic device, wherein at least the first multi-modal interaction platform is configured to output data to at least one of the display and the haptic device.

29. (canceled)

30. The system of claim 23, further comprising one or more sensors configured to communicate with at least one of the multi-modal interaction platforms, wherein the one or more sensors include at least one of:
a stereo vision AR (augmented reality) component configured to display an AR environment according to at least one of tracking data of a user and data received from the first multi-modal interaction platform, and a second additional multi-modal interaction platform;
an object tracking sensor;
a facial detection sensor configured to detect a human face, or emotions thereof; and
a markerless tracking sensor in which an object is tracked without additional specific markers placed on it.

31. (canceled)

32. (canceled)

33. A method for processing image information comprising:
receiving SVPD from a stereo camera;
performing RGB preprocessing on the input pixel data to produce preprocessed RGB image pixel data;
using the RGB preprocessed image pixel data in the operation of the stereo camera with respect to at least one of an autogain and an autoexposure algorithm;
rectifying the SVPD so as to control artifacts caused by the lens of the camera; and
calibrating the SVPD so as to prevent distortion of the stereo pixel input data by the lens of the stereo camera, wherein said calibrating includes matching the RGB pixel image data with depth pixel data;
further comprising colorizing the preprocessed RGB image pixel data, and creating a disparity map based on the colorized, preprocessed RGB image pixel data.

34. (canceled)

35. (canceled)

36. The method of claim 33, wherein the disparity map is created by:
obtaining depth pixel data from at least one of the stereo pixel input data, the preprocessed RGB image pixel data, and depth pixel data from a depth sensor, and checking differences between stereo images.

37. The method of claim 36, wherein said disparity map, plus depth pixel data from the depth sensor in the form of a calibrated depth map, is combined for the point cloud computation.

38. (canceled)

39. A stereo image processing method comprising:
receiving first data flow of at least one image from a first RGB camera and second data flow of at least one image from a second RGB camera;
sampling the first and second data flows such that each of the first and second data flows are synchronized with a single clock;
sending the first and second data flows to a frame synchronizer;
detecting which data flow is advanced of the other, and directing the advanced data flow to a First Input First Output (FIFO), such that the data from the advanced flow is retained by the frame synchronizer until the other data flow reaches the frame synchronizer; and
synchronizing, using the frame synchronizer, a first image frame from the first data flow and a second image frame from the second data flow such that time shift between the first image and frame and the second image frame is substantially eliminated.

40. (canceled)

41. The method of claim 39, further comprising serializing frame data of the first and second data flows as a sequence of bytes.

42. The method of claim 41, further comprising detecting non-usable pixels.

43. The method of claim 39, further comprising constructing a set of color data from each of the first and second data flows and color correcting each of the first and second data flows; corresponding the first and second data flows into a CFA (color filter array) color image data;
applying a denoising process for the CFA image data, the process comprising:
grouping four (4) CFA colors to make a 4-color pixel for each pixel of the image data;
comparing each 4-color pixel to neighboring 4-color pixels;
attributing a weight to each neighbor pixel depending on its difference with the center 4-color pixel; and
for each color, computing a weighted mean to generate the output 4-color pixel.

44. (canceled)

45. (canceled)

46. The method of claim 43, wherein said denoising process further comprises performing a distance computation according to a Manhattan distance, computed between each color group neighbor and the center color group.

47. (canceled)

48. A stereo vision procurement apparatus for obtaining stereo visual data, comprising:
a stereo RGB camera;
a depth sensor; and
an RGB-D fusion module,
wherein:
each of said stereo RGB camera and said depth sensor are configured to provide pixel data corresponding to a plurality of pixels,
said RGB-D fusion module is configured to combine RGB pixel data from said stereo RGB camera and depth information pixel data from said depth sensor to form stereo visual pixel data (SVPD), and
said RGB-D fusion module is implemented in an FPGA field-programmable gate array);
further comprising:
a processor;
a memory; and
a plurality of tracking devices to track movement of a subject,
wherein:
the processor is configured to process data from the tracking devices to form a plurality of sub-features, and
said sub-features are combined by said FPGA to form a feature to track movements of the subject; and
wherein the processor is configured to perform a defined set of operations in response to receiving a corresponding instruction selected from an instruction set of codes; and
wherein:
said defined set of operations includes:
a first set of codes for operating said RGB-D fusion module to synchronize RGB pixel data and depth pixel data, and for creating a disparity map; and
a second set of codes for creating a point cloud from said disparity map and said depth pixel data.
